(19) United States
(12) Patent Application Publication
(10) Pub. No.: US 2023/0322641 A1
(43) Pub. Date: Oct. 12, 2023

(54) COMPOSITIONS AND METHODS FOR PRODUCING BICARBONATE AND MINERALS

(71) Applicant: ANDES AG, INC., Alameda, CA (US)

(72) Inventors: Gonzalo FUENZALIDA, Piedmont, CA (US); Tania TIMMERMANN, Oakland, CA (US); Bjorn TRAAG, Walnut Creek, CA (US); Lina LEON, San Francisco, CA (US); Naresh PANDEY, Emeryville, CA (US); Raghuveer SINGH, Emeryville, CA (US)

(21) Appl. No.: 18/135,668

(22) Filed: Apr. 17, 2023

Related U.S. Application Data
(63) Continuation of application No. PCT/US2021/056083, filed on Oct. 21, 2021.
(60) Provisional application No. 63/257,079, filed on Oct. 18, 2021.
(60) Provisional application No. 63/094,870, filed on Oct. 21, 2020.

(51) Int. Cl. C05F 11/08; C05G 3/90

(52) U.S. Cl. CPC C05F 11/08; C05G 3/90

(57) ABSTRACT

Described herein are methods and compositions that utilize microorganisms integrated with plants for improvement of carbon dioxide conversion and sequestration in soil.

### CROSS-REFERENCE TO RELATED APPLICATIONS

This application is a continuation of International Application No. PCT/US21/56083, filed internationally on Oct. 21, 2021, which claims the benefit of U.S. Provisional Application No. 63/094,870, filed on Oct. 21, 2020 and U.S. Provisional Application No. 63/257,079, filed on Oct. 18, 2021, all of which are incorporated herein by reference.

### FIELD OF THE INVENTION

Anthropogenic activities, including burning of fossil fuels and deforestation have significantly contributed to the increase of major greenhouse gases. Burning of coals generates the highest amount of CO₂ in comparison to the other uses of fossil fuels and approximately 2.5 tons of CO₂ is produced for every ton of coal burned. To date the CO₂ concentration in the environment has reached over 400 ppm from 280 ppm that was in the mid-19th century at the start of industrial revolution. It is predicted that by the middle of this century CO₂ concentration is likely to reach 600 ppm, and by the end of this century it will most likely reach 700 ppm. Global temperature is reported to increase more than 2° C. by 2050 and about 3-5° C. in the coming 50-100 years. This global temperature increase has worsened climate change and the global consequences of climate change have been already experienced that include, bushfire in Australia that destroyed the wild-life, reoccurring wildfires in California forests, increase in the frequency and duration of heat waves, extended periods of droughts, rise in sea level, tsunami, etc. None of these natural calamities were common prior to the industrialization and these are the results of raised CO₂ levels.

Apart from the known sources of CO₂ emission, there are some unexplored sources that are not only continuously adding CO₂ but may become a key source depending on the severity of climate change. Soil is the largest carbon reservoirs as it contains much more carbon (1500 Pg of C to 1 m depth and 2500 Pg of C to 2 m; 1 Pg=1×1015 g) than is present in vegetation and twice as much C as the atmosphere (750 Pg of C). It is estimated that each ton of soil's organic carbon releases 3.66 tons of CO₂. The organic carbon in the soil is added by plants in the following ways: root death, root exudates, or other root-borne organic substances released by rhizosphere and root respiration. It is well documented that during photosynthesis plants use CO₂ and convert it into sugars, however during respiration a greater amount of unfixed CO₂ is released primarily by the roots of the plants. Out of 120 Pg carbon captured by the plants, 50% is lost to the atmosphere by respiration of plants. This is further exacerbated by the fact that the soil inhabiting organisms and microorganisms which lives in a closer proximity to roots (rhizosphere) release CO₂ during their respiration. Production of CO₂ by the rhizobial community is 10 times higher than the plants without the rhizosphere. The soil inhabiting microorganisms are being fed by the root exudates or surviving by decomposing complex materials present in the soil. The role of soil microorganisms for climate change has been investigated previously and it is suggested that global warming is likely to accelerate the rates of heterotrophic microbial activity leading to increase in the flux of CO₂ in soil that ultimately will get released into the environment. Because the temperature of soil can increase soil respiration, it is anticipated that global climate change might increase the net transfer of carbon from soil to atmosphere. Though soil is a good source of storing carbon (3.3 times the size of the atmospheric pool (760 gigatons)), however the global warming could exacerbate the depletion of C pool. While it is necessary to prevent the release of CO₂ into the atmosphere, permanently storing CO₂ into soil via effective CO₂ sequestration is the dire need. The sequestration of carbon in soils used for agricultural, forestry and land reclamation has been recognized as a potential option to mitigate global change.

CO₂ fixation, whether biological or abiological, started in the early earth's history as the level of CO₂ were much higher than today. A massive amount of CO₂ approximately 150000×10¹² metric tons was fixed into carbonate minerals such as calcite, aragonite, dolomite and limestone. Typically, CO₂ can naturally be converted into solids including carbonate minerals such as calcium carbonate and magnesium carbonate, however the hydration of CO₂ that generates bicarbonate is a very slow process (˜1.3×10⁻¹ s⁻¹).

### SUMMARY OF THE INVENTION

An aspect of the present disclosure is composition comprising a plant or a plant seed and one or more microorganisms associated with the plant or plant seed, wherein the one or more microorganisms are, or are derived from, one or more microorganisms selected to produce or promote the formation of bicarbonate, carbonate or one or more minerals. In some embodiments, the plant is a commercial plant, a fruit tree plant, a nut tree plant, a bush plant, a bulb plant, a grassland plant, a turfgrass plant, or any combination thereof. In some embodiments, the plant seed is a commercial plant seed, a fruit tree plant seed, a nut tree plant seed, a bush plant seed, a bulb plant seed, a grassland plant seed, a turfgrass plant seed, or any combination thereof. In some embodiments, the one or more microorganisms associated with the plant seed are disposed in an interspace between a seed coat and a seed embryo of the plant seed. In some embodiments, the one or more microorganisms associated with the plant seed are disposed as a coating of the plant seed. In some embodiments, the one or more microorganisms associated with the plant seed are applied through an irrigation-system to the plant seed. In some embodiments, the irrigation system comprises an in-furrow treatment technique. In some embodiments, the irrigation system comprises a spray technique. In some embodiments, the bicarbonate sequesters carbon. In some embodiments, the carbon is a gaseous carbon. In some embodiments, the gaseous carbon is carbon dioxide. In some embodiments, the carbonate sequesters carbon. In some embodiments, the carbon is a gaseous carbon. In some embodiments, the gaseous carbon is carbon dioxide. In some embodiments, the one or more minerals sequester carbon. In some embodiments, the carbon is a gaseous carbon. In some embodiments, the gaseous carbon is carbon dioxide. In some embodiments, the one or more microorganisms associated with the plant seed are disposed in an interspace between a seed pericarp and a seed aleurone cell layer of the plant seed. In some embodiments, the one or more microorganisms comprises one or more carbonic anhydrase enzymes. In some embodiments, the one or more carbonic anhydrase enzymes comprise a carbonic anhydrase enzyme from the alpha class. In some embodiments, the one or more carbonic anhydrase enzymes comprise a carbonic anhydrase enzyme from the beta class. In some embodiments, the one or more carbonic anhydrase enzymes comprise a carbonic anhydrase enzyme from the gamma class. In some embodiments, the one or more carbonic anhydrase enzymes comprise a carbonic anhydrase enzyme from the delta class. In some embodiments, the one or more carbonic anhydrase enzymes comprise a carbonic anhydrase enzyme from the zeta class. In some embodiments, the one or more carbonic anhydrase enzymes comprise a carbonic anhydrase enzyme from the eta class. In some embodiments, the one or more carbonic anhydrase enzymes comprise a carbonic anhydrase enzyme from the iota class.

In some embodiments, the one or more microorganisms comprise a bacteria, archaea, fungi, or virus. In some embodiments, the one or more microorganisms comprise the bacteria. In some embodiments, the bacteria comprise endospore forming bacteria. In some embodiments, the bacteria comprise bacteria from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Pelospora sp., Pelotomaculum sp., Piscibacillus sp., Planfilum sp., Pontibacillus sp., Propionispora sp., Salinibacillus sp., Salsuginibacillus sp., Seinonella sp., Shimazuella sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp., Vulcanobacillus sp., or a combination thereof. In some embodiments, the bacteria comprise bacteria belonging to the Firmicutes phylum. In some embodiments, the bacteria comprise rhizobacteria. In some embodiments, the rhizobacteria comprise Bacillus sp, Paenibacillus sp, or both. In some embodiments, bacteria comprise B. amyloliquefaciens, B. laterosporus, B. licheniformis, B. macerans, B. cereus, B. circulans, B. firmus, B. subtilis, B. megaterium, B. coagulans, B. brevis, B. sphaericus, B. thuringiensis, B. mycoides, B. cucumis, B. endophyticus, B. pumilus, B. velezensis, B. mucilaginosus, B. tequilensis, B. methylotrophicus, or any combination thereof. In some embodiments, the bacteria comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof. In some embodiments, the bacteria comprise Bacillus subtilis S3C23. In some embodiments, the bacteria comprise Bacillus subtilis MP2. In some embodiments, the bacteria comprise Paenibacillus polymyxa, Paenibacillus taohuashanense, Paenibacillus pocheonensis, Paenibacillus aceris, Paenibacillus catalpa, Paenibacillus rigui, Paenibacillus pabuli, Paenibacillus brasiliensis, or any combination thereof. In some embodiments, the bacteria comprise Paenibacillus polymyxa RO3C16, Paenibacillus taohuashanense TY4D5, Paenibacillus pocheonensis S2C3, Paenibacillus aceris VF2D2, Paenibacillus catalpa TY2B5, Paenibacillus rigui TY2D5, Paenibacillus pabuli PG2A8, or any combination thereof. In some embodiments, the bacteria comprise non-endospore forming bacteria. In some embodiments, the bacteria comprise bacteria belonging to the Proteobacteria phylum. In some embodiments, the bacteria comprise Klebsiella sp., Rhizobium sp., Bradyrhizobium sp., Ochrobactrum sp., Sinorhizobium sp., Xanthobacter sp., Methylobacterium sp., Actinomyces sp., Kosakonia sp., Azotobacter sp., Acetobacter sp., Herbaspirillum sp., Pseudomonas sp., Paraburkholderia sp., Ralstonia sp., Geobacter sp., Serratia sp., Pantoea sp., Ensifer sp., Enterobacter sp., or any combination thereof. In some embodiments, the bacteria comprise Ensifer adhaerens S3C10. In some embodiments, the bacteria comprise bacteria belonging to the Actinobacteria phylum. In some embodiments, the bacteria comprise Streptomyces sp., Coxiella sp., Frankia sp. In some embodiments, the bacteria comprise bacteria belonging to the Cyanobacteria phylum. In some embodiments, the bacteria comprise Cyanobacteria sp. In some embodiments, the bacteria comprise bacteria belonging to the Cloroflexi phylum. In some embodiments, the one or more microorganisms comprise one or more fungi associated with the plant seed. In some embodiments, the one or more fungi associated with the plant seed are disposed in an interspace between a seed coat and a seed embryo of the plant seed. In some embodiments, the one or more fungi associated with the plant seed are disposed as a coating of the plant seed. In some embodiments, the one or more fungi associated with the plant seed are applied with in-furrow techniques to the plant seed. In some embodiments, the one or more fungi associated with the plant seed are applied with spray techniques to the plant seed. In some embodiments, the one or more fungi associated with the plant seed are applied through irrigation to the plant seed. In some embodiments, the one or more fungi associated with the plant seed are disposed in an interspace between a seed pericarp and a seed aleurone cell layer of the plant seed. In some embodiments, the one or more fungi comprise Arbuscular Mycorrhizal fungi. In some embodiments, the one or more fungi comprise Ectomycorrhizal fungi. In some embodiments, the one or more fungi comprise fungi from the genus Trichoderma. In some embodiments, the one or more fungi comprise fungi from the genus Penicillium. In some embodiments, the one or more minerals comprise calcite, aragonite, dolomite, limestone, or any combination thereof. In some embodiments, the one or more minerals comprise CaCO₃, MgCO₃, CaMg(CO₃)₂, or any combination thereof. In some embodiments, the promotion of production of the one or more minerals comprises production of ammonia and a resulting increase in pH in a medium in which a plant derived from the plant seed is grown. In some embodiments, the one or more microorganisms are not naturally present in the interspace between the seed pericarp and the seed aleurone cell layer of the plant seed. In some embodiments, the plant seed is monocot seed or dicot seed. In some embodiments, the commercial plant seed is a maize seed, wheat seed, rice seed, sorghum seed, barley seed, rye seed, sugar cane seed, millet seed, oat seed, soybean seed, cotton seed, alfalfa seed, bean seed, quinoa seed, lentil seed, peanut seed, sunflower seeds, canola seeds, cassava seeds, oil palm seeds, potato seeds, sugar beet seeds, cacao seeds, coffee beans, lettuce seed, tomato seed, pea seed, or a cabbage seed.

Another aspect of the present disclosure is composition comprising a plant or a part thereof and one or more microorganisms associated with the plant or the part thereof, wherein the one or more microorganisms are, or are derived from, one or more microorganisms selected to produce or promote the formation of bicarbonate, carbonate or one or more minerals. In some embodiments, the plant or the part thereof is a plant root, a plant stem, a plant leaf, a plant seed, a plant fruit, a plant tuber, or a plant root nodule. In some embodiments, the plant or the part thereof comprise a commercial plant or part thereof. In some embodiments, the commercial plant or part thereof is maize, wheat, rice, sorghum, barley, rye, sugar cane, millet, oat, soybean, cotton, alfalfa, bean, quinoa, lentil, peanut, sunflower, canola, cassava, oil palm, potato, sugar beet, cacao, coffea, lettuce, tomato, pea, cabbage, fruit tree, nut tree, forestry tree, grassland, or turfgrass. In some embodiments, the part thereof is a plant seed and wherein the one or more microorganisms associated with the plant seed are disposed in an interspace between a seed coat and a seed embryo of the plant seed. In some embodiments, the one or more microorganisms associated with the plant or the part thereof are disposed as a coating of the plant or the part thereof. In some embodiments, the one or more microorganisms associated with the plant or the part thereof are applied through an irrigation-system to the plant seed. In some embodiments, the irrigation system comprises an in-furrow treatment technique. In some embodiments, the irrigation system comprises a spray technique. In some embodiments, the bicarbonate sequesters carbon. In some embodiments, the carbon is a gaseous carbon. In some embodiments, the gaseous carbon is carbon dioxide. In some embodiments, the carbonate sequesters carbon. In some embodiments, the carbon is a gaseous carbon. In some embodiments, the gaseous carbon is carbon dioxide. In some embodiments, the one or more minerals sequester carbon. In some embodiments, the carbon is a gaseous carbon. In some embodiments, the gaseous carbon is carbon dioxide. In some embodiments, the part thereof is a plant seed and wherein the one or more microorganisms associated with the plant seed are disposed in an interspace between a seed pericarp and a seed aleurone cell layer of the plant seed. In some embodiments, the one or more microorganisms comprises one or more carbonic anhydrase enzymes. In some embodiments, the one or more carbonic anhydrase enzymes comprise a carbonic anhydrase enzyme belonging to the alpha class. In some embodiments, the one or more carbonic anhydrase enzymes comprise a carbonic anhydrase enzyme belonging to the beta class. In some embodiments, the one or more carbonic anhydrase enzymes comprise a carbonic anhydrase enzyme belonging to the gamma class. In some embodiments, the one or more carbonic anhydrase enzymes comprise a carbonic anhydrase enzyme belonging to the delta class. In some embodiments, the one or more carbonic anhydrase enzymes comprise a carbonic anhydrase enzyme belonging to the zeta class. In some embodiments, the one or more carbonic anhydrase enzymes comprise a carbonic anhydrase enzyme belonging to the eta class. In some embodiments, the one or more carbonic anhydrase enzymes comprise a carbonic anhydrase enzyme belonging to the iota class. In some embodiments, the one or more microorganisms comprise a bacteria, archaea, fungi, or virus. In some embodiments, the one or more microorganisms comprise the bacteria. In some embodiments, the bacteria comprise endospore forming bacteria. In some embodiments, the bacteria comprise bacteria from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Pelospora sp., Pelotomaculum sp., Piscibacillus sp., Planfilum sp., Pontibacillus sp., Propionispora sp., Salinibacillus sp., Salsuginibacillus sp., Seinonella sp., Shimazuella sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp., Vulcanobacillus sp., or a combination thereof. In some embodiments, the bacteria comprise bacteria belonging to the Firmicutes phylum. In some embodiments, the bacteria comprise rhizobacteria. In some embodiments, the rhizobacteria comprise Bacillus sp, Paenibacillus sp, or both. In some embodiments, the bacteria comprise B. amyloliquefaciens, B. laterosporus, B. licheniformis, B. macerans, B. cereus, B. circulans, B. firmus, B. subtilis, B. megaterium, B. coagulans, B. brevis, B. sphaericus, B. thuringiensis, B. mycoides, B. cucumis, B. endophyticus, B. pumilus, B. velezensis, B. mucilaginosus, B. tequilensis, B. methylotrophicus, or any combination thereof. In some embodiments, the bacteria comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof. In some embodiments, the bacteria comprise Bacillus subtilis S3C23. In some embodiments, the bacteria comprise Bacillus subtilis MP2. In some embodiments, the bacteria comprise Paenibacillus polymyxa, Paenibacillus taohuashanense, Paenibacillus pocheonensis, Paenibacillus aceris, Paenibacillus catalpa, Paenibacillus rigui, Paenibacillus pabuli, Paenibacillus brasiliensis, or any combination thereof. In some embodiments, the bacteria comprise Paenibacillus polymyxa RO3C16, Paenibacillus taohuashanense TY4D5, Paenibacillus pocheonensis S2C3, Paenibacillus aceris VF2D2, Paenibacillus catalpa TY2B5, Paenibacillus rigui TY2D5, Paenibacillus pabuli PG2A8, or any combination thereof. In some embodiments, the bacteria comprise non-endospore forming bacteria. In some embodiments, the bacteria comprise bacteria belonging to the Proteobacteria phylum. In some embodiments, the bacteria comprise Klebsiella sp., Rhizobium sp., Bradyrhizobium sp., Ochrobactrum sp., Sinorhizobium sp., Xanthobacter sp., Methylobacterium sp., Actinomyces sp., Kosakonia sp., Azotobacter sp., Acetobacter sp., Herbaspirillum sp., Pseudomonas sp., Paraburkholderia sp., Ralstonia sp., Geobacter sp., Serratia sp., Pantoea sp., Ensifer sp., Enterobacter sp., or any combination thereof. In some embodiments, the bacteria comprise Ensifer adhaerens S3C10. In some embodiments, the bacteria comprise bacteria belonging to the Actinobacteria phylum. In some embodiments, the bacteria comprise Streptomyces sp., Coxiella sp., Frankia sp. In some embodiments, the bacteria comprise bacteria belonging to the Cyanobacteria phylum. In some embodiments, the bacteria comprise Cyanobacteria sp. In some embodiments, the bacteria comprise bacteria belonging to the Cloroflexi phylum. In some embodiments, the one or more microorganisms comprise one or more fungi associated with the plant or the part thereof. In some embodiments, the one or more fungi associated with the plant or the part thereof are disposed in an interspace between a seed coat and a seed embryo of the plant or the part thereof. In some embodiments, the one or more fungi associated with the plant or the part thereof are disposed as a coating of the plant or the part thereof. In some embodiments, the one or more fungi associated with plant or part thereof are applied with in-furrow techniques to the plant or the part thereof. In some embodiments, the one or more fungi associated with the plant or the part thereof are applied with spray techniques to the plant or the part thereof. In some embodiments, the one or more fungi associated with the plant or the part thereof are applied through the irrigation system to the plant or the part thereof. In some embodiments, the one or more fungi associated with the plant or the part thereof are disposed in an interspace between a seed pericarp and a seed aleurone cell layer of the plant or the part thereof. In some embodiments, the one or more fungi comprise Arbuscular Mycorrhizal fungi. In some embodiments, the one or more fungi comprise Ectomycorrhizal fungi. In some embodiments, the one or more fungi comprise fungi from the genus Trichoderma. In some embodiments, the one or more fungi comprise fungi from the genus Penicillium. In some embodiments, the one or more minerals comprise calcite, aragonite, dolomite, limestone, or any combination thereof. In some embodiments, the one or more minerals comprise CaCO₃, MgCO₃, CaMg(CO₃)₂, or any combination thereof. In some embodiments, the promotion of production of the one or more minerals comprises production of ammonia and a resulting increase in pH in a medium in which a plant derived from the plant or the part thereof is grown. In some embodiments, the part thereof is a plant seed and wherein the one or more microorganisms are not naturally present in the interspace between the seed pericarp and the seed aleurone cell layer of the plant or the part thereof. In some embodiments, the plant or the part thereof is monocot plant or dicot plant.

Another aspect of present disclosure is a composition comprising one or more microorganisms, wherein the one or more microorganisms are located at an interspace between a coating and a cell layer of a plant or a part thereof, and are, or are derived from, one or more microorganisms selected to produce or promote the formation of bicarbonate, carbonate or one or more minerals. In some embodiments, the plant or the part thereof is a plant root, a plant stem, a plant leaf, a plant seed, a plant fruit, a plant tuber, or a plant root nodule. In some embodiments, the plant or the part thereof comprise a commercial plant or part thereof. In some embodiments, the commercial plant or part thereof is maize, wheat, rice, sorghum, barley, rye, sugar cane, millet, oat, soybean, cotton, alfalfa, bean, quinoa, lentil, peanut, sunflower, canola, cassava, oil palm, potato, sugar beet, cacao, coffea, lettuce, tomato, pea, cabbage, fruit tree, nut tree, forestry tree, grassland, or turfgrass. In some embodiments, the part thereof is a plant seed and wherein the one or more microorganisms associated with the plant seed are disposed in an interspace between a seed coat and a seed embryo of the plant seed. In some embodiments, the one or more microorganisms associated with the plant or the part thereof are disposed as a coating of the plant or the part thereof. In some embodiments, the one or more microorganisms associated with the plant or the part thereof are applied through an irrigation-system to the plant seed. In some embodiments, the irrigation system comprises an in-furrow treatment technique. In some embodiments, the irrigation system comprises a spray technique. In some embodiments, the bicarbonate sequesters carbon. In some embodiments, the carbon is a gaseous carbon. In some embodiments, the gaseous carbon is carbon dioxide. In some embodiments, the carbonate sequesters carbon. In some embodiments, the carbon is a gaseous carbon. In some embodiments, the gaseous carbon is carbon dioxide. In some embodiments, the one or more minerals sequester carbon. In some embodiments, the carbon is a gaseous carbon. In some embodiments, the gaseous carbon is carbon dioxide. In some embodiments, the part thereof is a plant seed and wherein the one or more microorganisms associated with the plant seed are disposed in an interspace between a seed pericarp and a seed aleurone cell layer of the plant seed. In some embodiments, the one or more microorganisms comprises one or more carbonic anhydrase enzymes. In some embodiments, the one or more carbonic anhydrase enzymes comprise a carbonic anhydrase enzyme belonging to the alpha class. In some embodiments, the one or more carbonic anhydrase enzymes comprise a carbonic anhydrase enzyme belonging to the beta class. In some embodiments, the one or more carbonic anhydrase enzymes comprise a carbonic anhydrase enzyme belonging to the gamma class. In some embodiments, the one or more carbonic anhydrase enzymes comprise a carbonic anhydrase enzyme belonging to the delta class. In some embodiments, the one or more carbonic anhydrase enzymes comprise a carbonic anhydrase enzyme belonging to the zeta class. In some embodiments, the one or more carbonic anhydrase enzymes comprise a carbonic anhydrase enzyme belonging to the eta class. In some embodiments, the one or more carbonic anhydrase enzymes comprise a carbonic anhydrase enzyme belonging to the iota class. In some embodiments, the one or more microorganisms comprise a bacteria, archaea, fungi, or virus. In some embodiments, the one or more microorganisms comprise the bacteria. In some embodiments, the bacteria comprise endospore forming bacteria. In some embodiments, the bacteria comprise bacteria from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Pelospora sp., Pelotomaculum sp., Piscibacillus sp., Planfilum sp., Pontibacillus sp., Propionispora sp., Salinibacillus sp., Salsuginibacillus sp., Seinonella sp., Shimazuella sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp., Vulcanobacillus sp., or a combination thereof. In some embodiments, the bacteria comprise bacteria belonging to the Firmicutes phylum. In some embodiments, the bacteria comprise rhizobacteria. In some embodiments, the rhizobacteria comprise Bacillus sp, Paenibacillus sp, or both. In some embodiments, the bacteria comprise B. amyloliquefaciens, B. laterosporus, B. licheniformis, B. macerans, B. cereus, B. circulans, B. firmus, B. subtilis, B. megaterium, B. coagulans, B. brevis, B. sphaericus, B. thuringiensis, B. mycoides, B. cucumis, B. endophyticus, B. pumilus, B. velezensis, B. mucilaginosus, B. tequilensis, B. methylotrophicus, or any combination thereof. In some embodiments, the bacteria comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof. In some embodiments, the bacteria comprise Bacillus subtilis S3C23. In some embodiments, the bacteria comprise Bacillus subtilis MP2. In some embodiments, the bacteria comprise Paenibacillus polymyxa, Paenibacillus taohuashanense, Paenibacillus pocheonensis, Paenibacillus aceris, Paenibacillus catalpa, Paenibacillus rigui, Paenibacillus pabuli, Paenibacillus brasiliensis, or any combination thereof. In some embodiments, the bacteria comprise Paenibacillus polymyxa RO3C16, Paenibacillus taohuashanense TY4D5, Paenibacillus pocheonensis S2C3, Paenibacillus aceris VF2D2, Paenibacillus catalpa TY2B5, Paenibacillus rigui TY2D5, Paenibacillus pabuli PG2A8, or any combination thereof. In some embodiments, the bacteria comprise non-endospore forming bacteria. In some embodiments, the bacteria comprise bacteria belonging to the Proteobacteria phylum. In some embodiments, the bacteria comprise Klebsiella sp., Rhizobium sp., Bradyrhizobium sp., Ochrobactrum sp., Sinorhizobium sp., Xanthobacter sp., Methylobacterium sp., Actinomyces sp., Kosakonia sp., Azotobacter sp., Acetobacter sp., Herbaspirillum sp., Pseudomonas sp., Paraburkholderia sp., Ralstonia sp., Geobacter sp., Serratia sp., Pantoea sp., Ensifer sp., Enterobacter sp., or any combination thereof. In some embodiments, the bacteria comprise Ensifer adhaerens S3C10. In some embodiments, the bacteria comprise bacteria belonging to the Actinobacteria phylum. In some embodiments, the bacteria comprise Streptomyces sp., Coxiella sp., Frankia sp. In some embodiments, the bacteria comprise bacteria belonging to the Cyanobacteria phylum. In some embodiments, the bacteria comprise Cyanobacteria sp. In some embodiments, the bacteria comprise bacteria belonging to the Cloroflexi phylum. In some embodiments, the one or more microorganisms comprise one or more fungi associated with the plant or the part thereof. In some embodiments, the one or more fungi associated with the plant or the part thereof are disposed in an interspace between a seed coat and a seed embryo of the plant or the part thereof. In some embodiments, the one or more fungi associated with the plant or the part thereof are disposed as a coating of the plant or the part thereof. In some embodiments, the one or more fungi associated with plant or part thereof are applied with in-furrow techniques to the plant or the part thereof. In some embodiments, the one or more fungi associated with the plant or the part thereof are applied with spray techniques to the plant or the part thereof. In some embodiments, the one or more fungi associated with the plant or the part thereof are applied through the irrigation system to the plant or the part thereof. In some embodiments, the one or more fungi associated with the plant or the part thereof are disposed in an interspace between a seed pericarp and a seed aleurone cell layer of the plant or the part thereof. In some embodiments, the one or more fungi comprise Arbuscular Mycorrhizal fungi. In some embodiments, the one or more fungi comprise Ectomycorrhizal fungi. In some embodiments, the one or more fungi comprise fungi from the genus Trichoderma. In some embodiments, the one or more fungi comprise fungi from the genus Penicillium. In some embodiments, the one or more minerals comprise calcite, aragonite, dolomite, limestone, or any combination thereof. In some embodiments, the one or more minerals comprise CaCO₃, MgCO₃, CaMg(CO₃)₂, or any combination thereof. In some embodiments, the promotion of production of the one or more minerals comprises production of ammonia and a resulting increase in pH in a medium in which a plant derived from the plant or the part thereof is grown. In some embodiments, the part thereof is a plant seed and wherein the one or more microorganisms are not naturally present in the interspace between the seed pericarp and the seed aleurone cell layer of the plant or the part thereof. In some embodiments, the plant or the part thereof is monocot plant or dicot plant.

Another aspect of the present disclosure is a method of promoting mineralization, the method comprising: cultivating a plant or a part thereof and one or more microorganisms associated with the plant or the part thereof, wherein the one or more microorganisms are, or are derived from, microorganisms selected to produce or promote the formation of bicarbonate, carbonate, or one or more minerals. In some embodiments, the plant or the part thereof is a commercial plant, a plant root, a plant stem, a plant leaf, a plant seed, a plant fruit, a plant tuber, or a plant root nodule. In some embodiments, the one or more microorganisms associated with the plant or part thereof are disposed on the plant root or a rhizosphere of the plant or part thereof. In some embodiments, the one or more microorganisms associated with the plant or the part thereof are disposed on the plant root or the rhizosphere of the plant or the part thereof by an irrigation system. In some embodiments, the irrigation system comprises an in-furrow treatment technique. In some embodiments, the irrigation system comprises a spray technique. In some embodiments, the plant or part thereof is derived from a seedling, which is integrated through the irrigation system with the microorganisms to stimulate production of the one or more minerals by the plant or part thereof. In some embodiments, the bicarbonate sequesters carbon. In some embodiments, the carbon is a gaseous carbon. In some embodiments, the gaseous carbon is carbon dioxide. In some embodiments, the carbonate sequesters carbon. In some embodiments, the carbon is a gaseous carbon. In some embodiments, the gaseous carbon is carbon dioxide. In some embodiments, the one or more minerals sequester carbon. In some embodiments, the carbon is a gaseous carbon. In some embodiments, the gaseous carbon is carbon dioxide. In some embodiments, the one or more microorganisms comprise bacteria, archaea, a fungi, or a virus. In some embodiments, the one or more microorganisms comprise the bacteria. In some embodiments, the bacteria comprise endospore forming bacteria. In some embodiments, bacteria comprise rhizobacteria. In some embodiments, the rhizobacteria comprise Bacillus sp, Paenibacillus sp, or both. In some embodiments, the bacteria comprise B. amyloliquefaciens, B. laterosporus, B. licheniformis, B. macerans, B. cereus, B. circulans, B. firmus, B. subtilis, B. sphaericus, B. megaterium, B. coagulans, B. brevis, B. thuringiensis, B. mycoides, B. cucumis, B. endophyticus, B. pumilus, B. velezensis, B. mucilaginosus, B. tequilensis, B. methylotrophicus, or any combination thereof. In some embodiments, the bacteria comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof. In some embodiments, the bacteria comprise Bacillus subtilis S3C23. In some embodiments, the bacteria comprise Bacillus subtilis MP2. In some embodiments, the one or more microorganisms comprise one or more fungi associated with the plant or the part thereof. In some embodiments, the one or more fungi associated with the plant or the part thereof are disposed on the plant root or the rhizosphere of the plant or the part thereof by the irrigation system. In some embodiments, the one or more fungi comprise Arbuscular Mycorrhizal fungi. In some embodiments, the one or more fungi comprise Ectomycorrhizal fungi. In some embodiments, the one or more fungi comprise fungi from the genus Trichoderma. In some embodiments, the one or more fungi comprise fungi from the genus Penicillium. In some embodiments, the one or more microorganisms produces the formation of one or more carbonic anhydrase enzymes. In some embodiments, the one or more microorganisms produces the formation of one or more carbonic anhydrase enzymes belonging to the alpha class. In some embodiments, the one or more microorganisms produces the formation of one or more carbonic anhydrase enzymes belonging to the beta class. In some embodiments, the one or more microorganisms produces the formation of one or more carbonic anhydrase enzymes belonging to the gamma class. In some embodiments, the one or more carbonic anhydrase enzymes comprise a carbonic anhydrase enzyme belonging to the delta class. In some embodiments, the one or more carbonic anhydrase enzymes comprise a carbonic anhydrase enzyme belonging to the zeta class. In some embodiments, the one or more carbonic anhydrase enzymes comprise a carbonic anhydrase enzyme belonging to the eta class. In some embodiments, the one or more carbonic anhydrase enzymes comprise a carbonic anhydrase enzyme belonging to the iota class. In some embodiments, the one or more minerals comprise calcite, aragonite, dolomite, limestone, or any combination thereof. In some embodiments, the promotion of production of the one or more minerals comprises production of ammonia and a resulting increase in pH in a medium in which the plant or the part thereof is grown. In some embodiments, the one or more microorganisms are not naturally present on the one or more roots. In some embodiments, the plant or the part thereof is monocot plant or dicot plant. In some embodiments, the plant or the part thereof comprise a commercial plant or part thereof. In some embodiments, the commercial plant or part thereof is comprised of a group consisting essentially of plant is maize, wheat, rice, sorghum, barley, rye, sugar cane, millet, oat, soybean, cotton, alfalfa, bean, quinoa, lentil, peanut, sunflower, canola, cassava, oil palm, potato, sugar beet, cacao, coffea, lettuce, tomato, pea, cabbage, fruit tree, nut tree, forestry tree, grassland, or turfgrass.

Another aspect of the present disclosure is a method of sequestering carbon, the method comprising: cultivating a plant or a part thereof and one or more microorganisms associated with the plant or the part thereof; wherein the one or more microorganisms are, or are derived from, microorganisms selected to produce or promote the formation of one or more carbonaceous minerals, thereby sequestering carbon. In some embodiments, the plant or the part thereof is a plant root, a plant stem, a plant leaf, a plant seed, a plant fruit, a plant tuber, or a plant root nodule. In some embodiments, the plant or the part thereof comprise a commercial plant or part thereof. In some embodiments, the commercial plant or part thereof is comprised of a group consisting essentially of plant is maize, wheat, rice, sorghum, barley, rye, sugar cane, millet, oat, soybean, cotton, alfalfa, bean, quinoa, lentil, peanut, sunflower, canola, cassava, oil palm, potato, sugar beet, cacao, coffea, lettuce, tomato, pea, cabbage, fruit tree, nut tree, forestry tree, grassland, or turfgrass. In some embodiments, the one or more carbonaceous minerals comprise one or more gaseous carbonating species. In some embodiments, the one or more gaseous carbonating species comprise carbon monoxide, methane, or carbon dioxide. In some embodiments, the one or more gaseous carbonating species is the carbon dioxide. In some embodiments, the one or more microorganisms associated with the plant are disposed on the plant root or a rhizosphere of the plant or the part thereof. In some embodiments, the one or more microorganisms associated with the plant are disposed on the plant root or the rhizosphere of the plant or the part thereof by an irrigation system. In some embodiments, the irrigation system comprises an in-furrow treatment technique. In some embodiments, the irrigation system comprises a spray technique. In some embodiments, the plant or part thereof is derived from a seedling, which is integrated through the irrigation system with the microorganisms to stimulate production of the one or more minerals by the plant or part thereof. In some embodiments, the one or more microorganisms comprise bacteria, archaea, a fungi, or a virus. In some embodiments, the one or more microorganisms comprise the bacteria. In some embodiments, the bacteria comprise endospore forming bacteria. In some embodiments, the bacteria comprise rhizobacteria. In some embodiments, the rhizobacteria comprise Bacillus sp, Paenibacillus sp, or both. In some embodiments, the bacteria comprise B. amyloliquefaciens, B. laterosporus, B. licheniformis, B. macerans, B. cereus, B. circulans, B. firmus, B. subtilis, B. megaterium, B. coagulans, B. brevis, B. sphaericus, B. thuringiensis, B. mycoides, B. cucumis, B. endophyticus, B. pumilus, B. velezensis, B. mucilaginosus, B. tequilensis, B. methylotrophicus, or any combination thereof. In some embodiments, the bacteria comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof. In some embodiments, the bacteria comprise Bacillus subtilis S3C23. In some embodiments, the bacteria comprise Bacillus subtilis MP2. In some embodiments, the one or more microorganisms comprise one or more fungi associated with the plant or the part thereof. In some embodiments, the one or more fungi associated with the plant or the part thereof are disposed on the plant root or the rhizosphere of the plant or the part thereof by the irrigation system. In some embodiments, the one or more fungi comprise Arbuscular Mycorrhizal fungi. In some embodiments, the one or more fungi comprise Ectomycorrhizal fungi. In some embodiments, the one or more fungi comprise fungi from the genus Trichoderma. In some embodiments, the one or more fungi comprise fungi from the genus Penicillium. In some embodiments, the one or more microorganisms are not naturally present on the one or more roots. In some embodiments, the plant or the part thereof is a monocot plant or a dicot plant. In some embodiments, the one or more microorganisms produces the formation of one or more carbonic anhydrase enzymes. In some embodiments, the one or more microorganisms produces the formation of one or more carbonic anhydrase enzymes belonging to the alpha class. In some embodiments, the one or more microorganisms produces the formation of one or more carbonic anhydrase enzymes belonging to the beta class. In some embodiments, the one or more microorganisms produces the formation of one or more carbonic anhydrase enzymes belonging to the gamma class. In some embodiments, the one or more carbonic anhydrase enzymes comprise a carbonic anhydrase enzyme belonging to the delta class. In some embodiments, the one or more carbonic anhydrase enzymes comprise a carbonic anhydrase enzyme belonging to the zeta class. In some embodiments, the one or more carbonic anhydrase enzymes comprise a carbonic anhydrase enzyme belonging to the eta class. In some embodiments, the one or more carbonic anhydrase enzymes comprise a carbonic anhydrase enzyme belonging to the iota class.

Another aspect of the present disclosure is a composition comprising one or more microorganisms, wherein the one or more microorganisms are, or are derived from, microorganisms selected to produce or promote the formation of bicarbonate, carbonate, or one or more minerals. In some embodiments, the plant or the part thereof is a plant root, a plant stem, a plant leaf, a plant seed, a plant fruit, a plant tuber, or a plant root nodule. In some embodiments, the plant or the part thereof comprise a commercial plant or part thereof. In some embodiments, the commercial plant or part thereof is maize, wheat, rice, sorghum, barley, rye, sugar cane, millet, oat, soybean, cotton, alfalfa, bean, quinoa, lentil, peanut, sunflower, canola, cassava, oil palm, potato, sugar beet, cacao, coffea, lettuce, tomato, pea, cabbage, fruit tree, nut tree, forestry tree, grassland, or turfgrass. In some embodiments, the bicarbonate sequesters carbon. In some embodiments, the carbon is a gaseous carbon. In some embodiments, the gaseous carbon is carbon dioxide. In some embodiments, the carbonate sequesters carbon. In some embodiments, the carbon is a gaseous carbon. In some embodiments, the gaseous carbon is carbon dioxide. In some embodiments, the one or more minerals sequester carbon. In some embodiments, the carbon is a gaseous carbon. In some embodiments, the gaseous carbon is carbon dioxide. In some embodiments, the one or more microorganisms comprise bacteria, archaea, a fungi, or a virus. In some embodiments, the one or more microorganisms comprise the bacteria. In some embodiments, the bacteria comprise endospore forming bacteria. In some embodiments, the bacteria comprise rhizobacteria. In some embodiments, the rhizobacteria comprise Bacillus sp, Paenibacillus sp, or both. In some embodiments, the bacteria comprise B. amyloliquefaciens, B. laterosporus, B. licheniformis, B. macerans, B. cereus, B. circulans, B. firmus, B. subtilis, B. sphaericus, B. megaterium, B. coagulans, B. brevis, B. thuringiensis, B. mycoides, B. cucumis, B. endophyticus, B. pumilus, B. velezensis, B. mucilaginosus, B. tequilensis, B. methylotrophicus, or any combination thereof. In some embodiments, the bacteria comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof. In some embodiments, the bacteria comprise Bacillus subtilis S3C23. In some embodiments, the bacteria comprise Bacillus subtilis MP2. In some embodiments, the one or more microorganisms comprise one or more fungi associated with the plant or the part thereof. In some embodiments, the one or more fungi associated with the plant or the part thereof are disposed on the plant root or the rhizosphere of the plant or the part thereof by the irrigation system. In some embodiments, the one or more fungi comprise Arbuscular Mycorrhizal fungi. In some embodiments, the one or more fungi comprise Ectomycorrhizal fungi. In some embodiments, the one or more fungi comprise fungi from the genus Trichoderma. In some embodiments, the one or more fungi comprise fungi from the genus Penicillium. In some embodiments, the one or more minerals comprise calcite, aragonite, dolomite, limestone, or any combination thereof. In some embodiments, the promotion of production of the one or more minerals comprises production of ammonia and a resulting increase in pH in a medium in which the plant or the part thereof is grown. In some embodiments, the one or more microorganisms comprises one or more carbonic anhydrase enzymes. In some embodiments, the one or more carbonic anhydrase enzymes comprise a carbonic anhydrase enzyme belonging to the alpha class. In some embodiments, the one or more carbonic anhydrase enzymes comprise a carbonic anhydrase enzyme belonging to the beta class. In some embodiments, the one or more carbonic anhydrase enzymes comprise a carbonic anhydrase enzyme belonging to the gamma class. In some embodiments, the one or more carbonic anhydrase enzymes comprise a carbonic anhydrase enzyme belonging to the delta class. In some embodiments, the one or more carbonic anhydrase enzymes comprise a carbonic anhydrase enzyme belonging to the zeta class. In some embodiments, the one or more carbonic anhydrase enzymes comprise a carbonic anhydrase enzyme belonging to the eta class. In some embodiments, the one or more carbonic anhydrase enzymes comprise a carbonic anhydrase enzyme belonging to the iota class.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The novel features of the methods and compositions described herein are set forth with particularity in the appended claims. A better understanding of the features and advantages of the present methods and compositions described herein will be obtained by reference to the following detailed description that sets forth illustrative embodiments, in which the principles of the methods and compositions described herein are utilized, and the accompanying drawings of which:

FIG. 1 High CO₂ concentration at plant's rhizosphere represents an opportunity to sequester carbon mediated by carbonic anhydrase-producing microorganisms.

FIG. 2 depicts the two-stage plant enhancement strategy described herein. 101 exemplifies a monocot seed. The seed treatment processes described herein incorporate bacteria (or endospores thereof) 106 between the aleurone layer 103 and the pericarp 102. The aleurone layer 103 separates the endosperm 104 from the outer layers.

FIG. 3 shows a process diagram which depicts the seed treatment process (Microprime™ seed treatment process).

FIG. 4 depicts the present methodology for obtaining stable microbial technology seed treatments (Microprime™).

FIG. 5A shows the space inside the corn seed (Zea mays) where the bacteria are located after a Microprime™ seed treatment.

FIG. 5B shows a zoomed in image of the space inside a corn seed (Zea mays) where bacteria are located after a Microprime™ seed treatment.

FIG. 6A-6B depict the population increase and the logarithm, respectively, of the population increase of Bacillus subtilis (strain S3C23) endospores inside Microprime™ maize seeds prior to their germination. Seeds sown in agar plates with Murashige and Skoog 50% medium initially had 164,000 colony forming units (CFU) at the time of sowing. After three days the population inside the seed reached levels of 7,200,000 CFU/seed. Each point represents the mean±standard error of three pools of five seeds per pool.

FIG. 7A-7B depicts the population increase and logarithm, respectively, of the population increase of Bacillus subtilis (strain S3C23) endospores inside Microprime™ rice seeds prior to their germination. Seeds sown in agar plates with Murashige and Skoog 50% medium initially had 51,167 colony forming units (CFU) at the time of the sowing. After three days the population inside the seed reached levels of 36,666,667 CFU/seed. Each point represents the mean±standard error of three pools of five seeds per pool.

FIG. 8A-8B depicts the population increase and the logarithm, respectively of the population increase of Bacillus subtilis (strain S3C23) endospores inside Microprime™ soybean seeds prior to their germination. Seeds sown in agar plates with Murashige and Skoog 50% medium initially had 123,333 colony forming units (CFU) at the time of the sowing. After three days the population inside the seed reached levels of 674,666,667 CFU/seed. Each point represents the mean±standard error of three pools of five seeds per pool.

FIG. 9 depicts the viability of Bacillus subtilis endospores (strain S3C23) inside Microprime™ maize seeds in a time frame of one to 18 months after the Microprime™ seed treatment. Each time point represents the mean±standard error of three pools of five seeds per pool. The germination percentage of the S3C23 Microprime™ seeds at 18 months was the same as the untreated seeds, 98.33% (n=60 seeds per treatment).

FIG. 10 depicts the carbonic anhydrase activity of lysate samples prepared from liquid cultures of Bacillus subtilis (strain S3C23) as measured by the enzymatic hydrolysis of 4-nitrophenyl acetate to 4-nitrophenol and acetic acid, protocol according to Zhuang et al, 2018, which is herein incorporated by reference in its entirety. Values are given as carbonic anhydrase (CA) activity/total protein (mg/ml). Activity in samples exhibits a steep increase at pH 8.5 compared to pH 7.5, in line with the expected pH-dependence of carbonic anhydrases.

FIG. 11 depicts the enzyme-induced precipitation of carbonate and bicarbonate ions as calcium carbonate (CaCO₃). Lysate prepared from Bacillus subtilis (strain S3C23), or recombination Bovine Carbonic Anhydrase, or Bovine Serum Albumin (BSA, negative control) was mixed with CaCl₂) (final concentration 100 mM) and Tris pH 8 (final concentration 200 mM) and 50% CO₂-saturated water (added last to start the reaction). Time to calcium carbonate formation was assessed visually and recorded. Values are normalized to time to abiotic CaCO₃ precipitation. Recombinant Bovine CA rapidly induced precipitation in a dose-dependent manner. 500 ul S3C23 lysate induced precipitation markedly faster than abiotic precipitation.

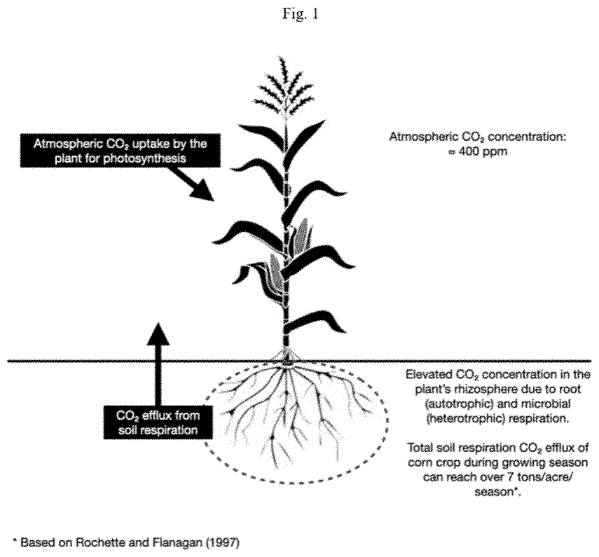

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Land used for plant cultivation provides an ideal location for CO₂ sequestration due to the significantly elevated CO₂ levels compared to atmospheric CO₂ levels as a result of plant root and soil microbiome respiration.

As described herein, plant seeds, and the plants derived from plant seeds, can be modified with one or more microorganisms described herein to enhance bicarbonate production and mineral formation in a given plot of soil wherein the plant is cultivated. The slow and rate limiting step of bicarbonate generation can be accelerated by the use of an enzyme called Carbonic Anhydrase (CA). CA which is a zinc-containing metalloenzyme catalyzes the reversible hydration of CO₂ into bicarbonate and a proton around 10⁷ higher than the non-enzymatic process. CA is the fastest enzyme known to catalyze the reversible hydration of CO₂ and the typical rate of different types of CAs can reach 10-10⁶ s⁻¹. CA is ubiquitously distributed in animals, plants, archaea, and bacteria. This includes many fungi and bacteria commonly found in soil which produce intracellular and extracellular CAs. Extremely high selectivity of CA towards CO₂ makes it a perfect candidate for CO₂ sequestration of gases mixed with other polluting gases. There are a number of compelling evidence showing the role of CA to sequester atmospheric CO₂ to bicarbonate (HCO₃⁻) which can be precipitated to form minerals by reacting with various cations (20, 21).

According to the present disclosure, one or more microorganisms may be selected for on the basis of high CA activity or CA activity sufficient to generate a desired amount of HCO₃⁻ in a given plot of soil. These microorganisms can be associated with various plant seeds, plants, and/or the root rhizosphere as described herein. In some embodiments, microorganisms that have low expression levels of CA can be genetically modified to enhance CA expression. In some embodiments, microorganisms that do not express CA can be genetically modified to express CA.

Plants derived from the compositions described herein can be cultivated in a given plot of soil to enhance bicarbonate and mineral formation in the soil.

A Carbonic Anhydrase (CA) induced mineralization process starts with a reversible hydration of CO₂ to bicarbonate ions (shown in the equation 1).

CO₂+H₂O↔HCO₃⁻+H⁺ (1)

The generation of carbonate ions from bicarbonates via hydrolysis is the second step in mineralization (shown in the equation 2). These carbonate and bicarbonate ions increase the pH of the medium. The pH of the medium can further be elevated up to 9.2 by the production of ammonia by the microorganisms.

HCO₃⁻+OH⁻↔CO₃²⁻+H₂O (2)

The final step of mineralization includes precipitation of carbonate and bicarbonate ions by cations (equation 3).

Ca²⁺+CO₃²⁻→CaCO₃ (3)

Because the soil has different types of cations present naturally, CA expressing soil microorganisms found on roots and/or in the rhizosphere are well suited to convert CO₂ to minerals sustainably. CA can also play a secondary role to elevate the supersaturation of some minerals in the liquid medium by releasing a large number of carbonate and bicarbonate. Biomineralization process can be further accelerated by a gene cluster known as lcfA (comprised of five genes lcfA, ysiA, ysiB, etfB, and etfA) that plays a role in carbonate biomineralization in Bacillus subtilis.

To date no technology is available that can ensure 100% delivery of microorganisms to site of CO₂ evolution (roots) for effective CO₂ sequestration. Integrating the compositions described herein with Microprime™ is highly suitable in agriculture practices to not only maintain the productivity of soil but also to capture CO₂ that could otherwise be released to the atmosphere. Additionally, the methods and compositions described here are cost-effective as it costs only $0.20 per acre and uses eco-friendly formulated environmental microorganisms that pose no threat to either the agricultural land or crops.

The microorganisms described herein would decrease the levels of carbon output thus increase terrestrial carbon sequestration by trapping CO₂ in various forms. The microorganisms described herein employ a variety of mechanisms to capture CO₂ efficiently into multiple microbial products. One of the prominent products would be bicarbonate and minerals (solids). Minerals may include calcite, aragonite, dolomite and limestone. One of the microbial products, limestone (CaCO₃), apart from sequestering gaseous CO₂ would be beneficial for the agricultural lands. Formation of calcite in soil could obviate the use of limestone treatment by farmers to maintain the productivity of soil. Limestone improves the structure of the soil and increases its pH.

### Compositions Comprising Plant Seeds and Bacteria

In certain aspects, disclosed herein is a composition comprising a plant seed and one or more microorganisms associated with said plant seed, wherein said one or more microorganisms are, or are derived from, microorganisms selected to produce or promote the formation of one or more minerals.

### Biopriming and Seed Treatment Methodology: Microprime™

A typical seed priming protocol includes the steps of soaking the seeds in any solution containing a required priming agent (inorganic and organic salts, nanoparticles, plant growth regulating substances and/or plant growth promoting bacteria) followed by re-drying the seeds. This results into the start of the germination process except by the radicle emergence, as shown in Heydecker et al., 1973; Mahakham et al., 2017; McDonald, 1999; Song et al., 2017; Wright et al., 2003, which are herein incorporated by reference in their entirety. Seed priming using osmotic solutions (osmopriming) has been around for many decades (Heydecker et al., 1973) and is now a common commercial practice in selected high value horticultural seeds. This concept was also extended to hydropriming in cereal and legume crops and the “on farm” priming technique has been revived (Harris et al., 2001). In recent years, several metal- and carbon-based nanoparticles (e.g., AgNPs16, AuNPs5, CuNPs17,18, ZnNPs17,18, fullerene22 and carbon23 nanotubes, etc.) have been applied as seed priming agents for promoting seed germination, seedling growth and stress tolerance in some crops (Mahakham et al., 2017). Amongst different priming techniques (e.g. hydropriming, osmopriming, nanopriming, etc.) when this procedure is performed using microbial cells, the inner spaces within a seed have potentially ideal conditions for the bacterial inoculation and colonization McQuilken et al., 1998; Ashraf and Foolad, 2005; Bennett et al., 2009; Tabassum et al., 2018; Wright et al., 2003, which are herein incorporated by reference in their entirety.

Since the early 90's the biopriming method has been extensively used for a wide range of crops and has been undoubtedly recognized as an environmentally friendly agrotechnology O'Callaghan, 2016; Taylor and Harman, 1990, which are herein incorporated by reference in their entirety. Sometimes, the biopriming technique is wrongly defined as the application of whole microorganisms, their exudates or some biologically active compounds on the outside of the seed, which are provided by El-Mougy and Abdel-Kader, 2008; Müller and Berg, 2008; Song et al., 2017; Saber et al., 2012, which are herein incorporated by refereeing in their entirety. Being more accurately, biopriming incorporates biological (inoculation of seed with beneficial microorganism) and physiological elements (seed hydration) into the seed, by promoting the rate and uniformity emergence of seedlings and also improving the plant traits. Seeds treated with microorganisms differ fundamentally from other biological seed treatments in that while performing the seed treatment with microorganisms the cells may be alive and so the colonization and proliferation of the added microorganisms must occur inside the seeds. However, most literature from the previous state of art, is not rigorous on explaining the differences in detail. Specifically, no results or studies have been yet reported on 1) the survival and/or proliferation of the biological agents inside the seed through relevant time frames (several months), 2) seed shelf-life and effective germination after several months after treatment, 3) effective microbe inoculum and plant interaction after relevant time being the seed stored and 4) economically viable methodologies (taking into account relevant factors such as seed treatment required time, inputs and energy) with the potential of being scalable and thus being implementable within a traditional seed business model. Moreover, bio-osmopriming have solely demonstrated to significantly enhance the uniformity of the germination and plant growth traits when associated with bacterial coating procedures Bennett et al., 2009; Raj et al., 2004; Sharifi, 2011; Sharifi et al., 2011; Shariffi et al., 2012, which are herein incorporated by reference in their entirety. Several researchers have reported incubation time from 20 min to several days Bennett et al., 2009; Bennett and Whipps, 2008b, 2008a; Murunde and Wainwright, 2018, which are herein incorporated by reference in their entirety. As well, cell suspension broadly ranged from 10⁵ to 10⁹ cells per gram of seed and depending on the type of the biological agent (i.e: spores, endospore or vegetative cells) (Wright et al., 2003; Saber et al., 2012; Raj et al., 2004; Murunde and Wainwright, 2018). In fact, the biopriming has been practiced and explained by different researchers in several ways, but is still an ambiguous approach which needs to be explored and discussed Bennett et al., 2009; Callan et al., 1990, 1991; Chakraborty et al., 2011; Mirshekari et al., 2012; Moeinzadeh et al., 2010; Raj et al., 2004; Reddy, 2013; Sharifi, 2011; Sharifi et al., 2011; Sharifi et al., 2012, which are herein incorporated by reference in their entirety.

According to the state of the art, the use of Bacillus sp. exudates to trigger immunity on cucumber plants was explained by Song et al., (Song et al., 2017). This approach have several misleading results both in method and scope because it 1) Does not use the bacterial inocula or its derived plant growth promoting agents but instead the seed is bioprimed by a compound based on peptides; 2) Does not incorporates living microorganisms inside the seed for them or its exudates to be in contact with the embryo at early post-dormant stage of seed germination; 3) Does not confirms if the biological agent (e.g. cyclodipeptides) have entered the seed and primed a PGP effect (changes in genes expression) at early stage of the plant embryo (previous to the pericarp rupture); and 4) Does not inform on the stability of the elicitors of plant immunity triggers through time. This last issue is particularly relevant since a commercially feasible microbial technology for agriculture must have to be stable through a relatively long period of time (e.g. more than six months) in order to be compatible with current agricultural distribution systems. In addition, the biological priming agent used in this referenced work, is particularly unstable through time and susceptible to be changed by abiotic and biotic environmental factors (e.g. temperature, pH, biodegradation activity by other microorganisms, etc.).

Serratia plymuthica strain HRO-C48 was reported as biological agent for inoculation procedures on seeds (Müller and Berg, 2008). This work attempted to compare three different techniques as pelleting, film coating and bio-osmopriming. In spite of the cells numbers per seed that was determined immediately after seed treatment and storage, authors have failure in accurately quantify the shelf-life of the product for it to be a commercially feasible for the agriculture industry. In fact, the strain HRO-C48 viability was just determined over an extremely short storage period (30 days). An additional ambiguous topic reported by the authors relies on the biopriming optimization procedures since 1) a high initial cell density was adjusted for the seed immersion and, 2) long incubation time of the seeds in the presence of the biological agent was used (reported as 12 hours). Certainly, all of this aspects are often not feasible parameters for an industrial and commercial implementation of the method (Müller and Berg, 2008).

Some other works pointing out the incorporation of synthetic microorganism formulations inside the seed were also reported in the state of the art. For instance, the US Patent 2016/0338360 A1 and 2016/0330976 A1 have referred to a seed containing beneficial bacteria. The methods presented in both of these referenced works are based on the direct inoculation of flowers and different parts of the plant in order to finally obtain seeds containing the desired microorganisms Mitter et al, 2016a, 2016b, which are herein incorporated by reference in their entirety.

Disclosed herein is a new, effective and reliable alternative to traditional biopriming technology that directly tackles the previously described issues. The proposed seed treatment method, denominated Microprime™, is a well-designed, calculated, executed and controlled process for obtaining commercial seeds with desired microorganisms. Precisely, disclosed herein is a stable microbial seed treatment methodology by which is incorporated a single microorganism and/or a synthetic consortia of microorganisms and/or its exudates and/or its individualized biomolecules inside of seeds through an industrially scalable process, which takes into account the process cost, time and energy, the technology stability through time (for both the plant embryo and the inoculant), the multi-soil compatibility, the stability under different environmental conditions and also compatibility with the traditional distribution chain for agricultural inputs. The method involves a controlled, economical and fast imbibition of seeds in an aqueous solution of an osmotically active liquid media supplemented with an specific amount of the beneficial microorganisms or a synthetic consortia of microorganisms and/or its exudates and/or its individualized biomolecules, in addition to a surfactant to enhance intra-seed permeability and/or a group of nutrients to enhance the microorganism colonization inside the seed and/or a supplemental reagent for enhancing bacterial endospore formation. The biological agent survival and the extended shelf-life of the treated seed are guaranteed by the Microprime™ seed technology.

The compositions and methods disclosed herein propose a novel strategy for enabling plant traits and enhance its yield. The strategy is based on two effects in the plant seed that are achieved by the implementation of a specific seed treatment method (Microprime™) explained below:

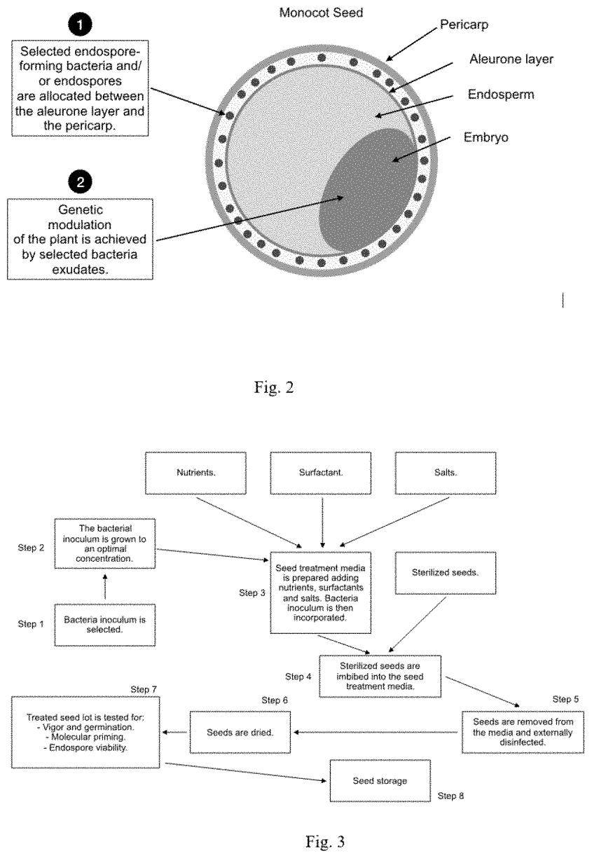

1. Loading into the seed functional bacteria: endospore-forming bacteria and/or endospores are loaded into the seed by the implementation of the current seed treatment method. As a result of the Microprime™ seed treatment, endospore-forming bacteria and/or endospores are allocated into the seed in an interspace located between the seed pericarp and its aleurone cell layer, as is shown in FIG. 2 and FIGS. 5A & 5B. The endospore-forming bacteria and/or endospores incorporated into the seed correspond to strains which have the ability to effectively colonize the plant rhizosphere and also have the ability to sequester CO₂ by converting it into bicarbonate and ultimately carbonate minerals. The endospore-converting ability of the selected bacteria and its allocation inside the seed guarantees the stability after the Microprime™ seed treatment and during the entire commercial storage. This process is confirmed by bacterial cell count in time.

In order for the methods and compositions disclosed herein to have value and real industrial-scale applicability, it is necessary that the method to be cost efficient and scalable. In a seed treatment process like the ones disclosed herein, there are several steps that require time, inputs and energy. The method and the compositions disclosed herein have as a first priority making the seed treatment processing cost and time as low as possible. The Microprime™ methodology aims to make the seed treatment process effective when carried out at room temperature (between 20 and 24° C.) while performing the seed imbibition during less than 20 minutes to 16 hours. The latter is not trivial to achieve, since in addition to having a minimum desirable number of bacteria, endospore-forming bacteria and/or endospores within the seeds after the Microprime™ seed treatment, it is necessary for the bacteria remain stable and viable over time, so, the seeds (as a product) can undergo unaffected through storage, packaging, logistics, and sowing processes, as is done the same with a traditional seed without Microprime™ seed treatment.

The proposed methodology consists of imbibing the previously disinfected seeds into a seed treatment media containing nutrients, surfactants and salts (henceforth Microprime™ solution). FIG. 3 shows a process diagram which depicts the seed treatment process.

### Stability of Bacterial Seed Treatment

The stability of the bacteria within the seed over time is not a simple nor an obvious issue to address. When incorporating the bacteria into the seed using the seed treatment methodology disclosed herein (Microprime™ seed treatment), for the case of a corn seed the place within the seed where the bacteria is located is shown in FIGS. 5A & 5B.

In FIG. 5A it can be appreciated that the space inside the corn seed where the bacteria marked with a red fluorescent protein (RFP) are lodged after the Microprime™ seed treatment (pink filaments). This place is the interspace between the seed pericarp and the seed aleurone cells layer, which separates the endosperm and embryo from outer layers. This is a place where some microorganisms can be comfortable for a limited period of time, after which due to depletion of available nutrients necessarily the cell will die or in case of some specific microorganisms, start a process of endosporulation (bacteria from the Firmicutes, Proteobacteria and Actinobacteria Phylum). The benefit of being deposited in the aforementioned place is that the microorganisms are protected from external elements that could affect their immediate integrity such as other microorganisms or dehydration.

To tackle the viability issue for longer periods of time due to the lack of nutrients, the methodology will depend on the type of bacteria to cope with it. There are bacteria that under certain conditions (mainly in scenarios where they sense feasibility risk), they have the ability to stop multiplying and enter to a physical state called endospore. As an endospore, the bacterium enters a dormant scenario in which it may be absent from nutrients for extended periods of time. For bacteria, mainly from the Firmicutes, Proteobacteria and Actinobacteria phylum, which have the capacity to generate endospores, the Microprime™ solution is supplemented with certain salts that will push the bacteria to enter this state of lethargy once it is incorporated into the seed. By doing the latter the viability of the bacteria within the seed is ensured over time. When the endospore is found again in favorable conditions of moisture and nutrients (for instance when the seed is sowed), it reverts to an active-bacteria state (vegetative cell) and starts normal functions and vegetative reproduction.

Another strategy is to supplement the Microprime™ solution directly with endospores rather than to push the bacteria to convert while performing the seed treatment process. The later had shown better yields in terms of endospores per seed that can be found after a Microprime™ seed treatment.

| Phylum | Firmicutes | | | Proteobacteria | Actinobacteria |
|---|---|---|---|---|---|
| Genus | Acetonema sp. | Halonatronum sp. | Sporohalobacter sp. | Actinomyces sp. | Coxiella sp. |
| | Alkalibacillus sp. | Hellobacterium sp. | Sporolactobacillus sp. | | |
| | Ammoniphilus sp. | Heliophilum sp. | Sporomusa sp. | | |
| | Amphibacillus sp. | Laceyella sp. | Sporosarcina sp. | | |
| | Anaerobacter sp. | Lentibacillus sp. | Sporotalea sp. | | |
| | Anaerospora sp. | Lysinibacillus sp. | Sporotomaculum sp. | | |
| | Aneurinibacillus sp. | Mahella sp. | Syntrophomonas sp. | | |
| | Anoxybacillus sp. | Metabacterium sp. | Syntrophospora sp. | | |
| | Bacillus sp. | Moorella sp. | Tenuibacillus sp. | | |
| | Brevibacillus sp. | Natroniella sp. | Tepidibacter sp. | | |
| | Caldanaerobacter sp. | Oceanobacillus sp. | Terribacillus sp. | | |
| | Caloramator sp. | Orenia sp. | Thalassobacillus sp. | | |
| | Caminicella sp. | Omithinibacillus sp. | Thermoscetogenium sp. | | |
| | Cerasibacillus sp. | Oxalophagus sp. | Thermoactinomyces sp. | | |
| | Clostridium sp. | Oxobacter sp. | Thermoalkalibacillus sp. | | |
| | Clostridiisalibacter sp. | Paenibacillus sp. | Thermoanaerobacter sp. | | |
| | Cohnella sp. | Paraliobacillus sp. | Thermoanaeromonas sp. | | |
| | Dendrosporobacter sp. | Pelospora sp. | Thermobacillus sp. | | |
| | Desulfotomaculum sp. | Pelotomaculum sp. | Thermoflavimicrobium sp. | | |
| | Desulfosporomusa sp. | Piscibacillus sp. | Thermovenabulum sp. | | |
| | Desulfosporosinus sp. | Planifilum sp. | Tuberibacillus sp. | | |
| | Desulfovirgula sp. | Pontibacillus sp. | Virgibacillus sp. | | |
| | Desulfunispora sp. | Propionispora sp. | Vulcanobacillus sp. | | |
| | Desulfurispora sp. | Salinibacillus sp. | | | |
| | Filifactor sp | Salsuginibacillus sp. | | | |
| | Filobacillus sp. | Seinonella sp. | | | |
| | Gelria sp. | Shimazuella sp. | | | |
| | Geobacillus sp. | Sporacetigenium sp. | | | |
| | Geosporobacter sp. | Sporoanaerobacter sp. | | | |
| | Gracilibacillus sp. | Sporobacter sp. | | | |
| | Halobacillus sp. | Sporobacterium sp. | | | |

The bacteria of the genus Bacillus are one of the most abundant with endosporulation capability. For an adequate proliferation of bacteria inside the seed, it is necessary to supplement the Microprime™ solution with nutrients of particular compatibility with the selected bacterium, or alternatively, directly lead to the Microprime™ solution endospores of the desired bacterium to be incorporated into the seed.

### Biological Priming of the Seed Embryo

The method of the disclosure contemplates treatment of plant seeds with bacterial compositions designed as previously explained (Microprime™ seed treatment). Such a treatment can employ osmotic permeation of the seeds to allow bacteria incorporation, a treatment that was described initially by Smith et al. to introduce chemical priming agents into the seeds is currently referred to as osmopriming. The method of this disclosure, however, has been adapted to the incorporation of bacterial populations into the dormant seeds, with the aim to produce or promote the formation of an early conditioning of the emerging plantlet through direct biological priming of the embryo, once dormancy is finished, and proper environmental or agronomic conditions induce the first stage of germination. This novel approach provides an unprecedented advantage with respect to previously disclosed bacterial formulations designed to produce or promote the formation of biological priming, since incorporated bacteria are protected within dormant seeds, and conveniently positioned to produce or promote the formation of by themselves or by action of their exudates an enduring priming of the embryo from the earliest possible developmental stages. Furthermore, treated seeds are susceptible to regular transport, storage, coating pelleting and sowing treatments according to the standard agronomic practice, without any additional requirement regarding manipulation, nutritional additives, preservatives, or irrigation, and without incompatibility restrictions related to pest or plant disease control agents. Thus, the method described here (Microprime™ seed treatment) also provides a clear advantage from seed biopriming (Mahmood et al., 2016), because that method involves pre-germination of the seeds and dormancy termination, which reduces storage survival and limits manipulation and treatment feasibility/

In addition, the method of this disclosure is different from methods previously reported to inoculate seeds using parental plants as reactors for microbial growth or by inoculation of plant sexual organs (Mitter et al., 2016a; Mitter et al., 2016b). Such methods imply an intrinsic bias in the type of bacteria that can be finally incorporated into the seeds, as successful inoculants must be able to survive within plant target organs or tissues, to compete with endogenous microorganisms and to access the seed inner space by their selves. The Microprime™ strategy presented here is not hampered by endophytic competence or tissue survival, as artificially incorporated bacteria do not have to be endosymbionts, they do not need to face the defensive response of a mature plant, or outcompete endophytic microbiota, but are only required to survive long enough or for its exudates to be able to reach the plant embryo to produce or promote the formation of a molecular priming of the plant.

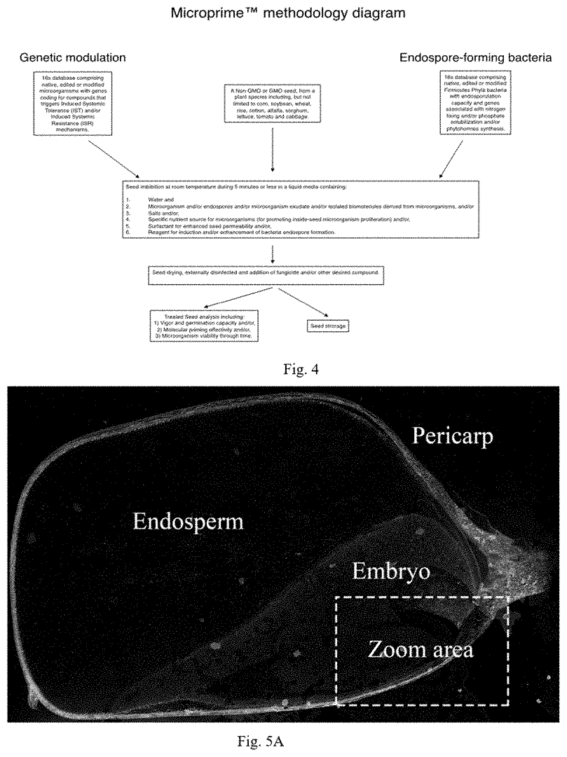

The unique advantages and differentiating features stated above make the method of this disclosure non-obvious to a person skilled in the techniques involved in bacterial plant growth stimulation. In fact, for this strategy to be successful, certain key conditions must be met by candidate bacteria for treatment compositions, which are not necessarily considered in standard formulation of plant growth-promoting microorganisms. In the first place, bacterial compositions must be designed using the effectiveness and compatibility criteria described above, to avoid competition and/or antagonistic effects within the seeds. Absence of these effects must be experimentally assessed before a composition is formulated. Seed internalization must be evaluated for each bacterium contained in a designed composition, determining saturation curves, and bacterial survival during storage time and seed treatment procedures Furthermore, analyses of the seed internal tissues must also be carried out to assess the presence and viability of the desired bacteria and the relative abundance of each component strain with respect to others (FIG. 4).

Plant material must also be conditioned prior to treatment with a specific bacterial composition. Seeds may be sterilized in order to eliminate any background noise while determining the effectiveness of the Microprime™ seed treatment.

Once Microprime™ has occurred, transcriptional analysis of marker genes related to defense among pathogens, abiotic stress tolerance and development must be determined to confirm the impact of the beneficial bacteria on the treated seeds. This analysis must be performed after the dormancy stage of the seed and previous to the seed pericarp and endosperm rupture and radicle emergence. Assessment of transcriptional changes in the developing embryo that are due to previous bacterial treatment of the dormant seed is also a crucial step in the validation of the methodology, since it provides a fast confirmation of priming effectiveness, and the results cannot yet be influenced by external factors that appear after seed rupture, including access to other microorganisms from the seed exterior to the developing plant tissue and/or the chemical composition of the surrounding soil or growth substrate.

The methods and compositions disclosed herein can be summarized on Microprime™ seed treatment method where seeds are incorporated into a saline solution containing seed-compatible bacteria compositions, bacteria-compatible nutrients (in case of using non-endosporulating bacteria), and surfactants to increase bacterial cell load into de seed at room temperature and in a short period of seed immersion and the supplemented minerals for increasing the conversion rate of endospore-forming bacteria to endospores.

FIG. 3 depicts the present methodology for obtaining stable microbial technology seed treatments.

### Modified Plant Seeds

In one aspect, provided herein, is a modified plant seed comprising a microorganism or an exudate of a microorganism incorporated into the seed. In some embodiments, the microorganism or exudate sequesters CO2 by converting it into bicarbonate and ultimately carbonate minerals. In some embodiments, the CO2 is sequestered by the formation of bicarbonate. In some embodiments, the CO2 is sequestered by the formation of one or more carbonate minerals. In some preferred embodiments, the microorganism is an endospore forming bacteria or endospore thereof.

In some embodiments, the microorganism or exudate is incorporated into the interior of the seed. In some embodiments, the microorganism or exudate is incorporated into the seed beneath the pericarp. In some embodiments, the microorganism or exudate is incorporated into the seed between the pericarp and the aleurone cell layer. In some embodiments, the microorganism or exudate contacts the embryo of the seed. In some embodiments, the microorganism or exudate does not contact the embryo of the seed. In some embodiments, the microorganism or exudate contacts the endosperm of the seed. In some embodiments, the microorganism or exudate does not contact the endosperm of the seed. In some embodiments, the microorganism or exudate is incorporated into the seed in an interspace between a seed coat and a seed embryo. In some embodiments, the microorganism or exudate is incorporated into an interspace between a seed pericarp and a seed aleurone cell layer.

The modified plant seed may be any type of plant seed. In some embodiments, the modified seed is a monocot seed. In some embodiments, the plant seed is a maize, a wheat, a rice, a barley, a rye, a sugar cane, a millet, an oat, or a sorghum seed. In some embodiments, the plant seed is a maize seed. In some embodiments, the plant seed is a Zea maize seed. In some embodiments, the seed is a soybean seed. In some embodiments, the seed is a Glycine max seed. In some embodiments, the seed is a rice seed. In some embodiments, the seed is a Oryza sativa seed. In some embodiments, the modified seed is a dicot seed. In some embodiments, the seed is a soybean, cotton, alfalfa, bean, quinoa, lentil, peanut, sunflower, canola, cassava, oil palm, potato, sugar beet, cacao, coffea, lettuce, tomato, or cabbage seed. In some embodiments, the seed is a genetically modified organism (GMO) seed. In some embodiments, the seed is a non-GMO seed.

An amount of microorganism or exudate incorporated into the seed must be of a sufficient level in order for effectively sequester CO2 in the soil. In some embodiments, the amount of microorganism incorporated into the seed is about 250 colony forming units (CFU) to about 5,000 CFU. In some embodiments, the amount of microorganism incorporated into the seed is about 250 CFU to about 500 CFU, about 250 CFU to about 750 CFU, about 250 CFU to about 1,000 CFU, about 250 CFU to about 2,000 CFU, about 250 CFU to about 3,000 CFU, about 250 CFU to about 4,000 CFU, about 250 CFU to about 5,000 CFU, about 500 CFU to about 750 CFU, about 500 CFU to about 1,000 CFU, about 500 CFU to about 2,000 CFU, about 500 CFU to about 3,000 CFU, about 500 CFU to about 4,000 CFU, about 500 CFU to about 5,000 CFU, about 750 CFU to about 1,000 CFU, about 750 CFU to about 2,000 CFU, about 750 CFU to about 3,000 CFU, about 750 CFU to about 4,000 CFU, about 750 CFU to about 5,000 CFU, about 1,000 CFU to about 2,000 CFU, about 1,000 CFU to about 3,000 CFU, about 1,000 CFU to about 4,000 CFU, about 1,000 CFU to about 5,000 CFU, about 2,000 CFU to about 3,000 CFU, about 2,000 CFU to about 4,000 CFU, about 2,000 CFU to about 5,000 CFU, about 3,000 CFU to about 4,000 CFU, about 3,000 CFU to about 5,000 CFU, or about 4,000 CFU to about 5,000 CFU. In some embodiments, the amount of microorganism incorporated into the seed is about 250 CFU, about 500 CFU, about 750 CFU, about 1,000 CFU, about 2,000 CFU, about 3,000 CFU, about 4,000 CFU, or about 5,000 CFU. In some embodiments, the amount of microorganism incorporated into the seed is at least about 250 CFU, about 500 CFU, about 750 CFU, about 1,000 CFU, about 2,000 CFU, about 3,000 CFU, or about 4,000 CFU. In some embodiments, the amount of microorganism incorporated into the seed is at most about 500 CFU, about 750 CFU, about 1,000 CFU, about 2,000 CFU, about 3,000 CFU, about 4,000 CFU, or about 5,000 CFU. In some embodiments, at least about 500 CFU are incorporated into the seed. In some embodiments, at least about 1000 CFU are incorporated into the seed.

In some embodiments, the microorganism or exudate incorporated into the seed is shelf stable for an extended period of time. In some embodiments, the modified seed is shelf stable for about 3 months to about 36 months. In some embodiments, the modified seed is shelf stable for about 3 months to about 6 months, about 3 months to about 9 months, about 3 months to about 12 months, about 3 months to about 15 months, about 3 months to about 18 months, about 3 months to about 21 months, about 3 months to about 24 months, about 3 months to about 30 months, about 3 months to about 36 months, about 6 months to about 9 months, about 6 months to about 12 months, about 6 months to about 15 months, about 6 months to about 18 months, about 6 months to about 21 months, about 6 months to about 24 months, about 6 months to about 30 months, about 6 months to about 36 months, about 9 months to about 12 months, about 9 months to about 15 months, about 9 months to about 18 months, about 9 months to about 21 months, about 9 months to about 24 months, about 9 months to about 30 months, about 9 months to about 36 months, about 12 months to about 15 months, about 12 months to about 18 months, about 12 months to about 21 months, about 12 months to about 24 months, about 12 months to about 30 months, about 12 months to about 36 months, about 15 months to about 18 months, about 15 months to about 21 months, about 15 months to about 24 months, about 15 months to about 30 months, about 15 months to about 36 months, about 18 months to about 21 months, about 18 months to about 24 months, about 18 months to about 30 months, about 18 months to about 36 months, about 21 months to about 24 months, about 21 months to about 30 months, about 21 months to about 36 months, about 24 months to about 30 months, about 24 months to about 36 months, or about 30 months to about 36 months. In some embodiments, the modified seed is shelf stable for about 3 months, about 6 months, about 9 months, about 12 months, about 15 months, about 18 months, about 21 months, about 24 months, about 30 months, or about 36 months. In some embodiments, the modified seed is shelf stable for at least about 3 months, about 6 months, about 9 months, about 12 months, about 15 months, about 18 months, about 21 months, about 24 months, or about 30 months. In some embodiments, the modified seed is shelf stable for at most about 6 months, about 9 months, about 12 months, about 15 months, about 18 months, about 21 months, about 24 months, about 30 months, or about 36 months.

In some embodiments, a microorganism incorporated into a seed is stable after incorporation. In some embodiments, the microorganism is stable for greater than 30 days, for greater than six months, greater than one year, or greater than two years. In some embodiments, the microorganism is stable for greater than 30 days. In some embodiments, the microorganism is stable for greater than six months. In some embodiments, the microorganism is stable for greater than one year. In some embodiments, the microorganism is stable for greater than two years

The microorganism or exudate thereof incorporated into plant seeds may be any of the microorganisms provided herein, or any other microorganism. In some embodiments, the microorganism is a microbe. In some embodiments, the microorganism is an endospore forming microbe. In some embodiments, the microorganism is an endospore forming microbe or an endospore thereof. In some embodiments, the microorganism is an endospore of a microorganism provided herein. In some embodiments, the microorganism is an endospore forming bacteria or an endospore thereof.

### Methods of Incorporating Bacteria

In one aspect, provided herein, is a method of incorporating one or more microorganisms or exudates thereof into one or more plant seeds. In some embodiments, the method comprises disinfecting the plant seeds. In some embodiments, the method comprises contacting the seeds with a solution comprising the one or more microorganisms or the exudate thereof. In some embodiments, the solution further comprises a salt. In some embodiments, the method comprises incubating the seeds with the solution for a period of time. In some embodiments, the period of time is sufficient to allow a desired amount of microorganisms or exudates thereof into the plant seeds. In some embodiments, the method incorporates a desired amount of microorganisms or exudate thereof into the seeds.

In some embodiments, the method comprises contacting the seeds with a solution comprising a salt. Any salt may be used. In some preferred embodiments, the salt is NaCl. In some embodiments, the salt is NaCl, LiCl, KCl, MgCl₂, CaCl₂), NaBr, LiBr, KBr, MgBr₂, CaBr₂, NaI, LiI, KI, MgI₂, or CaI₂. In some embodiments, the salt comprises sodium, lithium, or potassium ions. In some embodiments, the salt comprises alkali metal ions. In some embodiments, the salt comprises alkaline earth metal ions. In some embodiments, the salt comprises halide ions. In some embodiments, the salt is an alkali or alkaline earth halide salt. In some embodiments, the salt comprises chloride, bromide, or iodide ions. In some embodiments, the salt is a sulfate, phosphate, carbonate, or nitrate salt.

The salt may be present in the solution at any suitable concentration. In some embodiments, the solution comprises about 0.85% salt (w/v). In some embodiments, the solution comprises about 0.1% to about 1.25% salt (w/v). In some embodiments, the solution comprises about 0.10% to about 2.0% salt (w/v). In some embodiments, the solution comprises about 0.10% to about 0.25%, about 0.1% to about 0.5%, about 0.1% to about 0.6%, about 0.1% to about 0.7%, about 0.10% to about 0.75%, about 0.10% to about 0.8%, about 0.10% to about 0.85%, about 0.10% to about 0.9%, about 0.1% to about 0.95%, about 0.1% to about 1%, about 0.1% to about 1.25%, about 0.25% to about 0.5%, about 0.25% to about 0.6%, about 0.25% to about 0.7%, about 0.25% to about 0.75%, about 0.25% to about 0.8%, about 0.25% to about 0.85%, about 0.25% to about 0.9%, about 0.25% to about 0.95%, about 0.25% to about 1%, about 0.25% to about 1.25%, about 0.5% to about 0.6%, about 0.5% to about 0.7%, about 0.5% to about 0.75%, about 0.5% to about 0.8%, about 0.5% to about 0.85%, about 0.5% to about 0.9%, about 0.5% to about 0.95%, about 0.5% to about 1%, about 0.5% to about 1.25%, about 0.6% to about 0.7%, about 0.6% to about 0.75%, about 0.6% to about 0.8%, about 0.6% to about 0.85%, about 0.6% to about 0.9%, about 0.6% to about 0.95%, about 0.6% to about 1%, about 0.6% to about 1.25%, about 0.7% to about 0.75%, about 0.7% to about 0.8%, about 0.7% to about 0.85%, about 0.7% to about 0.9%, about 0.7% to about 0.95%, about 0.7% to about 1%, about 0.7% to about 1.25%, about 0.75% to about 0.8%, about 0.75% to about 0.85%, about 0.75% to about 0.9%, about 0.75% to about 0.95%, about 0.75% to about 1%, about 0.75% to about 1.25%, about 0.8% to about 0.85%, about 0.8% to about 0.9%, about 0.8% to about 0.95%, about 0.8% to about 1%, about 0.8% to about 1.25%, about 0.85% to about 0.9%, about 0.85% to about 0.95%, about 0.85% to about 1%, about 0.85% to about 1.25%, about 0.9% to about 0.95%, about 0.9% to about 1%, about 0.9% to about 1.25%, about 0.95% to about 1%, about 0.95% to about 1.25%, or about 1% to about 1.25% salt (w/v). In some embodiments, the solution comprises about 0.1%, about 0.25%, about 0.5%, about 0.6%, about 0.7%, about 0.75%, about 0.8%, about 0.85%, about 0.9%, about 0.95%, about 1%, or about 1.25% salt (w/v). In some embodiments, the solution comprises at least about 0.1%, about 0.25%, about 0.5%, about 0.6%, about 0.7%, about 0.75%, about 0.8%, about 0.85%, about 0.9%, about 0.95%, or about 1% salt (w/v). In some embodiments, the solution comprises at most about 0.25%, about 0.5%, about 0.6%, about 0.7%, about 0.75%, about 0.8%, about 0.85%, about 0.9%, about 0.95%, about 1%, or about 1.25% salt (w/v). In some embodiments, the solution comprises about 0.85% salt (w/v). In some embodiments, the solution comprises from about 0.8% to about 0.9% salt (w/v). In some embodiments, the solution comprises from about 0.75% to about 0.95% salt (w/v). In some embodiments, the solution comprises from about 0.7% to about 1% salt (w/v). In some embodiments, the solution comprises from about 0.5% to about 1.25% salt (w/v). In some embodiments, the solution comprises from about 0.5% to about 2% salt (w/v). In some embodiments, the solution comprises 0.1-0.2%, 0.2-0.3%, 0.3-0.4%, 0.4-0.5%, 0.5-0.6%, 0.6-0.7%, 0.7-0.8%, 0.8-0.9%, 0.9-1.0%, 1.0-1.1%, 1.1-1.2%, 1.2-1.3%, 1.3-1.4%, or 1.4-1.5% salt (w/v).

In some embodiments, the solution comprises an additional additive. In some embodiments, the solution comprises dimethyl sulfoxide (DMSO), 1-dodecylazacycloheptan-2-one, laurocapram, 1-methyl-2-pyrrolidone (NMP), oleic acid, ethanol, methanol, polyethylene glycol (Brij 35, 58, 98), polyethylene glycol monolaurate (e.g. Tween 20), Tween 40 (Polyoxyethylenate sorbitol ester), Tween 60, Tween 80 (non-ionic), cetylmethylammonium bromide (CTAB), urea, lecithins (solidified fatty acids derived from soybean), chitosan, Poloxamer 188, Poloxamer 237, Poloxamer 338, Poloxamer 407, or a combination thereof. In some embodiments, the solution comprises polyethylene glycol monolaurate (e.g. Tween 20), Poloxamer 188, Poloxamer 237, Poloxamer 338, Poloxamer 407, or a combination thereof. In some embodiments, the solution comprises a Poloxamer. In some embodiments, the solution comprises polyethylene glycol monolaurate (e.g. Tween 20). The additional additive may be present at any concentration. In some embodiments, the additional additive comprises up to about 0.01%, 0.05%, 0.1%, 0.125%, 0.15%, 0.2%, 0.5% or 1% (v/v) of the solution. In some embodiments, the additional additive comprises about 0.01% to about 1% (v/v) of the solution. In some embodiments, the additional additive comprises about 0.1% (v/v) of the solution.

In some embodiments, the solution comprises an additional metal ion. In some embodiments, the solution comprises magnesium, calcium, manganese, or any combination thereof. In some embodiments, the solution comprises magnesium. In some embodiments, the solution comprises calcium. In some embodiments, the solution comprises manganese. In some embodiments, the solution comprises magnesium and calcium. In some embodiments, the solution comprises magnesium and manganese. In some embodiments, the solution comprises calcium and manganese. In some embodiments, the solution comprises magnesium, calcium, and manganese.

In some embodiments, the solution comprises one or more nutrients for the microorganisms. In some embodiments, the solution comprises a bacterial growth media. In some embodiments, the solution comprises lysogeny broth (LB), nutrient broth, or a combination thereof. In some embodiments, the solution comprises lysogeny broth. In some embodiments, the solution comprises nutrient broth.

In some embodiments, the solution comprises a microorganism. In some embodiments, solution comprises from about 10³ to about 10¹⁷ colony forming units (CFU)/mL of the microorganism. In some embodiments, the solution comprises about 10³ to about 10⁴, about 10³ to about 10⁵, about 10³ to about 10⁶, about 10³ to about 10⁷, about 10³ to about 10⁸, about 10³ to about 10⁹, about 10³ to about 10¹⁰, about 10³ to about 10¹², about 10³ to about 10¹⁵, about 10³ to about 10¹⁷, about 10⁴ to about 10⁵, about 10⁴ to about 10⁶, about 10⁴ to about 10⁷, about 10⁴ to about 10⁸, about 10⁴ to about 10⁹, about 10⁴ to about 10¹⁰, about 10⁴ to about 10¹², about 10⁴ to about 10¹⁵, about 10⁴ to about 10¹⁷, about 10⁵ to about 10⁶, about 10⁵ to about 10⁷, about 10⁵ to about 10⁸, about 10⁵ to about 10⁹, about 10⁵ to about 10¹⁰, about 10⁵ to about 10¹², about 10⁵ to about 10¹⁵, about 10⁵ to about 10¹⁷, about 10⁶ to about 10⁷, about 10⁶ to about 10⁸, about 10⁶ to about 10⁹, about 10⁶ to about 10¹⁰, about 10⁶ to about 10¹², about 10⁶ to about 10¹⁵, about 10⁶ to about 10¹⁷, about 10⁷ to about 10⁸, about 10⁷ to about 10⁹, about 10⁷ to about 10¹⁰, about 10⁷ to about 10¹², about 10⁷ to about 10¹⁵, about 10⁷ to about 10¹⁷, about 10⁸ to about 10⁹, about 10⁸ to about 10¹⁰, about 10⁸ to about 10¹², about 10⁸ to about 10¹⁵, about 10⁸ to about 10¹⁷, about 10⁹ to about 10¹⁰, about 10⁹ to about 10¹², about 10⁹ to about 10¹⁵, about 10⁹ to about 10¹⁷, about 10¹⁰ to about 10¹², about 10¹⁰ to about 10¹⁵, about 10¹⁰ to about 10¹⁷, about 10¹² to about 10¹⁵, about 10¹² to about 10¹⁷, or about 10¹⁵ to about 10¹⁷ CFU/mL of the microorganism. In some embodiments, the solution comprises about 10³, about 10⁴, about 10⁵, about 10⁶, about 10⁷, about 10⁸, about 10⁹, about 10¹⁰, about 10¹², about 10¹⁵, or about 10¹⁷ CFU/mL of the microorganism. In some embodiments, the solution comprises at least about 10³, about 10⁴, about 10⁵, about 10⁶, about 10⁷, about 10¹, about 10⁹, about 10¹⁰, about 10¹², or about 10¹⁵ CFU/mL of the microorganism. In some embodiments, the solution comprises at most about 10⁴, about 10⁵, about 10⁶, about 10⁷, about 10⁸, about 10⁹, about 10¹⁰, about 10¹², about 10¹⁵, or about 10¹⁷ CFU/mL of the microorganism. In some embodiments, the solution comprises at least about 10⁶ to 10⁷ CFU/mL of the microorganism. In some embodiments, the solution comprises 1×10³ to 1×10⁴ CFU/mL; 1×10⁴ to 1×10⁵ CFU/mL; 1×10⁵ to 1×10⁶ CFU/mL; 1×10⁶ to 1×10⁷ CFU/mL; 1×10⁷ to 1×10⁸ CFU/mL; 1×10⁸ to 1×10⁹ CFU/mL; 1×10⁹ to 1×10¹⁰ CFU/mL; 1×10¹⁰ to 1×10¹¹ CFU/mL; 1×10¹¹ to 1×10¹² CFU/mL; 1×10¹² to 1×10¹³ CFU/mL; 1×10¹³ to 1×10¹⁴ CFU/mL; 1×10¹⁴ to 1×10¹⁵ CFU/mL; 1×10¹⁵ to 1×10¹⁶ CFU/mL; or 1×10¹⁶ to 1×10¹⁷ CFU/mL of the microorganism.

In some embodiments, the solution comprises a desired amount of microorganism per seed mass. In some embodiments, solution comprises from about 10³ to about 10¹⁷ colony forming units (CFU)/gram of seed. In some embodiments, the solution comprises about 10³ to about 10⁴, about 10³ to about 10⁵, about 10³ to about 10⁶, about 10³ to about 10⁷, about 10³ to about 10⁸, about 10³ to about 10⁹, about 10³ to about 10¹⁰, about 10³ to about 10¹², about 10³ to about 10¹⁵, about 10³ to about 10¹⁷, about 10⁴ to about 10⁵, about 10⁴ to about 10⁶, about 10⁴ to about 10⁷, about 10⁴ to about 10⁸, about 10⁴ to about 10⁹, about 10⁴ to about 10¹⁰, about 10⁴ to about 10¹², about 10⁴ to about 10¹⁵, about 10⁴ to about 10¹⁷, about 10⁵ to about 10⁶, about 10⁵ to about 10⁷, about 10⁵ to about 10⁸, about 10⁵ to about 10⁹, about 10⁵ to about 10¹⁰, about 10⁵ to about 10¹², about 10⁵ to about 10¹⁵, about 10⁵ to about 10¹⁷, about 10⁶ to about 10⁷ about 10⁶ to about 10⁸, about 10⁶ to about 10⁹, about 10⁶ to about 10¹⁰, about 10⁶ to about 10¹², about 10⁶ to about 10¹⁵, about 10⁶ to about 10¹⁷, about 10⁷ to about 10⁸, about 10⁷ to about 10⁹, about 10⁷ to about 10¹⁰, about 10⁷ to about 10¹², about 10⁷ to about 10¹⁵, about 10⁷ to about 10¹⁷, about 10⁸ to about 10⁹, about 10⁸ to about 10¹⁰, about 10⁸ to about 10¹², about 10⁸ to about 10¹⁵, about 10⁸ to about 10¹⁷, about 10⁹ to about 10¹⁰, about 10⁹ to about 10¹², about 10⁹ to about 10¹⁵, about 10⁹ to about 10¹⁷, about 10¹⁰ to about 10¹², about 10¹⁰ to about 10¹⁵, about 10¹⁰ to about 10¹⁷, about 10¹² to about 10¹⁵, about 10¹² to about 10¹⁷, or about 10¹⁵ to about 10¹⁷ CFU/gram of seed. In some embodiments, the solution comprises about 10³, about 10⁴, about 10⁵, about 10⁶, about 10⁷, about 10⁸, about 10⁹, about 10¹⁰, about 10¹², about 10¹⁵, or about 10¹⁷ CFU/gram of seed. In some embodiments, the solution comprises at least about 10³, about 10⁴, about 10⁵, about 10⁶, about 10⁷, about 10¹, about 10⁹, about 10¹⁰, about 10¹², or about 10¹⁵ CFU/gram of seed. In some embodiments, the solution comprises at most about 10⁴, about 10⁵, about 10⁶, about 10⁷, about 10¹, about 10⁹, about 10¹⁰, about 10¹², about 10¹⁵, or about 10¹⁷ CFU/gram of seed. In some embodiments, the solution comprises less than 10¹⁰ CFU/gram of seed. In some embodiments, the solution comprises less than 10⁹ CFU/gram of seed. In some embodiments, the solution comprises less than 10⁸ CFU/gram of seed. In some embodiments, the solution comprises less than 10¹¹ CFU/gram of seed. In some embodiments, the solution comprises about 10⁵ to about 10⁹ CFU/gram of seed.

In some embodiments, solution comprises from about 10³ to about 10¹⁷ colony cells/gram of seed. In some embodiments, the solution comprises about 10³ to about 10⁴, about 10³ to about 10⁵, about 10³ to about 10⁶, about 10³ to about 10⁷, about 10³ to about 10⁸, about 10³ to about 10⁹, about 10³ to about 10¹⁰, about 10³ to about 10¹², about 10³ to about 10¹⁵, about 10³ to about 10¹⁷, about 10⁴ to about 10⁵, about 10⁴ to about 10⁶, about 10⁴ to about 10⁷, about 10⁴ to about 10⁸, about 10⁴ to about 10⁹, about 10⁴ to about 10¹⁰, about 10⁴ to about 10¹², about 10⁴ to about 10¹⁵, about 10⁴ to about 10¹⁷, about 10⁵ to about 10⁶, about 10⁵ to about 10⁷, about 10⁵ to about 10⁸, about 10⁵ to about 10⁹, about 10⁵ to about 10¹⁰, about 10⁵ to about 10¹², about 10⁵ to about 10¹⁵, about 10⁵ to about 10¹⁷, about 10⁶ to about 10⁷, about 10⁶ to about 10⁸, about 10⁶ to about 10⁹, about 10⁶ to about 10¹⁰, about 10⁶ to about 10¹², about 10⁶ to about 10¹⁵, about 10⁶ to about 10¹⁷, about 10⁷ to about 10⁸, about 10⁷ to about 10⁹, about 10⁷ to about 10¹⁰, about 10⁷ to about 10¹², about 10⁷ to about 10¹⁵, about 10⁷ to about 10¹⁷, about 10⁸ to about 10⁹, about 10⁸ to about 10¹⁰, about 10⁸ to about 10¹², about 10⁸ to about 10¹⁵, about 10⁸ to about 10¹⁷, about 10⁹ to about 10¹⁰, about 10⁹ to about 10¹², about 10⁹ to about 10¹⁵, about 10⁹ to about 10¹⁷, about 10¹⁰ to about 10¹², about 10¹⁰ to about 10¹⁵, about 10¹⁰ to about 10¹⁷, about 10¹² to about 10¹⁵, about 10¹² to about 10¹⁷, or about 10¹⁵ to about 10¹⁷ cells/gram of seed. In some embodiments, the solution comprises about 10³ about 10⁴ about 10⁵ about 10⁶, about 10, about 10 about 10⁹, about 10¹⁰, about 10¹², about 10¹⁵, or about 10¹⁷ cells/gram of seed. In some embodiments, the solution comprises at least about 10³, about 10⁴, about 10⁵, about 10⁶, about 10⁷, about 10¹, about 10⁹, about 10¹⁰, about 10¹², or about 10¹⁵ cells/gram of seed. In some embodiments, the solution comprises at most about 10⁴, about 10⁵, about 10⁶, about 10⁷, about 10⁸, about 10⁹, about 10¹⁰, about 10¹², about 10¹⁵, or about 10¹⁷ cells/gram of seed. In some embodiments, the solution comprises less than 10¹⁰ cells/gram of seed. In some embodiments, the solution comprises less than 10⁹ cells/gram of seed. In some embodiments, the solution comprises less than 10⁸ cells/gram of seed. In some embodiments, the solution comprises less than 10¹¹ cells/gram of seed. In some embodiments, the solution comprises about 10⁵ to about 10⁹ cells/gram of seed.

In some embodiments, the seeds comprise a desired amount of microorganism per seed. In some embodiments, solution comprises from about 10³ to about 10¹⁷ colony forming units (CFU)/seed. In some embodiments, the solution comprises about 10³ to about 10⁴, about 10³ to about 10⁵, about 10³ to about 10⁶, about 10³ to about 10⁷, about 10³ to about 10⁸, about 10³ to about 10⁹, about 10³ to about 10¹⁰, about 10³ to about 10¹², about 10³ to about 10¹⁵, about 10³ to about 10¹⁷, about 10⁴ to about 10⁵, about 10⁴ to about 10⁶, about 10⁴ to about 10⁷, about 10⁴ to about 10⁸, about 10⁴ to about 10⁹, about 10⁴ to about 10¹⁰, about 10⁴ to about 10¹², about 10⁴ to about 10¹⁵, about 10⁴ to about 10¹⁷, about 10⁵ to about 10⁶, about 10⁵ to about 10⁷, about 10⁵ to about 10⁸, about 10⁵ to about 10⁹, about 10⁵ to about 10¹⁰, about 10⁵ to about 10¹², about 10⁵ to about 10¹⁵, about 10⁵ to about 10¹⁷, about 10⁶ to about 10⁷, about 10⁶ to about 10⁸, about 10⁶ to about 10⁹, about 10⁶ to about 10¹⁰, about 10⁶ to about 10¹², about 10⁶ to about 10¹⁵, about 10⁶ to about 10¹⁷, about 10⁷ to about 10⁸, about 10⁷ to about 10⁹, about 10⁷ to about 10¹⁰, about 10⁷ to about 10¹², about 10⁷ to about 10¹⁵, about 10⁷ to about 10¹⁷, about 10⁸ to about 10⁹, about 10⁸ to about 10¹⁰, about 10⁸ to about 10¹², about 10⁸ to about 10¹⁵, about 10⁸ to about 10¹⁷, about 10⁹ to about 10¹⁰, about 10⁹ to about 10¹², about 10⁹ to about 10¹⁵, about 10⁹ to about 10¹⁷, about 10¹⁰ to about 10¹², about 10¹⁰ to about 10¹⁵, about 10¹⁰ to about 10¹⁷, about 10¹² to about 10¹⁵, about 10¹² to about 10¹⁷, or about 10¹⁵ to about 10¹⁷ CFU/seed. In some embodiments, the solution comprises about 10³, about 10⁴, about 10⁵, about 10⁶, about 10⁷, about 10¹, about 10⁹, about 10¹⁰, about 10¹², about 10¹⁵, or about 10¹⁷ CFU/seed. In some embodiments, the solution comprises at least about 10³, about 10⁴, about 10⁵, about 10⁶, about 10, about 10 about 10⁹, about 10¹⁰, about 10¹², or about 10¹⁵ CFU/seed. In some embodiments, the solution comprises at most about 10⁴, about 10⁵, about 10⁶, about 10, about 10⁸ about 10⁹, about 10¹⁰, about 10¹², about 10¹⁵, or about 10¹⁷ CFU/seed. In some embodiments, the solution comprises less than 10¹⁰ CFU/seed. In some embodiments, the solution comprises less than 10⁹ CFU/seed. In some embodiments, the solution comprises less than 10⁸ CFU/seed. In some embodiments, the solution comprises less than 10¹¹ CFU/seed. In some embodiments, the solution comprises about 10⁵ to about 10⁹ CFU/seed.

In some embodiments, the seeds comprise a desired amount of microorganism per seed. In some embodiments, solution comprises from about 10³ to about 10¹⁷ cells/seed. In some embodiments, the solution comprises about 10³ to about 10⁴, about 10³ to about 10⁵, about 10³ to about 10⁶, about 10³ to about 10⁷, about 10³ to about 10⁸, about 10³ to about 10⁹, about 10³ to about 10¹⁰, about 10³ to about 10¹², about 10³ to about 10¹⁵, about 10³ to about 10¹⁷, about 10⁴ to about 10⁵, about 10⁴ to about 10⁶, about 10⁴ to about 10⁷, about 10⁴ to about 10⁸, about 10⁴ to about 10⁹, about 10⁴ to about 10¹⁰, about 10⁴ to about 10¹², about 10⁴ to about 10¹⁵, about 10⁴ to about 10¹⁷, about 10⁵ to about 10⁶, about 10⁵ to about 10⁷, about 10⁵ to about 10⁸, about 10⁵ to about 10⁹, about 10⁵ to about 10¹⁰, about 10⁵ to about 10¹², about 10⁵ to about 10¹⁵, about 10⁵ to about 10¹⁷, about 10⁶ to about 10⁷, about 10⁶ to about 10⁸, about 10⁶ to about 10⁹, about 10⁶ to about 10¹⁰, about 10⁶ to about 10¹², about 10⁶ to about 10¹⁵, about 10⁶ to about 10¹⁷, about 10⁷ to about 10⁸, about 10⁷ to about 10⁹, about 10⁷ to about 10¹⁰, about 10⁷ to about 10¹², about 10⁷ to about 10¹⁵, about 10⁷ to about 10¹⁷, about 10⁸ to about 10⁹, about 10⁸ to about 10¹⁰, about 10⁸ to about 10¹², about 10⁸ to about 10¹⁵, about 10⁸ to about 10¹⁷, about 10⁹ to about 10¹⁰, about 10⁹ to about 10¹², about 10⁹ to about 10¹⁵, about 10⁹ to about 10¹⁷, about 10¹⁰ to about 10¹², about 10¹⁰ to about 10¹⁵, about 10¹⁰ to about 10¹⁷, about 10¹² to about 10¹⁵, about 10¹² to about 10¹⁷, or about 10¹⁵ to about 10¹⁷ cells/seed. In some embodiments, the solution comprises about 10³, about 10⁴, about 10⁵, about 10⁶, about 10⁷, about 10⁸, about 10⁹, about 10¹⁰, about 10¹², about 10¹⁵, or about 10¹⁷ cells/seed. In some embodiments, the solution comprises at least about 10³, about 10⁴, about 10⁵, about 10⁶, about 10⁷, about 10¹, about 10⁹, about 10¹⁰, about 10¹², or about 10¹⁵ cells/seed. In some embodiments, the solution comprises at most about 10⁴, about 10⁵, about 10⁶, about 10⁷, about 10⁸, about 10⁹, about 10¹⁰, about 10¹², about 10¹⁵, or about 10¹⁷ cells/seed. In some embodiments, the solution comprises less than 10¹⁰ cells/seed. In some embodiments, the solution comprises less than 10⁹ cells/seed. In some embodiments, the solution comprises less than 10⁸ cells/seed. In some embodiments, the solution comprises less than 10¹¹ cells/seed. In some embodiments, the solution comprises about 10⁵ to about 10⁹ cells/seed

In some embodiments, the microorganism is a bacterium. In some embodiments, the bacterium is an endospore forming bacteria. In some embodiments, the method comprises inducing endosporulation of the endospore forming bacteria. In some embodiments, the bacteria incorporated into the seed is an endospore. In some embodiments, the solution comprises one or more ingredients to induce endosporulation. In some embodiments, the solution comprises potassium, ferrous sulfate, calcium, magnesium, manganese, or a combination thereof.

In some embodiments, the method comprises sterilizing the seeds. In some embodiments, the method comprises sterilizing the surface of the seeds. Any method of producing a seed with a sterilized surface may be employed. In some embodiments, the seed is sterilized with a bleach solution. In some embodiments, the seeds are sterilized prior to immersing the seeds in the solution containing the one or more microorganisms. In some embodiments, the seed is a sterilized seed. In some embodiments, the seed has a sterilized surface. As used herein, “sterilizing,” “sterilized” and related terms (e.g. “disinfecting” and the like) indicates that there are substantially no microorganisms alive on the sterilized item. In some embodiments, the seed is sterilized prior to incubating the seed in the solution comprising the microorganism. In some embodiments, the seed is sterilized after incubating the seed in the solution comprising the microorganism. In some embodiments, a fungicide is added to the surface of the seed.

In some embodiments, the sterilized or disinfected seeds comprise substantially no living microorganisms on the seed (e.g. the surface of the seed). In some embodiments, the sterile or sterilized seed comprises less than 1 CFU, less than 5 CFU, less than 10 CFU, less than 20 CFU, less than 30 CFU, less than 40 CFU, or less than 50 CFU of microorganisms on the seed.

In some embodiments, the plant seeds are incubated with the solution containing the microorganism for a time sufficient to incorporate the microorganism into the seed. In some embodiments, the plant seeds are incubated with the solution containing endospore forming bacteria or endospores thereof for about 1 minute to about 960 minutes. In some embodiments, the plant seeds are incubated with the solution containing endospore forming bacteria or endospores thereof for about 1 minute to about 5 minutes, about 1 minute to about 10 minutes, about 1 minute to about 20 minutes, about 1 minute to about 60 minutes, about 1 minute to about 240 minutes, about 1 minute to about 960 minutes, about 5 minutes to about 10 minutes, about 5 minutes to about 20 minutes, about 5 minutes to about 60 minutes, about 5 minutes to about 240 minutes, about 5 minutes to about 960 minutes, about 10 minutes to about 20 minutes, about 10 minutes to about 60 minutes, about 10 minutes to about 240 minutes, about 10 minutes to about 960 minutes, about 20 minutes to about 60 minutes, about 20 minutes to about 240 minutes, about 20 minutes to about 960 minutes, about 60 minutes to about 240 minutes, about 60 minutes to about 960 minutes, or about 240 minutes to about 960 minutes. In some embodiments, the plant seeds are incubated with the solution containing endospore forming bacteria or endospores thereof for about 1 minute, about 5 minutes, about 10 minutes, about 20 minutes, about 60 minutes, about 240 minutes, or about 960 minutes. In some embodiments, the plant seeds are incubated with the solution containing endospore forming bacteria or endospores thereof for at least about 1 minute, about 5 minutes, about 10 minutes, about 20 minutes, about 60 minutes, or about 240 minutes. In some embodiments, the plant seeds are incubated with the solution containing endospore forming bacteria or endospores thereof for at most about 5 minutes, about 10 minutes, about 20 minutes, about 60 minutes, about 240 minutes, or about 960 minutes. In some embodiments, the plant seeds are incubated with the solution containing endospore forming bacteria or endospores thereof for about 1 minute. In some embodiments, the plant seeds are incubated with the solution containing endospore forming bacteria or endospores thereof for about 5 minutes. In some embodiments, the plant seeds are incubated with the solution containing endospore forming bacteria or endospores thereof for about 10 minutes. In some embodiments, the plant seeds are incubated with the solution containing endospore forming bacteria or endospores thereof for about 20 minutes. In some embodiments, the plant seeds are incubated with the solution containing endospore forming bacteria or endospores thereof for about 60 minutes. In some embodiments, the plant seeds are incubated with the solution containing endospore forming bacteria or endospores thereof for about 240 minutes. In some embodiments, the plant seeds are incubated with the solution containing endospore forming bacteria or endospores thereof for about 960 minutes.

In some embodiments, the plant seeds are incubated with the solution containing the microorganism or exudate thereof for about 1 minute to about 960 minutes. In some embodiments, the plant seeds are incubated with the solution containing the microorganism or exudate thereof for about 1 minute to about 5 minutes, about 1 minute to about 10 minutes, about 1 minute to about 20 minutes, about 1 minute to about 60 minutes, about 1 minute to about 240 minutes, about 1 minute to about 960 minutes, about 5 minutes to about 10 minutes, about 5 minutes to about 20 minutes, about 5 minutes to about 60 minutes, about 5 minutes to about 240 minutes, about 5 minutes to about 960 minutes, about 10 minutes to about 20 minutes, about 10 minutes to about 60 minutes, about 10 minutes to about 240 minutes, about 10 minutes to about 960 minutes, about 20 minutes to about 60 minutes, about 20 minutes to about 240 minutes, about 20 minutes to about 960 minutes, about 60 minutes to about 240 minutes, about 60 minutes to about 960 minutes, or about 240 minutes to about 960 minutes. In some embodiments, the plant seeds are incubated with the solution containing the microorganism or exudate thereof for about 1 minute, about 5 minutes, about 10 minutes, about 20 minutes, about 60 minutes, about 240 minutes, or about 960 minutes. In some embodiments, the plant seeds are incubated with the solution containing the microorganism or exudate thereof for at least about 1 minute, about 5 minutes, about 10 minutes, about 20 minutes, about 60 minutes, or about 240 minutes. In some embodiments, the plant seeds are incubated with the solution containing the microorganism or exudate thereof for at most about 5 minutes, about 10 minutes, about 20 minutes, about 60 minutes, about 240 minutes, or about 960 minutes. In some embodiments, the plant seeds are incubated with the solution containing the microorganism or exudate thereof for about 1 minute. In some embodiments, the plant seeds are incubated with the solution containing the microorganism or exudate thereof for about 5 minutes. In some embodiments, the plant seeds are incubated with the solution containing the microorganism or exudate thereof for about 10 minutes. In some embodiments, the plant seeds are incubated with the solution containing the microorganism or exudate thereof for about 20 minutes. In some embodiments, the plant seeds are incubated with the solution containing the microorganism or exudate thereof for about 60 minutes. In some embodiments, the plant seeds are incubated with the solution containing the microorganism or exudate thereof for about 240 minutes. In some embodiments, the plant seeds are incubated with the solution containing the microorganism or exudate thereof for about 960 minutes.

In some embodiments, the seeds are incubated with the solution at a desired temperature. In some embodiments, the seeds are incubated with the solution at a temperature of about 2 to about 40° C. In some embodiments, the seeds are incubated with the solution at a temperature of about 2 to about 4, about 2 to about 8, about 2 to about 12, about 2 to about 16, about 2 to about 25, about 2 to about 30, about 2 to about 35, about 2 to about 40, about 4 to about 8, about 4 to about 12, about 4 to about 16, about 4 to about 25, about 4 to about 30, about 4 to about 35, about 4 to about 40, about 8 to about 12, about 8 to about 16, about 8 to about 25, about 8 to about 30, about 8 to about 35, about 8 to about 40, about 12 to about 16, about 12 to about 25, about 12 to about 30, about 12 to about 35, about 12 to about 40, about 16 to about 25, about 16 to about 30, about 16 to about 35, about 16 to about 40, about 25 to about 30, about 25 to about 35, about 25 to about 40, about 30 to about 35, about 30 to about 40, or about 35 to about 40° C. In some embodiments, the seeds are incubated with the solution at a temperature of about 2, about 4, about 8, about 12, about 16, about 25, about 30, about 35, or about 40° C. In some embodiments, the seeds are incubated with the solution at a temperature of at least about 2, about 4, about 8, about 12, about 16, about 25, about 30, or about 35° C. In some embodiments, the seeds are incubated with the solution at a temperature of at most about 4, about 8, about 12, about 16, about 25, about 30, about 35, or about 40° C.

In some embodiments, the method comprises drying seeds. In some embodiments, the seeds are dried to about 10% of total seed moisture. In some embodiments, the seeds are dried to about 5% to about 25% of total seed moisture. In some embodiments, the seeds are dried to about 5% to about 8%, about 5% to about 10%, about 5% to about 12%, about 5% to about 15%, about 5% to about 20%, about 5% to about 25%, about 8% to about 10%, about 8% to about 12%, about 8% to about 15%, about 8% to about 20%, about 8% to about 25%, about 10% to about 12%, about 10% to about 15%, about 10% to about 20%, about 10% to about 25%, about 12% to about 15%, about 12% to about 20%, about 12% to about 25%, about 15% to about 20%, about 15% to about 25%, or about 20% to about 25% of total seed moisture. In some embodiments, the seeds are dried to about 5%, about 8%, about 10%, about 12%, about 15%, about 20%, or about 25% of total seed moisture. In some embodiments, the seeds are dried to at least about 5%, about 8%, about 10%, about 12%, about 15%, or about 20% of total seed moisture. In some embodiments, the seeds are dried to at most about 8%, about 10%, about 12%, about 15%, about 20%, or about 25% of total seed moisture. In some embodiments, the seeds are dried to prevent germination of the seeds. In some embodiments, the seeds are dried to prevent germination prior to planting the seeds.

### Formulations for Incorporating Microorganisms

In one aspect, provided herein, is a formulation for incorporating microorganisms, endospores, or exudates thereof into a seed. In some embodiments, the formulation comprises one or more microorganisms or endospores thereof and a salt. The one or more microorganisms can be any of the microorganisms provided herein or endospores thereof. In some embodiments, the one or more microorganisms comprises one or more endospore forming bacteria or endospores thereof. In some embodiments, the formulation comprises an exudate of a microorganism. The exudate can be from any of the microorganisms provided herein.

In some embodiments, the formulation is a solution. In some embodiments, the formulation is an aqueous solution.

In some embodiments, the formulation comprises a salt. The salt may be present in the formulation at any suitable concentration. In some embodiments, the formulation comprises about 0.85% salt (w/v). In some embodiments, the formulation comprises about 0.1% to about 1.25% salt (w/v). In some embodiments, the formulation comprises about 0.1% to about 2.0% salt (w/v). In some embodiments, the formulation comprises about 0.1% to about 0.25%, about 0.1% to about 0.5%, about 0.1% to about 0.6%, about 0.1% to about 0.7%, about 0.1% to about 0.75%, about 0.1% to about 0.8%, about 0.1% to about 0.85%, about 0.1% to about 0.9%, about 0.1% to about 0.95%, about 0.1% to about 1%, about 0.1% to about 1.25%, about 0.25% to about 0.5%, about 0.25% to about 0.6%, about 0.25% to about 0.7%, about 0.25% to about 0.75%, about 0.25% to about 0.8%, about 0.25% to about 0.85%, about 0.25% to about 0.9%, about 0.25% to about 0.95%, about 0.25% to about 1%, about 0.25% to about 1.25%, about 0.5% to about 0.6%, about 0.5% to about 0.7%, about 0.5% to about 0.75%, about 0.5% to about 0.8%, about 0.5% to about 0.85%, about 0.5% to about 0.9%, about 0.5% to about 0.95%, about 0.5% to about 1%, about 0.5% to about 1.25%, about 0.6% to about 0.7%, about 0.6% to about 0.75%, about 0.6% to about 0.8%, about 0.6% to about 0.85%, about 0.6% to about 0.9%, about 0.6% to about 0.95%, about 0.6% to about 1%, about 0.6% to about 1.25%, about 0.7% to about 0.75%, about 0.7% to about 0.8%, about 0.7% to about 0.85%, about 0.7% to about 0.9%, about 0.7% to about 0.95%, about 0.7% to about 1%, about 0.7% to about 1.25%, about 0.75% to about 0.8%, about 0.75% to about 0.85%, about 0.75% to about 0.9%, about 0.75% to about 0.95%, about 0.75% to about 1%, about 0.75% to about 1.25%, about 0.8% to about 0.85%, about 0.8% to about 0.9%, about 0.8% to about 0.95%, about 0.8% to about 1%, about 0.8% to about 1.25%, about 0.85% to about 0.9%, about 0.85% to about 0.95%, about 0.85% to about 1%, about 0.85% to about 1.25%, about 0.9% to about 0.95%, about 0.9% to about 1%, about 0.9% to about 1.25%, about 0.95% to about 1%, about 0.95% to about 1.25%, or about 1% to about 1.25% salt (w/v). In some embodiments, the formulation comprises about 0.1%, about 0.25%, about 0.5%, about 0.6%, about 0.7%, about 0.75%, about 0.8%, about 0.85%, about 0.9%, about 0.95%, about 1%, or about 1.25% salt (w/v). In some embodiments, the formulation comprises at least about 0.1%, about 0.25%, about 0.5%, about 0.6%, about 0.7%, about 0.75%, about 0.8%, about 0.85%, about 0.9%, about 0.95%, or about 1% salt (w/v). In some embodiments, the formulation comprises at most about 0.25%, about 0.5%, about 0.6%, about 0.7%, about 0.75%, about 0.8%, about 0.85%, about 0.9%, about 0.95%, about 1%, or about 1.25% salt (w/v). In some embodiments, the formulation comprises about 0.85% salt (w/v). In some embodiments, the formulation comprises from about 0.8% to about 0.9% salt (w/v). In some embodiments, the formulation comprises from about 0.75% to about 0.95% salt (w/v). In some embodiments, the formulation comprises from about 0.7% to about 1% salt (w/v). In some embodiments, the formulation comprises from about 0.5% to about 1.25% salt (w/v). In some embodiments, the formulation comprises from about 0.5% to about 2% salt (w/v). In some embodiments, the formulation comprises 0.1-0.2%, 0.2-0.3%, 0.3-0.4%, 0.4-0.5%, 0.5-0.6%, 0.6-0.7%, 0.7-0.8%, 0.8-0.9%, 0.9-1.0%, 1.0-1.1%, 1.1-1.2%, 1.2-1.3%, 1.3-1.4%, or 1.4-1.5% salt (w/v).

Any salt may be used. In some preferred embodiments, the salt is NaCl. In some embodiments, the salt is NaCl, LiCl, KCl, MgCl₂, CaCl₂), NaBr, LiBr, KBr, MgBr₂, CaBr₂, NaI, LiI, KI, MgI₂, or CaI₂. In some embodiments, the salt comprises sodium, lithium, or potassium ions. In some embodiments, the salt comprises alkali metal ions. In some embodiments, the salt comprises alkaline earth metal ions. In some embodiments, the salt comprises halide ions. In some embodiments, the salt is an alkali or alkaline earth halide salt. In some embodiments, the salt comprises chloride, bromide, or iodide ions. In some embodiments, the salt is a sulfate, phosphate, carbonate, or nitrate salt.

In some embodiments, the formulation comprises an additional additive. In some embodiments, the formulation comprises dimethyl sulfoxide (DMSO), 1-dodecylazacycloheptan-2-one, laurocapram, 1-methyl-2-pyrrolidone (NMP), oleic acid, ethanol, methanol, polyethylene glycol (Brij 35, 58, 98), polyethylene glycol monolaurate (e.g. Tween 20), Tween 40 (Polyoxyethylenate sorbitol ester), Tween 60, Tween 80 (non-ionic), cetylmethylammonium bromide (CTAB), urea, lecithins (solidified fatty acids derived from soybean), chitosan, Poloxamer 188, Poloxamer 237, Poloxamer 338, Poloxamer 407, or a combination thereof. In some embodiments, the formulation comprises polyethylene glycol monolaurate (e.g. Tween 20), Poloxamer 188, Poloxamer 237, Poloxamer 338, Poloxamer 407, or a combination thereof. In some embodiments, the formulation comprises a Poloxamer. In some embodiments, the formulation comprises polyethylene glycol monolaurate (e.g. Tween 20). The additional additive may be present at any concentration. In some embodiments, the additional additive comprises up to about 0.01%, 0.05%, 0.1%, 0.125%, 0.15%, 0.2%, 0.5% or 1% (v/v) of the formulation. In some embodiments, the additional additive comprises about 0.01% to about 1% (v/v) of the formulation. In some embodiments, the additional additive comprises about 0.1% (v/v) of the formulation.

In some embodiments, the formulation comprises an additional metal ion. In some embodiments, the formulation comprises magnesium, calcium, manganese, or any combination thereof. In some embodiments, the formulation comprises magnesium. In some embodiments, the formulation comprises calcium. In some embodiments, the formulation comprises manganese. In some embodiments, the formulation comprises magnesium and calcium. In some embodiments, the formulation comprises magnesium and manganese. In some embodiments, the formulation comprises calcium and manganese. In some embodiments, the formulation comprises magnesium, calcium, and manganese.

In some embodiments, the formulation comprises one or more nutrients for the microorganisms. In some embodiments, the formulation comprises a bacterial growth media. In some embodiments, the formulation comprises lysogeny broth (LB), nutrient broth, or a combination thereof. In some embodiments, the formulation comprises lysogeny broth. In some embodiments, the formulation comprises nutrient broth.

In some embodiments, the formulation comprises additional ingredient for promoting endosporulation of the one or more microorganisms. In some embodiments, the formulation comprises the formulation comprises potassium, ferrous sulfate, calcium, magnesium, manganese, or a combination thereof. In some embodiments, the formulation comprises potassium. In some embodiments, the formulation comprises ferrous sulfate. In some embodiments, the formulation comprises calcium. In some embodiments, the formulation comprises magnesium. In some embodiments, the formulation comprises manganese.

In some embodiments, the formulation comprises a microorganism. In some embodiments, formulation comprises from about 10³ to about 10¹⁷ colony forming units (CFU)/mL of the microorganism. In some embodiments, the formulation comprises at least 1×10⁶ CFU/mL of the microorganism. In some embodiments, the formulation comprises about 10³ to about 10⁴, about 10³ to about 10⁵, about 10³ to about 10⁶, about 10³ to about 10⁷, about 10³ to about 10⁸, about 10³ to about 10⁹, about 10³ to about 10¹⁰, about 10³ to about 10¹², about 10³ to about 10¹⁵, about 10³ to about 10¹⁷, about 10⁴ to about 10⁵, about 10⁴ to about 10⁶, about 10⁴ to about 10⁷, about 10⁴ to about 10⁸, about 10⁴ to about 10⁹, about 10⁴ to about 10¹⁰, about 10⁴ to about 10¹², about 10⁴ to about 10¹⁵, about 10⁴ to about 10¹⁷, about 10⁵ to about 10⁶, about 10⁵ to about 10⁷, about 10⁵ to about 10⁸, about 10⁵ to about 10⁹, about 10⁵ to about 10¹⁰, about 10⁵ to about 10¹², about 10⁵ to about 10¹⁵, about 10⁵ to about 10¹⁷, about 10⁶ to about 10⁷, about 10⁶ to about 10⁸, about 10⁶ to about 10⁹, about 10⁶ to about 10¹⁰, about 10⁶ to about 10¹², about 10⁶ to about 10¹⁵, about 10⁶ to about 10¹⁷, about 10⁷ to about 10⁸, about 10⁷ to about 10⁹, about 10⁷ to about 10¹⁰, about 10⁷ to about 10¹², about 10⁷ to about 10¹⁵, about 10⁷ to about 10¹⁷, about 10⁸ to about 10⁹, about 10⁸ to about 10¹⁰, about 10⁸ to about 10¹², about 10⁸ to about 10¹⁵, about 10⁸ to about 10¹⁷, about 10⁹ to about 10¹⁰, about 10⁹ to about 10¹², about 10⁹ to about 10¹⁵, about 10⁹ to about 10¹⁷, about 10¹⁰ to about 10¹², about 10¹⁰ to about 10¹⁵, about 10¹⁰ to about 10¹⁷, about 10¹² to about 10¹⁵, about 10¹² to about 10¹⁷, or about 10¹⁵ to about 10¹⁷ CFU/mL of the microorganism. In some embodiments, the formulation comprises about 10³, about 10⁴, about 10⁵, about 10⁶, about 10⁷, about 10¹, about 10⁹, about 10¹⁰, about 10¹², about 10¹⁵, or about 10¹⁷ CFU/mL of the microorganism. In some embodiments, the formulation comprises at least about 10³, about 10⁴, about 10⁵, about 10⁶, about 10⁷, about 10¹, about 10⁹, about 10¹⁰, about 10¹², or about 10¹⁵ CFU/mL of the microorganism. In some embodiments, the formulation comprises at most about 10⁴, about 10⁵, about 10⁶, about 10⁷, about 10⁸, about 10⁹, about 10¹⁰, about 10¹², about 10¹⁵, or about 10¹⁷ CFU/mL of the microorganism. In some embodiments, the formulation comprises at least about 10⁶ to 10⁷ CFU/mL of the microorganism. In some embodiments, the formulation comprises 1×10³ to 1×10⁴ CFU/mL; 1×10⁴ to 1×10⁵ CFU/mL; 1×10⁵ to 1×10⁶ CFU/mL; 1×10⁶ to 1×10⁷ CFU/mL; 1×10⁷ to 1×10⁸ CFU/mL; 1×10⁸ to 1×10⁹ CFU/mL; 1×10⁹ to 1×10¹⁰ CFU/mL; 1×10¹⁰ to 1×10¹¹ CFU/mL; 1×10¹¹ to 1×10¹² CFU/mL; 1×10¹² to 1×10¹³ CFU/mL; 1×10¹³ to 1×10¹⁴ CFU/mL; 1×10¹⁴ to 1×10¹⁵ CFU/mL; 1×10⁵ to 1×10¹⁶ CFU/mL; or 1×10¹⁶ to 1×10¹⁷ CFU/mL of the microorganism. The microorganism can be any of the microorganisms provided herein or an endospore of any of the microorganisms provided herein.

In some embodiments, the formulation is maintained at a desired temperature. In some embodiments, the formulation is maintained at a temperature of about 2 to about 40° C. In some embodiments, the formulation is maintained at a temperature of about 2 to about 4, about 2 to about 8, about 2 to about 12, about 2 to about 16, about 2 to about 25, about 2 to about 30, about 2 to about 35, about 2 to about 40, about 4 to about 8, about 4 to about 12, about 4 to about 16, about 4 to about 25, about 4 to about 30, about 4 to about 35, about 4 to about 40, about 8 to about 12, about 8 to about 16, about 8 to about 25, about 8 to about 30, about 8 to about 35, about 8 to about 40, about 12 to about 16, about 12 to about 25, about 12 to about 30, about 12 to about 35, about 12 to about 40, about 16 to about 25, about 16 to about 30, about 16 to about 35, about 16 to about 40, about 25 to about 30, about 25 to about 35, about 25 to about 40, about 30 to about 35, about 30 to about 40, or about 35 to about 40° C. In some embodiments, the formulation is maintained at a temperature of about 2, about 4, about 8, about 12, about 16, about 25, about 30, about 35, or about 40° C. In some embodiments, the formulation is maintained at a temperature are of at least about 2, about 4, about 8, about 12, about 16, about 25, about 30, or about 35° C. In some embodiments, the formulation is maintained at a temperature of at most about 4, about 8, about 12, about 16, about 25, about 30, about 35, or about 40° C.

### Microorganisms and Exudates

The microorganisms or exudates thereof provided herein produce or promote the formation of bicarbonate and one or more minerals. In some embodiments, the formation of bicarbonate sequesters CO₂. In some embodiments, the formation of bicarbonate leads to minerals formation. In some embodiments, the formed minerals stably sequester carbon in the soil. In some embodiments, the microorganism is a bacterium. In some embodiments, the microorganism is an endospore forming bacteria. In some embodiments, the microorganism is an endospore of a bacteria. Whenever a microorganism (e.g. a bacterium) referenced herein is capable of forming an endospore, it is intended that any endospore of the microorganism is also encompassed. For example, if a plant seed treatment formulation comprises a Bacillus sp., the formulation may comprise endospores of the Bacillus sp.

In some embodiments, the microorganism is a microbe from the phyla of Firmicutes, Proteobacteria, and Actinobacteria. In some embodiments, the microorganism is a microbe from the phylum Firmicutes. In some embodiments, the microorganism is a microbe from the phylum Proteobacteria. In some embodiments, the microorganism is a microbe from the phylum Actinobacteria. In some embodiments, the microorganism is an endospore of any of the microorganisms.

Rhizobacteria that fix atmospheric nitrogen are found on the roots of plants. These organisms are able to survive in soil and have tolerance to a great amount of CO₂ that is either being released by the roots of plants during respiration or CO₂ evolution by nearby microbial and soil fauna community through respiration.

Because these rhizobacteria are in the closer proximity to the roots, these organisms have the ability to utilize root exudates as a carbon and energy source. Many of them have evolved to possess genes that allow them to convert CO₂ to biomass or any metabolites for their own benefit. In some embodiments, the bacterium is not genetically modified. In some embodiments, the bacterium is selected for its ability to convert CO₂ to bicarbonate and minerals.

The rhizobacteria can colonize more aggressively the plant roots. Thus, these form a stable community that is able to survive in changing soil environment, secrete antimicrobial compounds to inhibit growth of pathogens or invaders and can form endospores that give them a selective fitness to survive in harsh environment.

The rhizobacteria apart from the other means of fixing CO₂, have the ability to express a well characterized enzyme, the Carbonic Anhydrase (CA). A wide temperature tolerance (up to 50° C.), a wide pH range and its high-level expression make CA as an ideal candidate to sequester CO₂ in the soil. This enzyme converts CO₂ in bicarbonate and via hydrolysis the bicarbonate converts to carbonate ions. Carbonate ions will react with cations present in the soil and minerals will be produced. Because soil is rich in many cations (Ca²⁺, Mg²⁺, Na⁺, K⁺), this sustains mineralization and a variety of minerals can be formed as a mean to permanently trap CO₂ in the soil. In some embodiments, the bacterium is selected for its use of carbonic anhydrase.

In some embodiments, the carbonic anhydrase is an α-Ca, β-CA, δ-CA, ζ-CA, η-CA, or an τ-CA. In some embodiments, the CA is CA-1, CA-2, CA-3, CA-4, CA-5A, CA-5B, CA-6, CA-7, CA-8, CA-9, CA-10, CA-11, CA-12, CA-13, CA-14 or CA-15.

In some embodiments, a variety of rhizobacteria effectively loaded into the seeds. In some embodiments, the rhizobacteria includes an endospore-forming bacteria that enhances the biological nitrogen fixation. In some embodiments, said rhizobacteria comprise Bacillus sp, Paenibacillus sp, or both. In some embodiments, said one or more microorganisms comprise B. amyloliquefaciens, B. laterosporus, B. licheniformis, B. macerans, B. cereus, B. circulans, B. firmus, B. subtilis, B. sphaericus, B. megaterium, B. coagulans, B. brevis, B. thuringiensis, B. mycoides, B. cucumis, B. endophyticus, B. pumilus, B. velezensis, B. mucilaginosus, B. tequilensis, B. methylotrophicus, or any combination thereof. In some embodiments, said one or more microorganisms comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12 Bacillus cucumis S3C14, Bacillus endophyticus 5, or any combination thereof. In some embodiments, said one or more microorganisms comprise Bacillus subtilis S3C23. In some embodiments, said one or more microorganisms comprise Bacillus subtilis MP2.

CO₂ sequestration by these microorganisms can be achieved by their ability to produce or promote the formation of CA. These rhizobacteria can colonize roots and can replace other microbial community in the near vicinity that otherwise could use nutrients from root exudates. CO₂ coming off the roots, from soil fauna or from microbial community can be captured by CA through its hydration to bicarbonate. Typically, to form minerals (CaCO₃, MgCO₃, CaMg(CO₃)₂), cations are required for the continuation of the process yielding minerals. Soil has a variety of cation present in it already allowing for a sustainable process. The amount of Ca²⁺ and Mg²⁺ in soil can depend upon the geographical location, type of soil and the irrigation pattern. These cations can be further adjusted by the farmers by applying limestone to maintain the high fertility of soil. A typical well irrigated soil has an average of 850 kg (Ca²⁺)/acre and 218 kg (Mg²⁺)/acre considering the first 15 cm depth. As per one prior published study, the amount of CO₂ produced in the corn rhizosphere is around 7000 kg/acre per corn season. Considering the amount of available CO₂ and cations, a significant amount of CO₂ can be stored as Ca or Mg minerals. Mathematically, 425 kg of CaCO₃ and 114 kg of MgCO₃ can be formed while there are many more combinations of forming other minerals such Na₂CO₃, depending upon the presence of other relevant cations in the soil (Na⁺, K⁺). Because the lime treatment is performed by farmers to maintaining high fertility of soil, the microorganisms disclosed herein could obviate this requirement by biologically producing limestone (CaCO₃). In addition, depending upon the availability of other cations in the soil, a variety of mineral can form to store gaseous CO₂. These minerals include, without limitations, calcite, aragonite, dolomite, limestone, carbonates, magnesium carbonates, iron carbonates, magnesite, cohenite, diamond, carbonatite, ferrous carbonate, spurrite, and tilleyite.

In some embodiments, the amount of minerals produced can be between 50 kg/acre up to 1000 kg/acre. In some embodiments, the amount of minerals produced can be between about 50 kg/acre to about 1,000 kg/acre. In some embodiments, the amount of minerals produced can be between about 50 kg/acre to about 100 kg/acre, about 50 kg/acre to about 200 kg/acre, about 50 kg/acre to about 300 kg/acre, about 50 kg/acre to about 400 kg/acre, about 50 kg/acre to about 500 kg/acre, about 50 kg/acre to about 600 kg/acre, about 50 kg/acre to about 700 kg/acre, about 50 kg/acre to about 800 kg/acre, about 50 kg/acre to about 900 kg/acre, about 50 kg/acre to about 1,000 kg/acre, about 100 kg/acre to about 200 kg/acre, about 100 kg/acre to about 300 kg/acre, about 100 kg/acre to about 400 kg/acre, about 100 kg/acre to about 500 kg/acre, about 100 kg/acre to about 600 kg/acre, about 100 kg/acre to about 700 kg/acre, about 100 kg/acre to about 800 kg/acre, about 100 kg/acre to about 900 kg/acre, about 100 kg/acre to about 1,000 kg/acre, about 200 kg/acre to about 300 kg/acre, about 200 kg/acre to about 400 kg/acre, about 200 kg/acre to about 500 kg/acre, about 200 kg/acre to about 600 kg/acre, about 200 kg/acre to about 700 kg/acre, about 200 kg/acre to about 800 kg/acre, about 200 kg/acre to about 900 kg/acre, about 200 kg/acre to about 1,000 kg/acre, about 300 kg/acre to about 400 kg/acre, about 300 kg/acre to about 500 kg/acre, about 300 kg/acre to about 600 kg/acre, about 300 kg/acre to about 700 kg/acre, about 300 kg/acre to about 800 kg/acre, about 300 kg/acre to about 900 kg/acre, about 300 kg/acre to about 1,000 kg/acre, about 400 kg/acre to about 500 kg/acre, about 400 kg/acre to about 600 kg/acre, about 400 kg/acre to about 700 kg/acre, about 400 kg/acre to about 800 kg/acre, about 400 kg/acre to about 900 kg/acre, about 400 kg/acre to about 1,000 kg/acre, about 500 kg/acre to about 600 kg/acre, about 500 kg/acre to about 700 kg/acre, about 500 kg/acre to about 800 kg/acre, about 500 kg/acre to about 900 kg/acre, about 500 kg/acre to about 1,000 kg/acre, about 600 kg/acre to about 700 kg/acre, about 600 kg/acre to about 800 kg/acre, about 600 kg/acre to about 900 kg/acre, about 600 kg/acre to about 1,000 kg/acre, about 700 kg/acre to about 800 kg/acre, about 700 kg/acre to about 900 kg/acre, about 700 kg/acre to about 1,000 kg/acre, about 800 kg/acre to about 900 kg/acre, about 800 kg/acre to about 1,000 kg/acre, or about 900 kg/acre to about 1,000 kg/acre. In some embodiments, the amount of minerals produced can be between about 50 kg/acre, about 100 kg/acre, about 200 kg/acre, about 300 kg/acre, about 400 kg/acre, about 500 kg/acre, about 600 kg/acre, about 700 kg/acre, about 800 kg/acre, about 900 kg/acre, or about 1,000 kg/acre. In some embodiments, the amount of minerals produced can be between at least about 50 kg/acre, about 100 kg/acre, about 200 kg/acre, about 300 kg/acre, about 400 kg/acre, about 500 kg/acre, about 600 kg/acre, about 700 kg/acre, about 800 kg/acre, or about 900 kg/acre. In some embodiments, the amount of minerals produced can be between at most about 100 kg/acre, about 200 kg/acre, about 300 kg/acre, about 400 kg/acre, about 500 kg/acre, about 600 kg/acre, about 700 kg/acre, about 800 kg/acre, about 900 kg/acre, or about 1,000 kg/acre.

In some embodiments, amount of CO₂ converted by the microorganisms is between 0.1 tons of CO₂ per acre up to 2.5 tons of CO₂/acre. In some embodiments, the microorganisms convert 2.5 to 5.3 tons of CO₂/acre. In some embodiments, the microorganisms convert 5.3 to 7.5 tons of CO₂/acre. In some embodiments, the microorganisms convert 7.5 to 10 tons of CO₂/acre. In some embodiments, the microorganisms convert 10 to 15 tons of CO₂/acre. In some embodiments, the microorganisms convert 15 to 20 tons/acre. In some embodiments, amount of CO₂ converted by the microorganisms is between about 2 tons/acre to about 20 tons/acre. In some embodiments, amount of CO₂ converted by the microorganisms is between about 2 tons/acre to about 4 tons/acre, about 2 tons/acre to about 6 tons/acre, about 2 tons/acre to about 8 tons/acre, about 2 tons/acre to about 10 tons/acre, about 2 tons/acre to about 12 tons/acre, about 2 tons/acre to about 14 tons/acre, about 2 tons/acre to about 16 tons/acre, about 2 tons/acre to about 18 tons/acre, about 2 tons/acre to about 20 tons/acre, about 4 tons/acre to about 6 tons/acre, about 4 tons/acre to about 8 tons/acre, about 4 tons/acre to about 10 tons/acre, about 4 tons/acre to about 12 tons/acre, about 4 tons/acre to about 14 tons/acre, about 4 tons/acre to about 16 tons/acre, about 4 tons/acre to about 18 tons/acre, about 4 tons/acre to about 20 tons/acre, about 6 tons/acre to about 8 tons/acre, about 6 tons/acre to about 10 tons/acre, about 6 tons/acre to about 12 tons/acre, about 6 tons/acre to about 14 tons/acre, about 6 tons/acre to about 16 tons/acre, about 6 tons/acre to about 18 tons/acre, about 6 tons/acre to about 20 tons/acre, about 8 tons/acre to about 10 tons/acre, about 8 tons/acre to about 12 tons/acre, about 8 tons/acre to about 14 tons/acre, about 8 tons/acre to about 16 tons/acre, about 8 tons/acre to about 18 tons/acre, about 8 tons/acre to about 20 tons/acre, about 10 tons/acre to about 12 tons/acre, about 10 tons/acre to about 14 tons/acre, about 10 tons/acre to about 16 tons/acre, about 10 tons/acre to about 18 tons/acre, about 10 tons/acre to about 20 tons/acre, about 12 tons/acre to about 14 tons/acre, about 12 tons/acre to about 16 tons/acre, about 12 tons/acre to about 18 tons/acre, about 12 tons/acre to about 20 tons/acre, about 14 tons/acre to about 16 tons/acre, about 14 tons/acre to about 18 tons/acre, about 14 tons/acre to about 20 tons/acre, about 16 tons/acre to about 18 tons/acre, about 16 tons/acre to about 20 tons/acre, or about 18 tons/acre to about 20 tons/acre. In some embodiments, amount of CO₂ converted by the microorganisms is between about 2 tons/acre, about 4 tons/acre, about 6 tons/acre, about 8 tons/acre, about 10 tons/acre, about 12 tons/acre, about 14 tons/acre, about 16 tons/acre, about 18 tons/acre, or about 20 tons/acre. In some embodiments, amount of CO₂ converted by the microorganisms is between at least about 2 tons/acre, about 4 tons/acre, about 6 tons/acre, about 8 tons/acre, about 10 tons/acre, about 12 tons/acre, about 14 tons/acre, about 16 tons/acre, or about 18 tons/acre. In some embodiments, amount of CO₂ converted by the microorganisms is between at most about 4 tons/acre, about 6 tons/acre, about 8 tons/acre, about 10 tons/acre, about 12 tons/acre, about 14 tons/acre, about 16 tons/acre, about 18 tons/acre, or about 20 tons/acre.

In some embodiments, promotion of production of said one or more minerals comprises production of ammonia and a resulting increase in pH in a medium in which a plant derived from said plant seed is grown.

The mineralization process can start either on the cell-wall or EPS of the microorganisms. The cell-wall due to the presence of overall negative charge has been shown to be the site of nucleation and mineralization. In some microorganisms such as Bacillus subtilis, EPS contains a significantly high number of glutamate, aspartate, histidine, arginine and lysin that become negatively charged at alkaline conditions and could serve as the nucleation site for CaCO₃ precipitation. This may be beneficial as microorganisms that are attached to the root along with CaCO₃ on them can be taken out by uprooting the plant at the end of the season to prevent the addition of minerals in the soil, if not required.

In some embodiments, said one or more microorganisms comprise a genetic modification which causes said one or more microorganisms to produce or promote the formation of more carbonic anhydrase relative to corresponding wild type microorganisms. In some embodiments, genetic modification comprises a nucleic acid construct, wherein said nucleic acid construct comprises one or more promoters configured to drive expression of a carbonic anhydrase (CA) coding sequence. In some embodiments, said genetic modification comprises a nucleic acid construct, wherein said nucleic acid construct comprises a carbonic anhydrase (CA) coding sequence. In some embodiments, said CA coding sequence is heterologous to said one or more microorganisms. In some embodiments, said CA coding sequence is endogenous to said one or more microorganisms. In some embodiments, the nucleic acid construct is codon optimized. In some embodiments, said nucleic acid construct further comprises one or more promoters configured to drive expression of said CA coding sequence. In some embodiments, said one or more promoters drive constitutive expression of said CA coding sequence. In some embodiments, said one or more promoters drive inducible expression of said CA coding sequence. In some embodiments, said genetic modification comprises a carbonic anhydrase gene which has been modified by direct microbial evolution. In some embodiments, said genetic modification comprises a signal sequence. In some embodiments, said signal sequence comprises a periplasmic signal sequence or an extracellular secretion signal. In some embodiments, said periplasmic signal sequence or said extracellular secretion signal is disposed to a 5′ end of a carbonic anhydrase coding sequence. In some embodiments, said periplasmic signal sequence or said extracellular secretion signal is fused to a 5′ end of a carbonic anhydrase coding sequence. In some embodiments, said genetic modification comprises one or more components of the general secretion pathway, and wherein said genetic modification results in secretion or subcellular targeting of carbonic anhydrase by said one or more microorganisms.

In some embodiments, the carbonic anhydrase is an α-Ca, β-CA, δ-CA, ζ-CA, η-CA, or an τ-CA. In some embodiments, the CA is a CA-1, CA-2, CA-3, CA-4, CA-5A, CA-5B, CA-6, CA-7, CA-8, CA-9, CA-10, CA-11, CA-12, CA-13, CA-14 or CA-15.

In some embodiments, said one or more promoters are or are derived from one or more promoters comprised in Bacillus sp. or Paenibacillus sp. In some embodiments, said one or more promoters is selected from P_{groES}, P₄₃, P_{sigX}, P_{trnQ}, and P_{xylA}. In some embodiments, said one or more promoters are or are derived from one or more housekeeping gene promoters or strongly expressed constitutive promoters. In some embodiments, said one or more housekeeping gene promoters or strongly expressed constitutive promoters is selected from P_{haG}, P_{lepA}, P_{veg}, P_{gstB}, P43, P_{trnQ}, Pₗᵢₐₗ (bacitracin inducible), and P_{xylA} (xylose inducible).

In some embodiments, said genetic modification comprises an introduction of an expression vector to the one or microorganisms. In some embodiments, said genetic modification comprises a modification to a chromosome of the one or microorganisms.

In some embodiments, the microorganisms may fix both nitrogen and carbon dioxide. In some embodiments, the nitrogen fixing microorganisms will continue to provide fixed nitrogen (ammonia) via biological nitrogen fixation to plants and this would reduce the use of chemical fertilizers that are polluting the environment. The end product (ammonia) of atmospheric nitrogen fixation may enhance the process of CO₂ to minerals because ammonia has been reported to increase the pH that accelerated mineralization. Because the ammonia production from the microorganisms disclosed herein is significantly higher than other soil inhabiting microorganisms even in the presence of external nitrogen source, the mineralization process may be quicker by the strains disclosed herein than the other microorganisms inhabiting in soil.

In some embodiments, the microorganism is a microbe selected from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Bradyrhizobium sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Klebsiella sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Penicillium sp., Pelospora sp., Pelotomaculum sp., Piscibacillus sp., Plamfilum sp., Pontibacillus sp., Propionispora sp., Salinibacillus sp., Salsuginibacillus sp., Seinonella sp., Shimazuella sp., Sinorhizobium sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp. and Vulcanobacillus sp., and Xanthobacter. In some embodiments, the microorganism is a microbe selected from Acetobacter sp., Actinomyces sp., Bacillus sp., Chryseobacterium sp., Coxiella sp., Ensifer sp., Glutamicibacter sp., Microbacterium sp., or Serratia sp. In some embodiments, the microorganism is an Acetobacter sp. In some embodiments, the microorganism is an Actinomyces sp. In some embodiments, the microorganism is a Bacillus sp. In some embodiments, the microorganism is a Chryseobacterium sp. In some embodiments, the microorganism is a Coxiella sp. In some embodiments, the microorganism is an Ensifer sp. In some embodiments, the microorganism is a Glutamicibacter sp. In some embodiments, the microorganism is a Microbacterium sp. In some embodiments, the microorganism is a Pantoea sp. In some embodiments, the microorganism is a Serratia sp. In some embodiments, the microorganism is an endospore of any of the microorganisms.

In some embodiments, the microorganism comprises an Acetobacter cerevisiae, Bacillus cucumis, Bacillus endophyticus, Bacillus megaterium, Bacillus nakamurai, Bacillus subtilis, Chryseobacterium lactis, Ensifer adhaerens, Glutamicibacter arilaitensis, Glutamicibacter halophytocola, Microbacterium chocolatum, Microbacterium yannicii, Pantoea allii, Serratia marcescens, or Serratia ureilytica. In some embodiments, the microorganism comprises an Acetobacter cerevisiae, Bacillus cucumis, Bacillus endophyticus, Bacillus megaterium, Bacillus nakamurai, Bacillus subtilis, Chryseobacterium lactis, Ensifer adhaerens, Glutamicibacter halophytocola, Microbacterium chocolatum, Pantoea allii, or Serratia marcescens. In some embodiments, the microorganism comprises Acetobacter cerevisiae. In some embodiments, the microorganism comprises Bacillus cucumis. In some embodiments, the microorganism comprises Bacillus endophyticus. In some embodiments, the microorganism comprises Bacillus megaterium. In some embodiments, the microorganism comprises Bacillus subtilis. In some embodiments, the microorganism comprises Chryseobacterium lactis. In some embodiments, the microorganism comprises Ensifer adhaerens. In some embodiments, the microorganism comprises Glutamicibacter halophytocola. In some embodiments, the microorganism comprises Microbacterium chocolatum. In some embodiments, the microorganism comprises Pantoea allii. In some embodiments, the microorganism comprises Serratia marcescens. In some embodiments, the microorganism is an endospore of any of the microorganisms.

In some embodiments, the microorganism is an endospore forming bacteria. In some embodiments, the endospore forming bacteria is from the genus Bacillus. In some embodiments, the endospore forming bacteria is a Bacillus sp. In some embodiments, the endospore forming bacteria comprises Bacillus cucumis, Bacillus endophyticus, Bacillus megaterium, Bacillus nakamurai, or Bacillus subtilis. In some embodiments, the endospore forming bacteria comprises Bacillus cucumis, Bacillus endophyticus, Bacillus megaterium or Bacillus subtilis. In some embodiments, the endospore forming bacteria comprises Bacillus cucumis. In some embodiments, the endospore forming bacteria comprises Bacillus megaterium. In some embodiments, the endospore forming bacteria comprises Bacillus nakamurai. In some embodiments, the endospore forming bacteria comprises Bacillus subtilis. In some embodiments, the microorganism is an endospore of any of the microorganisms.

In some embodiments, the microorganism is an endospore. In some embodiments, the endospore is from the genus Bacillus. In some embodiments, the endospore is a Bacillus sp. In some embodiments, the endospore comprises Bacillus cucumis, Bacillus endophyticus, Bacillus megaterium, Bacillus nakamurai, or Bacillus subtilis. In some embodiments, the endospore comprises Bacillus cucumis, Bacillus endophyticus, Bacillus megaterium or Bacillus subtilis. In some embodiments, the endospore comprises Bacillus cucumis. In some embodiments, the endospore comprises Bacillus megaterium. In some embodiments, the endospore comprises Bacillus nakamurai. In some embodiments, the endospore comprises Bacillus subtilis.

In some embodiments, a consortium of microorganisms is incorporated into the seed. In some embodiments, the consortium comprises two or more bacterium selected from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Pelospora sp., Pelotomaculum sp., Piscibacillus sp., Planfilum sp., Pontibacillus sp., Propionispora sp., Salinibacillus sp., Salsuginibacillus sp., Seinonella sp., Shimazuella sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp. and Vulcanobacillus sp. In some embodiments, the consortium comprises two or more bacterium selected from selected from Acetobacter sp., Actinomyces sp., Bacillus sp., Chryseobacterium sp., Coxiella sp., Ensifer sp., Glutamicibacter sp., Microbacterium sp., or Serratia sp. In some embodiments, the consortium comprises two, three, four, five, six, seven, eight, nine, ten, or more bacterium. In some embodiments, the consortium comprises two bacteria. In some embodiments, the consortium comprises three bacteria. In some embodiments, the consortium comprises four bacteria. In some embodiments, the consortium comprises five bacteria. In some embodiments, the consortium comprises six bacteria. In some embodiments, the consortium comprises endospores of any of the microorganisms.

In some embodiments, the consortium comprises a bacterium from the phylum Bacillus and one or more bacteria. In some embodiments, the consortium comprises a bacteria from the phylum Bacillus and one or more bacteria selected from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Pelospora sp., Pelotomaculum sp., Piscibacillus sp., Plamfilum sp., Pontibacillus sp., Propionispora sp., Salinibacillus sp., Salsuginibacillus sp., Seinonella sp., Shimazuella sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp. and Vulcanobacillus sp. In some embodiments, the consortium comprises two or more bacterium selected from selected from Acetobacter sp., Actinomyces sp., Bacillus sp., Chryseobacterium sp., Coxiella sp., Ensifer sp., Glutamicibacter sp., Microbacterium sp., and Serratia sp. In some embodiments, the consortium comprises endospores of any of the microorganisms.

In some embodiments, the consortium comprises a mixture of two or more bacteria selected from Bacillus endophyticus, Bacillus megaterium, Bacillus nakamurai, Bacillus subtilis, Chryseobacterium lactis, Ensifer adhaerens, Glutamicibacter arilaitensis, Glutamicibacter halophytocola, Microbacterium chocolatum, Microbacterium yannicii, Pantoea allii, Serratia marcescens, and Serratia ureilytica. In some embodiments, the consortium comprises a mixture of two or more bacteria selected from Acetobacter cerevisiae, Bacillus cucumis, Bacillus endophyticus, Bacillus megaterium, Bacillus nakamurai, Bacillus subtilis, Chryseobacterium lactis, Ensifer adhaerens, Glutamicibacter halophytocola, Microbacterium chocolatum, Pantoea allii, and Serratia marcescens. In some embodiments, the consortium comprises a mixture of two, three, four, five, six, seven, eight, nine, or ten bacteria. In some embodiments, the consortium comprises two bacteria. In some embodiments, the consortium comprises three bacteria. In some embodiments, the consortium comprises four bacteria. In some embodiments, the consortium comprises five bacteria. In some embodiments, the consortium comprises six bacteria. In some embodiments, the consortium comprises endospores of any of the microorganisms.

In some embodiments, the consortium comprises two or more bacteria selected from Acetobacter cereviseae, Chryseobacterium lactis, Bacillus cucumis, Bacillus endophyticus, Bacillus megaterium, Bacillus subtilis, and Ensifer adhaerens. In some embodiments, the consortium comprises two bacteria. In some embodiments, the consortium comprises three bacteria. In some embodiments, the consortium comprises four bacteria. In some embodiments, the consortium comprises five bacteria. In some embodiments, the consortium comprises six bacteria. In some embodiments, the consortium comprises seven bacteria. In some embodiments, the consortium comprises endospores of any of the microorganisms.

In some embodiments, the consortium comprises two or more bacteria selected from Acetobacter cereviseae, Chryseobacterium lactis, Bacillus endophyticus, and Bacillus megaterium. In some embodiments, the consortium comprises two bacteria selected from Acetobacter cereviseae, Chryseobacterium lactis, Bacillus endophyticus, and Bacillus megaterium. In some embodiments, the consortium comprises two bacteria selected from Acetobacter cereviseae, Chryseobacterium lactis, Bacillus endophyticus, and Bacillus megaterium. In some embodiments, the consortium comprises three bacteria selected from Acetobacter cereviseae, Chryseobacterium lactis, Bacillus endophyticus, and Bacillus megaterium. In some embodiments, the consortium comprises a mixture of Chryseobacterium lactis, Bacillus endophyticus, and Bacillus megaterium. In some embodiments, the consortium comprises a mixture of Chryseobacterium lactis, Bacillus endophyticus, and Bacillus megaterium. In some embodiments, the consortium comprises endospores of any of the microorganisms.

In some embodiments, the consortium comprises two or more bacteria selected from Bacillus subtilis, Bacillus cucumis, and Ensifer adhaerens. In some embodiments, the consortium comprises Ensifer adhaerens and Bacillus subtilis or Bacillus cucumis. In some embodiments, the consortium comprises Ensifer adhaerens and Bacillus subtilis. In some embodiments, the consortium comprises Ensifer adhaerens and Bacillus cucumis. In some embodiments, the consortium comprises endospores of any of the microorganisms.

In some embodiments, an exudate from any of the microorganisms provided herein is incorporated into the cell. In some embodiments, the exudate is from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Pelospora sp., Pelotomaculum sp., Piscibacillus sp., Planfilum sp., Pontibacillus sp., Propionispora sp., Salinibacillus sp., Salsuginibacillus sp., Seinonella sp., Shimazuella sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp. or Vulcanobacillus sp. In some embodiments, the exudate is from Acetobacter sp., Actinomyces sp., Bacillus sp., Chryseobacterium sp., Coxiella sp., Ensifer sp., Glutamicibacter sp., Microbacterium sp., and Serratia sp. In some embodiments, the exudate is from Acetobacter cerevisiae, Bacillus cucumis, Bacillus endophyticus, Bacillus megaterium, Bacillus nakamurai, Bacillus subtilis, Chryseobacterium lactis, Ensifer adhaerens, Glutamicibacter arilaitensis, Glutamicibacter halophytocola, Microbacterium chocolatum, Microbacterium yannicii, Pantoea allii, Serratia marcescens, or Serratia ureilytica. In some embodiments, the exudate is from Bacillus cucumis, Bacillus endophyticus, Bacillus megaterium, Bacillus nakamurai, or Bacillus subtilis. In some embodiments, the exudate is from endospores of any of the microorganisms.

In some embodiments, a microorganism is selected for one or more properties associated with the microorganism's ability to interact with the plant. In some embodiments, the microorganism is selected for compatibility. In some embodiments, the microorganism is selected to ensure no predatory or antagonistic effects will develop. In some embodiments, the microorganism is selected for stability during storage. In some embodiments, the microorganism is selected for rapid plant colonization and survival within associated tissues. In some embodiments, the microorganism is selected for optimal incorporation into the one or more seeds. In some embodiments, the microorganism remains present throughout the plant life cycle.

In some embodiments, a microorganism incorporated into a seed is stable after incorporation. In some embodiments, the microorganism is stable for greater than 30 days, for greater than six months, greater than one year, or greater than two years. In some embodiments, the microorganism is stable for greater than 30 days. In some embodiments, the microorganism is stable for greater than six months. In some embodiments, the microorganism is stable for greater than one year. In some embodiments, the microorganism is stable for greater than two years.

### Compositions Comprising Plants and Bacteria

In certain aspects, disclosed herein is a composition comprising a plant and one or more microorganisms associated with said plant, wherein said one or more microorganisms are, or are derived from, microorganisms selected to produce or promote the formation of bicarbonate and one or more minerals. In some embodiments, the composition is derived from cultivating a plant or a plant seed and one or more microorganisms associated with said plant or plant seed as described herein.

### Modified Plants

In one aspect, provided herein, is a modified plant comprising a microorganism or an exudate of a microorganism incorporated into the plant. In some embodiments, the microorganism or exudate produce or promote the formation of bicarbonate and one or more minerals. In some embodiments, the formation of bicarbonate sequesters CO₂. In some embodiments, the formation of bicarbonate leads to minerals formation. In some embodiments, the formed minerals stably sequester carbon in the soil. In some preferred embodiments, the microorganism is an endospore forming bacteria or endospore thereof.

In some embodiments, the microorganism or exudate is incorporated into the interior of the plant. In some embodiments, the microorganism or exudate is incorporated into the plant beneath the pericarp. In some embodiments, the microorganism or exudate is incorporated into the plant between the pericarp and the aleurone cell layer. In some embodiments, the microorganism or exudate contacts the embryo of the plant. In some embodiments, the microorganism or exudate does not contact the embryo of the plant. In some embodiments, the microorganism or exudate contacts the endosperm of the plant. In some embodiments, the microorganism or exudate does not contact the endosperm of the plant. In some embodiments, the microorganism or exudate is incorporated into the plant in an interspace between a plant coat and a plant embryo. In some embodiments, the microorganism or exudate is incorporated into an interspace between a plant pericarp and a plant aleurone cell layer.

The modified plant may be any type of plant. In some embodiments, the modified plant is a monocot plant. In some embodiments, the plant is a maize, a wheat, a rice, a barley, a rye, a sugar cane, a millet, an oat, or a sorghum plant. In some embodiments, the plant is a maize plant. In some embodiments, the plant is a Zea maize plant. In some embodiments, the modified plant is a dicot plant. In some embodiments, the plant is a soybean, cotton, alfalfa, bean, quinoa, lentil, peanut, sunflower, canola, cassava, oil palm, potato, sugar beet, cacao, coffea, lettuce, tomato, or cabbage plant. In some embodiments, the plant is a lettuce plant. In some embodiments, the plant is a Lactuca sativa plant. In some embodiments, the plant is a tomato plant. In some embodiments, the plant is a Solanum lycopersicum plant. In some embodiments, the plant is a genetically modified organism (GMO) plant. In some embodiments, the plant is a non-GMO plant.

An amount of microorganism or exudate incorporated into the plant must be of a sufficient level in order for effectively sequester CO₂. In some embodiments, the amount of microorganism incorporated into the plant is about 250 colony forming units (CFU) to about 5,000 CFU. In some embodiments, the amount of microorganism incorporated into the plant is about 250 CFU to about 500 CFU, about 250 CFU to about 750 CFU, about 250 CFU to about 1,000 CFU, about 250 CFU to about 2,000 CFU, about 250 CFU to about 3,000 CFU, about 250 CFU to about 4,000 CFU, about 250 CFU to about 5,000 CFU, about 500 CFU to about 750 CFU, about 500 CFU to about 1,000 CFU, about 500 CFU to about 2,000 CFU, about 500 CFU to about 3,000 CFU, about 500 CFU to about 4,000 CFU, about 500 CFU to about 5,000 CFU, about 750 CFU to about 1,000 CFU, about 750 CFU to about 2,000 CFU, about 750 CFU to about 3,000 CFU, about 750 CFU to about 4,000 CFU, about 750 CFU to about 5,000 CFU, about 1,000 CFU to about 2,000 CFU, about 1,000 CFU to about 3,000 CFU, about 1,000 CFU to about 4,000 CFU, about 1,000 CFU to about 5,000 CFU, about 2,000 CFU to about 3,000 CFU, about 2,000 CFU to about 4,000 CFU, about 2,000 CFU to about 5,000 CFU, about 3,000 CFU to about 4,000 CFU, about 3,000 CFU to about 5,000 CFU, or about 4,000 CFU to about 5,000 CFU. In some embodiments, the amount of microorganism incorporated into the plant is about 250 CFU, about 500 CFU, about 750 CFU, about 1,000 CFU, about 2,000 CFU, about 3,000 CFU, about 4,000 CFU, or about 5,000 CFU. In some embodiments, the amount of microorganism incorporated into the plant is at least about 250 CFU, about 500 CFU, about 750 CFU, about 1,000 CFU, about 2,000 CFU, about 3,000 CFU, or about 4,000 CFU. In some embodiments, the amount of microorganism incorporated into the plant is at most about 500 CFU, about 750 CFU, about 1,000 CFU, about 2,000 CFU, about 3,000 CFU, about 4,000 CFU, or about 5,000 CFU. In some embodiments, at least about 500 CFU are incorporated into the plant. In some embodiments, at least about 1000 CFU are incorporated into the plant.

In some embodiments, the microorganism or exudate incorporated into the plant is shelf stable for an extended period of time. In some embodiments, the modified plant is shelf stable for about 3 months to about 36 months. In some embodiments, the modified plant is shelf stable for about 3 months to about 6 months, about 3 months to about 9 months, about 3 months to about 12 months, about 3 months to about 15 months, about 3 months to about 18 months, about 3 months to about 21 months, about 3 months to about 24 months, about 3 months to about 30 months, about 3 months to about 36 months, about 6 months to about 9 months, about 6 months to about 12 months, about 6 months to about 15 months, about 6 months to about 18 months, about 6 months to about 21 months, about 6 months to about 24 months, about 6 months to about 30 months, about 6 months to about 36 months, about 9 months to about 12 months, about 9 months to about 15 months, about 9 months to about 18 months, about 9 months to about 21 months, about 9 months to about 24 months, about 9 months to about 30 months, about 9 months to about 36 months, about 12 months to about 15 months, about 12 months to about 18 months, about 12 months to about 21 months, about 12 months to about 24 months, about 12 months to about 30 months, about 12 months to about 36 months, about 15 months to about 18 months, about 15 months to about 21 months, about 15 months to about 24 months, about 15 months to about 30 months, about 15 months to about 36 months, about 18 months to about 21 months, about 18 months to about 24 months, about 18 months to about 30 months, about 18 months to about 36 months, about 21 months to about 24 months, about 21 months to about 30 months, about 21 months to about 36 months, about 24 months to about 30 months, about 24 months to about 36 months, or about 30 months to about 36 months. In some embodiments, the modified plant is shelf stable for about 3 months, about 6 months, about 9 months, about 12 months, about 15 months, about 18 months, about 21 months, about 24 months, about 30 months, or about 36 months. In some embodiments, the modified plant is shelf stable for at least about 3 months, about 6 months, about 9 months, about 12 months, about 15 months, about 18 months, about 21 months, about 24 months, or about 30 months. In some embodiments, the modified plant is shelf stable for at most about 6 months, about 9 months, about 12 months, about 15 months, about 18 months, about 21 months, about 24 months, about 30 months, or about 36 months.

In some embodiments, a microorganism incorporated into a plant is stable after incorporation. In some embodiments, the microorganism is stable for greater than 30 days, for greater than six months, greater than one year, or greater than two years. In some embodiments, the microorganism is stable for greater than 30 days. In some embodiments, the microorganism is stable for greater than six months. In some embodiments, the microorganism is stable for greater than one year. In some embodiments, the microorganism is stable for greater than two years

The microorganism or exudate thereof incorporated into plants may be any of the microorganisms provided herein, or any other microorganism. In some embodiments, the microorganism is a microbe. In some embodiments, the microorganism is an endospore forming microbe. In some embodiments, the microorganism is an endospore forming microbe or an endospore thereof. In some embodiments, the microorganism is an endospore of a microorganism provided herein. In some embodiments, the microorganism is an endospore forming bacteria or an endospore thereof.

### Methods of Incorporating Bacteria

In one aspect, provided herein, is a method of incorporating one or more microorganisms or exudates thereof into one or more plants. In some embodiments, the method comprises disinfecting the plants. In some embodiments, the method comprises contacting the plants with a solution comprising the one or more microorganisms or the exudate thereof. In some embodiments, the solution further comprises a salt. In some embodiments, the method comprises incubating the plants with the solution for a period of time. In some embodiments, the period of time is sufficient to allow a desired amount of microorganisms or exudates thereof into the plants. In some embodiments, the method incorporates a desired amount of microorganisms or exudate thereof into the plants.

In some embodiments, the method comprises contacting the plants with a solution comprising a salt as described herein

In some embodiments, the solution comprises an additional additive as described herein.

In some embodiments, the solution comprises an additional metal ion as described herein.

In some embodiments, the solution comprises one or more nutrients for the microorganisms as described herein. In some embodiments, the solution comprises a bacterial growth media. In some embodiments, the solution comprises lysogeny broth (LB), nutrient broth, or a combination thereof. In some embodiments, the solution comprises lysogeny broth. In some embodiments, the solution comprises nutrient broth.

In some embodiments, the solution comprises a microorganism as described herein.

In some embodiments, the solution comprises a desired amount of microorganism per plant mass as described herein.

In some embodiments, the plants comprise a desired amount of microorganism per plant as described herein. In some embodiments, the microorganism is a bacterium. In some embodiments, the bacterium is an endospore forming bacteria. In some embodiments, the method comprises inducing endosporulation of the endospore forming bacteria. In some embodiments, the bacteria incorporated into the plant is an endospore. In some embodiments, the solution comprises one or more ingredients to induce endosporulation. In some embodiments, the solution comprises potassium, ferrous sulfate, calcium, magnesium, manganese, or a combination thereof.

In some embodiments, the method comprises sterilizing the plants. In some embodiments, the method comprises sterilizing the surface of the plants. Any method of producing a plant with a sterilized surface may be employed. In some embodiments, the plant is sterilized with a bleach solution. In some embodiments, the plants are sterilized prior to immersing the plants in the solution containing the one or more microorganisms. In some embodiments, the plant is a sterilized plant. In some embodiments, the plant has a sterilized surface. As used herein, “sterilizing,” “sterilized” and related terms (e.g. “disinfecting” and the like) indicates that there are substantially no microorganisms alive on the sterilized item. In some embodiments, the plant is sterilized prior to incubating the plant in the solution comprising the microorganism. In some embodiments, the plant is sterilized after incubating the plant in the solution comprising the microorganism. In some embodiments, a fungicide is added to the surface of the plant.

In some embodiments, the sterilized or disinfected plants comprise substantially no living microorganisms on the plant (e.g. the surface of the plant). In some embodiments, the sterile or sterilized plant comprises less than 1 CFU, less than 5 CFU, less than 10 CFU, less than 20 CFU, less than 30 CFU, less than 40 CFU, or less than 50 CFU of microorganisms on the plant.

In some embodiments, the plants are incubated with the solution containing the microorganism for a time sufficient to incorporate the microorganism into the plant.

### Microorganisms and Exudates

The microorganisms or exudates thereof provided herein produce or promote the formation of bicarbonate and one or more minerals. In some embodiments, the formation of bicarbonate sequesters CO₂. In some embodiments, the formation of bicarbonate leads to minerals formation. In some embodiments, the formed minerals stably sequester carbon in the soil. In some embodiments, the microorganism is a bacterium as described herein. In some embodiments, the microorganism is an endospore forming bacteria. In some embodiments, the microorganism is an endospore of a bacterium. Whenever a microorganism (e.g. a bacterium) referenced herein is capable of forming an endospore, it is intended that any endospore of the microorganism is also encompassed. For example, if a plant treatment formulation comprises a Bacillus sp., the formulation may comprise endospores of the Bacillus sp.

In some embodiments, the microorganism is a microbe from the phyla of Firmicutes, Proteobacteria, and Actinobacteria. In some embodiments, the microorganism is a microbe from the phylum Firmicutes. In some embodiments, the microorganism is a microbe from the phylum Proteobacteria. In some embodiments, the microorganism is a microbe from the phylum Actinobacteria. In some embodiments, the microorganism is an endospore of any of the microorganisms.

Rhizobacteria that fix atmospheric nitrogen are found on the roots of plants. These organisms are able to survive in soil and have tolerance to a great amount of CO₂ that is either being released by the roots of plants during respiration or CO₂ evolution by nearby microbial and soil fauna community through respiration.

In some embodiments, the bacterium is not genetically modified. In some embodiments, the bacterium is selected for its ability to convert CO₂ to bicarbonate and ultimately minerals. In some embodiments, the bacterium is selected for its use of carbonic anhydrase.

In some embodiments, a variety of rhizobacteria effectively loaded into the seeds. In some embodiments, the rhizobacteria includes an endospore-forming bacteria that enhances the biological nitrogen fixation. In some embodiments, said rhizobacteria comprise Bacillus sp, Paenibacillus sp, or both. In some embodiments, said one or more microorganisms comprise B. amyloliquefaciens, B. laterosporus, B. licheniformis, B. macerans, B. cereus, B. circulans, B. firmus, B. subtilis, B. sphaericus, B. megaterium, B. coagulans, B. brevis, B. thuringiensis, B. mycoides, B. cucumis, B. endophyticus, B. pumilus, B. velezensis, B. mucilaginosus, B. tequilensis, B. methylotrophicus, or any combination thereof. In some embodiments, said one or more microorganisms comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof. In some embodiments, said one or more microorganisms comprise Bacillus subtilis S3C23. In some embodiments, said one or more microorganisms comprise Bacillus subtilis MP2.

In some embodiments, said one or more microorganisms comprise a genetic modification which causes said one or more microorganisms to produce or promote the formation of more carbonic anhydrase relative to corresponding wild type microorganisms. In some embodiments, genetic modification comprises a nucleic acid construct, wherein said nucleic acid construct comprises one or more promoters configured to drive expression of a carbonic anhydrase (CA) coding sequence. In some embodiments, said genetic modification comprises a nucleic acid construct, wherein said nucleic acid construct comprises a carbonic anhydrase (CA) coding sequence. In some embodiments, said CA coding sequence is heterologous to said one or more microorganisms. In some embodiments, said CA coding sequence is endogenous to said one or more microorganisms. In some embodiments, the nucleic acid construct is codon optimized. In some embodiments, said nucleic acid construct further comprises one or more promoters configured to drive expression of said CA coding sequence. In some embodiments, said one or more promoters drive constitutive expression of said CA coding sequence. In some embodiments, said one or more promoters drive inducible expression of said CA coding sequence. In some embodiments, said genetic modification comprises a carbonic anhydrase gene which has been modified by direct microbial evolution. In some embodiments, said genetic modification comprises a signal sequence. In some embodiments, said signal sequence comprises a periplasmic signal sequence or an extracellular secretion signal. In some embodiments, said periplasmic signal sequence or said extracellular secretion signal is disposed to a 5′ end of a carbonic anhydrase coding sequence. In some embodiments, said periplasmic signal sequence or said extracellular secretion signal is fused to a 5′ end of a carbonic anhydrase coding sequence. In some embodiments, said genetic modification comprises one or more components of the general secretion pathway, and wherein said genetic modification results in secretion or subcellular targeting of carbonic anhydrase by said one or more microorganisms.

In some embodiments, said one or more promoters are or are derived from one or more promoters comprised in Bacillus sp. or Paenibacillus sp. In some embodiments, said one or more promoters is selected from P_{groES}, P₄₃, P_{sigX}, P_{trnQ}, and P_{xylA}. In some embodiments, said one or more promoters are or are derived from one or more housekeeping gene promoters or strongly expressed constitutive promoters. In some embodiments, said one or more housekeeping gene promoters or strongly expressed constitutive promoters is selected from P_{liaG}, P_{lepA}, P_{veg}, P_{gstB}, P43, P_{trnQ}, Pₗᵢₐₗ (bacitracin inducible), and P_{xylA} (xylose inducible).

In some embodiments, said genetic modification comprises an introduction of an expression vector to the one or microorganisms. In some embodiments, said genetic modification comprises a modification to a chromosome of the one or microorganisms.

In some embodiments, the microorganisms may fix both nitrogen and carbon dioxide. In some embodiments, the nitrogen fixing microorganisms will continue to provide fixed nitrogen (ammonia) via biological nitrogen fixation to plants and this would reduce the use of chemical fertilizers that are polluting the environment. The end product (ammonia) of atmospheric nitrogen fixation may enhance the process of CO₂ to minerals because ammonia has been reported to increase the pH that accelerated mineralization. Because the ammonia production from the microorganisms disclosed herein is significantly higher than other soil inhabiting microorganisms even in the presence of external nitrogen source, the mineralization process may be quicker by the strains disclosed herein than the other microorganisms inhabiting in soil.

In some embodiments, the microorganism is a microbe selected from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Pelospora sp., Pelotomaculum sp., Piscibacillus sp., Planfilum sp., Pontibacillus sp., Propionispora sp., Salinibacillus sp., Salsuginibacillus sp., Seinonella sp., Shimazuella sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp. and Vulcanobacillus sp. In some embodiments, the microorganism is a microbe selected from Acetobacter sp., Actinomyces sp., Bacillus sp., Chryseobacterium sp., Coxiella sp., Ensifer sp., Glutamicibacter sp., Microbacterium sp., or Serratia sp. In some embodiments, the microorganism is an Acetobacter sp. In some embodiments, the microorganism is an Actinomyces sp. In some embodiments, the microorganism is a Bacillus sp. In some embodiments, the microorganism is a Chryseobacterium sp. In some embodiments, the microorganism is a Coxiella sp. In some embodiments, the microorganism is an Ensifer sp. In some embodiments, the microorganism is a Glutamicibacter sp. In some embodiments, the microorganism is a Microbacterium sp. In some embodiments, the microorganism is a Pantoea sp. In some embodiments, the microorganism is a Serratia sp. In some embodiments, the microorganism is an endospore of any of the microorganisms.

In some embodiments, a microorganism is selected for one or more properties associated with the microorganism's ability to interact with the plant. In some embodiments, the microorganism is selected for compatibility. In some embodiments, the microorganism is selected to ensure no predatory or antagonistic effects will develop. In some embodiments, the microorganism is selected for stability during storage. In some embodiments, the microorganism is selected for rapid plant colonization and survival within associated tissues. In some embodiments, the microorganism is selected for optimal incorporation into the one or more plants. In some embodiments, the microorganism remains present throughout the plant life cycle.

In some embodiments, a microorganism incorporated into a plant is stable after incorporation. In some embodiments, the microorganism is stable for greater than 30 days, for greater than six months, greater than one year, or greater than two years. In some embodiments, the microorganism is stable for greater than 30 days. In some embodiments, the microorganism is stable for greater than six months. In some embodiments, the microorganism is stable for greater than one year. In some embodiments, the microorganism is stable for greater than two years.

### Methods of Producing Bicarbonate and Minerals

In certain aspects, disclosed herein is a method of promoting bicarbonate formation and mineralization, the method comprising: (a) cultivating a plant and one or more microorganisms associated with said plant, the plant root, and/or the root rhizosphere wherein said one or more microorganisms are, or are derived from, microorganisms selected to produce or promote the formation of bicarbonate and one or more minerals.

### Modified Plants

In some embodiments, said one or more microorganisms associated with said plant are disposed on a root or rhizosphere of said plant. In some embodiments, said one or more microorganisms associated with said plant are disposed on said root or said rhizosphere of said plant by irrigation.

In some embodiments, said plant is derived from a seedling, which is irrigated with the microorganisms disclosed herein selected to stimulate production of said one or more minerals disclosed herein by said plant. In some embodiments, said plant is derived from cultivating a plant seed and one or more microorganisms associated with said plant seed as described herein. In some embodiments, the seed is primed by the methods described herein.

In one aspect, provided herein, is a method comprising cultivating a plant comprising a microorganism or an exudate of a microorganism incorporated into the plant. In some preferred embodiments, the microorganism is an endospore forming bacteria or endospore thereof.

In some embodiments, the amount of minerals produced can be between 50 kg/acre up to 1000 kg/acre. In some embodiments, the amount of minerals produced can be between about 50 kg/acre to about 1,000 kg/acre. In some embodiments, the amount of minerals produced can be between about 50 kg/acre to about 100 kg/acre, about 50 kg/acre to about 200 kg/acre, about 50 kg/acre to about 300 kg/acre, about 50 kg/acre to about 400 kg/acre, about 50 kg/acre to about 500 kg/acre, about 50 kg/acre to about 600 kg/acre, about 50 kg/acre to about 700 kg/acre, about 50 kg/acre to about 800 kg/acre, about 50 kg/acre to about 900 kg/acre, about 50 kg/acre to about 1,000 kg/acre, about 100 kg/acre to about 200 kg/acre, about 100 kg/acre to about 300 kg/acre, about 100 kg/acre to about 400 kg/acre, about 100 kg/acre to about 500 kg/acre, about 100 kg/acre to about 600 kg/acre, about 100 kg/acre to about 700 kg/acre, about 100 kg/acre to about 800 kg/acre, about 100 kg/acre to about 900 kg/acre, about 100 kg/acre to about 1,000 kg/acre, about 200 kg/acre to about 300 kg/acre, about 200 kg/acre to about 400 kg/acre, about 200 kg/acre to about 500 kg/acre, about 200 kg/acre to about 600 kg/acre, about 200 kg/acre to about 700 kg/acre, about 200 kg/acre to about 800 kg/acre, about 200 kg/acre to about 900 kg/acre, about 200 kg/acre to about 1,000 kg/acre, about 300 kg/acre to about 400 kg/acre, about 300 kg/acre to about 500 kg/acre, about 300 kg/acre to about 600 kg/acre, about 300 kg/acre to about 700 kg/acre, about 300 kg/acre to about 800 kg/acre, about 300 kg/acre to about 900 kg/acre, about 300 kg/acre to about 1,000 kg/acre, about 400 kg/acre to about 500 kg/acre, about 400 kg/acre to about 600 kg/acre, about 400 kg/acre to about 700 kg/acre, about 400 kg/acre to about 800 kg/acre, about 400 kg/acre to about 900 kg/acre, about 400 kg/acre to about 1,000 kg/acre, about 500 kg/acre to about 600 kg/acre, about 500 kg/acre to about 700 kg/acre, about 500 kg/acre to about 800 kg/acre, about 500 kg/acre to about 900 kg/acre, about 500 kg/acre to about 1,000 kg/acre, about 600 kg/acre to about 700 kg/acre, about 600 kg/acre to about 800 kg/acre, about 600 kg/acre to about 900 kg/acre, about 600 kg/acre to about 1,000 kg/acre, about 700 kg/acre to about 800 kg/acre, about 700 kg/acre to about 900 kg/acre, about 700 kg/acre to about 1,000 kg/acre, about 800 kg/acre to about 900 kg/acre, about 800 kg/acre to about 1,000 kg/acre, or about 900 kg/acre to about 1,000 kg/acre. In some embodiments, the amount of minerals produced can be between about 50 kg/acre, about 100 kg/acre, about 200 kg/acre, about 300 kg/acre, about 400 kg/acre, about 500 kg/acre, about 600 kg/acre, about 700 kg/acre, about 800 kg/acre, about 900 kg/acre, or about 1,000 kg/acre. In some embodiments, the amount of minerals produced can be between at least about 50 kg/acre, about 100 kg/acre, about 200 kg/acre, about 300 kg/acre, about 400 kg/acre, about 500 kg/acre, about 600 kg/acre, about 700 kg/acre, about 800 kg/acre, or about 900 kg/acre. In some embodiments, the amount of minerals produced can be between at most about 100 kg/acre, about 200 kg/acre, about 300 kg/acre, about 400 kg/acre, about 500 kg/acre, about 600 kg/acre, about 700 kg/acre, about 800 kg/acre, about 900 kg/acre, or about 1,000 kg/acre.

In some embodiments, the microorganism or exudate is incorporated into the interior of the plant. In some embodiments, the microorganism or exudate is incorporated into the plant beneath the pericarp. In some embodiments, the microorganism or exudate is incorporated into the plant between the pericarp and the aleurone cell layer. In some embodiments, the microorganism or exudate contacts the embryo of the plant. In some embodiments, the microorganism or exudate does not contact the embryo of the plant. In some embodiments, the microorganism or exudate contacts the endosperm of the plant. In some embodiments, the microorganism or exudate does not contact the endosperm of the plant. In some embodiments, the microorganism or exudate is incorporated into the plant in an interspace between a plant coat and a plant embryo. In some embodiments, the microorganism or exudate is incorporated into an interspace between a plant pericarp and a plant aleurone cell layer.

The modified plant may be any type of plant. In some embodiments, the modified plant is a monocot plant. In some embodiments, the plant is a maize, a wheat, a rice, a barley, a rye, a sugar cane, a millet, an oat, or a sorghum plant. In some embodiments, the plant is a maize plant. In some embodiments, the plant is a Zea maize plant. In some embodiments, the modified plant is a dicot plant. In some embodiments, the plant is a soybean, cotton, alfalfa, bean, quinoa, lentil, peanut, sunflower, canola, cassava, oil palm, potato, sugar beet, cacao, coffea, lettuce, tomato, or cabbage plant. In some embodiments, the plant is a lettuce plant. In some embodiments, the plant is a Lactuca sativa plant. In some embodiments, the plant is a tomato plant. In some embodiments, the plant is a Solanum lycopersicum plant. In some embodiments, the plant is a genetically modified organism (GMO) plant. In some embodiments, the plant is a non-GMO plant. In some embodiments, said plant is monocot plant or dicot plant. In some embodiments, said plant is maize, wheat, rice, sorghum, barley, rye, sugar cane, millet, oat, soybean, cotton, alfalfa, bean, quinoa, lentil, peanut, sunflower, canola, cassava, oil palm, potato, sugar beet, cacao, coffea, lettuce, tomato, pea, or cabbage.

An amount of microorganism or exudate incorporated into the plant must be of a sufficient level in order for effectively sequester CO₂. In some embodiments, the amount of microorganism incorporated into the plant is about 250 colony forming units (CFU) to about 5,000 CFU. In some embodiments, the amount of microorganism incorporated into the plant is about 250 CFU to about 500 CFU, about 250 CFU to about 750 CFU, about 250 CFU to about 1,000 CFU, about 250 CFU to about 2,000 CFU, about 250 CFU to about 3,000 CFU, about 250 CFU to about 4,000 CFU, about 250 CFU to about 5,000 CFU, about 500 CFU to about 750 CFU, about 500 CFU to about 1,000 CFU, about 500 CFU to about 2,000 CFU, about 500 CFU to about 3,000 CFU, about 500 CFU to about 4,000 CFU, about 500 CFU to about 5,000 CFU, about 750 CFU to about 1,000 CFU, about 750 CFU to about 2,000 CFU, about 750 CFU to about 3,000 CFU, about 750 CFU to about 4,000 CFU, about 750 CFU to about 5,000 CFU, about 1,000 CFU to about 2,000 CFU, about 1,000 CFU to about 3,000 CFU, about 1,000 CFU to about 4,000 CFU, about 1,000 CFU to about 5,000 CFU, about 2,000 CFU to about 3,000 CFU, about 2,000 CFU to about 4,000 CFU, about 2,000 CFU to about 5,000 CFU, about 3,000 CFU to about 4,000 CFU, about 3,000 CFU to about 5,000 CFU, or about 4,000 CFU to about 5,000 CFU. In some embodiments, the amount of microorganism incorporated into the plant is about 250 CFU, about 500 CFU, about 750 CFU, about 1,000 CFU, about 2,000 CFU, about 3,000 CFU, about 4,000 CFU, or about 5,000 CFU. In some embodiments, the amount of microorganism incorporated into the plant is at least about 250 CFU, about 500 CFU, about 750 CFU, about 1,000 CFU, about 2,000 CFU, about 3,000 CFU, or about 4,000 CFU. In some embodiments, the amount of microorganism incorporated into the plant is at most about 500 CFU, about 750 CFU, about 1,000 CFU, about 2,000 CFU, about 3,000 CFU, about 4,000 CFU, or about 5,000 CFU. In some embodiments, at least about 500 CFU are incorporated into the plant. In some embodiments, at least about 1000 CFU are incorporated into the plant.

In some embodiments, the microorganism or exudate incorporated into the plant is shelf stable for an extended period of time. In some embodiments, the modified plant is shelf stable for about 3 months to about 36 months. In some embodiments, the modified plant is shelf stable for about 3 months to about 6 months, about 3 months to about 9 months, about 3 months to about 12 months, about 3 months to about 15 months, about 3 months to about 18 months, about 3 months to about 21 months, about 3 months to about 24 months, about 3 months to about 30 months, about 3 months to about 36 months, about 6 months to about 9 months, about 6 months to about 12 months, about 6 months to about 15 months, about 6 months to about 18 months, about 6 months to about 21 months, about 6 months to about 24 months, about 6 months to about 30 months, about 6 months to about 36 months, about 9 months to about 12 months, about 9 months to about 15 months, about 9 months to about 18 months, about 9 months to about 21 months, about 9 months to about 24 months, about 9 months to about 30 months, about 9 months to about 36 months, about 12 months to about 15 months, about 12 months to about 18 months, about 12 months to about 21 months, about 12 months to about 24 months, about 12 months to about 30 months, about 12 months to about 36 months, about 15 months to about 18 months, about 15 months to about 21 months, about 15 months to about 24 months, about 15 months to about 30 months, about 15 months to about 36 months, about 18 months to about 21 months, about 18 months to about 24 months, about 18 months to about 30 months, about 18 months to about 36 months, about 21 months to about 24 months, about 21 months to about 30 months, about 21 months to about 36 months, about 24 months to about 30 months, about 24 months to about 36 months, or about 30 months to about 36 months. In some embodiments, the modified plant is shelf stable for about 3 months, about 6 months, about 9 months, about 12 months, about 15 months, about 18 months, about 21 months, about 24 months, about 30 months, or about 36 months. In some embodiments, the modified plant is shelf stable for at least about 3 months, about 6 months, about 9 months, about 12 months, about 15 months, about 18 months, about 21 months, about 24 months, or about 30 months. In some embodiments, the modified plant is shelf stable for at most about 6 months, about 9 months, about 12 months, about 15 months, about 18 months, about 21 months, about 24 months, about 30 months, or about 36 months.

In some embodiments, a microorganism incorporated into a plant is stable after incorporation. In some embodiments, the microorganism is stable for greater than 30 days, for greater than six months, greater than one year, or greater than two years. In some embodiments, the microorganism is stable for greater than 30 days. In some embodiments, the microorganism is stable for greater than six months. In some embodiments, the microorganism is stable for greater than one year. In some embodiments, the microorganism is stable for greater than two years.

The microorganism or exudate thereof incorporated into plants may be any of the microorganisms provided herein, or any other microorganism. In some embodiments, the microorganism is a microbe. In some embodiments, the microorganism is an endospore forming microbe. In some embodiments, the microorganism is an endospore forming microbe or an endospore thereof. In some embodiments, the microorganism is an endospore of a microorganism provided herein. In some embodiments, the microorganism is an endospore forming bacteria or an endospore thereof.

### Microorganisms and Exudates

The microorganisms or exudates thereof provided herein are capable of produce or promote the formation of bicarbonate and one or more minerals. In some embodiments, the formation of bicarbonate sequesters CO₂. In some embodiments, the formation of bicarbonate leads to minerals formation. In some embodiments, the formed minerals stably sequester carbon in the soil. In some embodiments, the microorganism is an endospore forming bacteria. In some embodiments, the microorganism is an endospore of a bacteria. Whenever a microorganism (e.g. a bacterium) referenced herein is capable of forming an endospore, it is intended that any endospore of the microorganism is also encompassed. For example, if a plant treatment formulation comprises a Bacillus sp., the formulation may comprise endospores of the Bacillus sp.

In some embodiments, the microorganism is a microbe from the phyla of Firmicutes, Proteobacteria, and Actinobacteria. In some embodiments, the microorganism is a microbe from the phylum Firmicutes. In some embodiments, the microorganism is a microbe from the phylum Proteobacteria. In some embodiments, the microorganism is a microbe from the phylum Actinobacteria. In some embodiments, the microorganism is an endospore of any of the microorganisms.

Rhizobacteria that fix atmospheric nitrogen are found on the roots of plants. These organisms are able to survive in soil and have tolerance to a great amount of CO₂ that is either being released by the roots of plants during respiration or CO₂ evolution by nearby microbial and soil fauna community through respiration.

In some embodiments, the bacterium is not genetically modified. In some embodiments, the bacterium is selected for its ability to convert CO₂ to bicarbonate and ultimately minerals. In some embodiments, the bacterium is selected for its use of carbonic anhydrase. In some embodiments, the bacterium is selected for its use of carbonic anhydrase. In some embodiments, a variety of rhizobacteria effectively loaded into the seeds. In some embodiments, said rhizobacteria comprise Bacillus sp, Paenibacillus sp, or both. In some embodiments, said one or more microorganisms comprise B. amyloliquefaciens, B. laterosporus, B. licheniformis, B. macerans, B. cereus, B. circulans, B. firmus, B. subtilis, B. sphaericus, B. megaterium, B. coagulans, B. brevis, B. thuringiensis, B. mycoides, B. cucumis, B. endophyticus, B. pumilus, B. velezensis, B. mucilaginosus, B. tequilensis, B. methylotrophicus, or any combination thereof. In some embodiments, said one or more microorganisms comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof. In some embodiments, said one or more microorganisms comprise Bacillus subtilis S3C23. In some embodiments, said one or more microorganisms comprise Bacillus subtilis MP2.

In some embodiments, said one or more microorganisms comprise a genetic modification which causes said one or more microorganisms to produce or promote the formation of more carbonic anhydrase relative to corresponding wild type microorganisms. In some embodiments, genetic modification comprises a nucleic acid construct, wherein said nucleic acid construct comprises one or more promoters configured to drive expression of a carbonic anhydrase (CA) coding sequence. In some embodiments, said genetic modification comprises a nucleic acid construct, wherein said nucleic acid construct comprises a carbonic anhydrase (CA) coding sequence. In some embodiments, said CA coding sequence is heterologous to said one or more microorganisms. In some embodiments, said CA coding sequence is endogenous to said one or more microorganisms. In some embodiments, the nucleic acid construct is codon optimized. In some embodiments, said nucleic acid construct further comprises one or more promoters configured to drive expression of said CA coding sequence. In some embodiments, said one or more promoters drive constitutive expression of said CA coding sequence. In some embodiments, said one or more promoters drive inducible expression of said CA coding sequence. In some embodiments, said genetic modification comprises a carbonic anhydrase gene which has been modified by direct microbial evolution. In some embodiments, said genetic modification comprises a signal sequence. In some embodiments, said signal sequence comprises a periplasmic signal sequence or an extracellular secretion signal. In some embodiments, said periplasmic signal sequence or said extracellular secretion signal is disposed to a 5′ end of a carbonic anhydrase coding sequence. In some embodiments, said periplasmic signal sequence or said extracellular secretion signal is fused to a 5′ end of a carbonic anhydrase coding sequence. In some embodiments, said genetic modification comprises one or more components of the general secretion pathway, and wherein said genetic modification results in secretion or subcellular targeting of carbonic anhydrase by said one or more microorganisms.

In some embodiments, said one or more promoters are or are derived from one or more promoters comprised in Bacillus sp. or Paenibacillus sp. In some embodiments, said one or more promoters is selected from P_{groES}, P43, P_{sigX}, P_{trnQ}, and P_{xylA}. In some embodiments, said one or more promoters are or are derived from one or more housekeeping gene promoters or strongly expressed constitutive promoters. In some embodiments, said one or more housekeeping gene promoters or strongly expressed constitutive promoters is selected from P_{liaG}, P_{lepA}, P_{veg}, P_{gstB}, P43, P_{trnQ}, Pₗᵢₐₗ (bacitracin inducible), and P_{xylA} (xylose inducible).

In some embodiments, said genetic modification comprises an introduction of an expression vector to the one or microorganisms. In some embodiments, said genetic modification comprises a modification to a chromosome of the one or microorganisms.

In some embodiments, the microorganisms may fix both nitrogen and carbon dioxide. In some embodiments, the nitrogen fixing microorganisms will continue to provide fixed nitrogen (ammonia) via biological nitrogen fixation to plants and this would reduce the use of chemical fertilizers that are polluting the environment. The end product (ammonia) of atmospheric nitrogen fixation may enhance the process of CO₂ to minerals because ammonia has been reported to increase the pH that accelerated mineralization. Because the ammonia production from the microorganisms disclosed herein is significantly higher than other soil inhabiting microorganisms even in the presence of external nitrogen source, the mineralization process may be quicker by the strains disclosed herein than the other microorganisms inhabiting in soil.

### Methods of Sequestering or Converting Carbon to Bicarbonate and Minerals

In certain aspects, disclosed herein is a method of sequestering carbon, the method comprising: a. cultivating a plant and one or more microorganisms associated with said plant, wherein said one or more microorganisms are, or are derived from, microorganisms selected to produce or promote the formation of bicarbonate and one or more minerals.

### Modified Plants

In one aspect, provided herein, is a method of sequestering carbon comprising cultivating a modified plant comprising a microorganism or an exudate of a microorganism incorporated into the plant. In some embodiments, the microorganism or exudate produce or promote the formation of bicarbonate and one or more minerals. In some embodiments, the formation of bicarbonate sequesters CO₂. In some embodiments, the formation of bicarbonate leads to minerals formation. In some embodiments, the formed minerals stably sequester carbon in the soil. In some preferred embodiments, the microorganism is an endospore forming bacteria or endospore thereof.

In some embodiments, amount of CO₂ converted by the microorganisms is between 0.1 tons of CO₂ per acre up to 2.5 tons of CO₂/acre. In some embodiments, the microorganisms convert 2.5 to 5.3 tons of CO₂/acre. In some embodiments, the microorganisms convert 5.3 to 7.5 tons of CO₂/acre. In some embodiments, the microorganisms convert 7.5 to 10 tons of CO₂/acre. In some embodiments, the microorganisms convert 10 to 15 tons of CO₂/acre. In some embodiments, the microorganisms convert 15 to 20 tons/acre. In some embodiments, amount of CO₂ converted by the microorganisms is between about 2 tons/acre to about 20 tons/acre. In some embodiments, amount of CO₂ converted by the microorganisms is between about 2 tons/acre to about 4 tons/acre, about 2 tons/acre to about 6 tons/acre, about 2 tons/acre to about 8 tons/acre, about 2 tons/acre to about 10 tons/acre, about 2 tons/acre to about 12 tons/acre, about 2 tons/acre to about 14 tons/acre, about 2 tons/acre to about 16 tons/acre, about 2 tons/acre to about 18 tons/acre, about 2 tons/acre to about 20 tons/acre, about 4 tons/acre to about 6 tons/acre, about 4 tons/acre to about 8 tons/acre, about 4 tons/acre to about 10 tons/acre, about 4 tons/acre to about 12 tons/acre, about 4 tons/acre to about 14 tons/acre, about 4 tons/acre to about 16 tons/acre, about 4 tons/acre to about 18 tons/acre, about 4 tons/acre to about 20 tons/acre, about 6 tons/acre to about 8 tons/acre, about 6 tons/acre to about 10 tons/acre, about 6 tons/acre to about 12 tons/acre, about 6 tons/acre to about 14 tons/acre, about 6 tons/acre to about 16 tons/acre, about 6 tons/acre to about 18 tons/acre, about 6 tons/acre to about 20 tons/acre, about 8 tons/acre to about 10 tons/acre, about 8 tons/acre to about 12 tons/acre, about 8 tons/acre to about 14 tons/acre, about 8 tons/acre to about 16 tons/acre, about 8 tons/acre to about 18 tons/acre, about 8 tons/acre to about 20 tons/acre, about 10 tons/acre to about 12 tons/acre, about 10 tons/acre to about 14 tons/acre, about 10 tons/acre to about 16 tons/acre, about 10 tons/acre to about 18 tons/acre, about 10 tons/acre to about 20 tons/acre, about 12 tons/acre to about 14 tons/acre, about 12 tons/acre to about 16 tons/acre, about 12 tons/acre to about 18 tons/acre, about 12 tons/acre to about 20 tons/acre, about 14 tons/acre to about 16 tons/acre, about 14 tons/acre to about 18 tons/acre, about 14 tons/acre to about 20 tons/acre, about 16 tons/acre to about 18 tons/acre, about 16 tons/acre to about 20 tons/acre, or about 18 tons/acre to about 20 tons/acre. In some embodiments, amount of CO₂ converted by the microbes is between about 2 tons/acre, about 4 tons/acre, about 6 tons/acre, about 8 tons/acre, about 10 tons/acre, about 12 tons/acre, about 14 tons/acre, about 16 tons/acre, about 18 tons/acre, or about 20 tons/acre. In some embodiments, amount of CO₂ converted by the microorganisms is between at least about 2 tons/acre, about 4 tons/acre, about 6 tons/acre, about 8 tons/acre, about 10 tons/acre, about 12 tons/acre, about 14 tons/acre, about 16 tons/acre, or about 18 tons/acre. In some embodiments, amount of CO₂ converted by the microorganisms is between at most about 4 tons/acre, about 6 tons/acre, about 8 tons/acre, about 10 tons/acre, about 12 tons/acre, about 14 tons/acre, about 16 tons/acre, about 18 tons/acre, or about 20 tons/acre.

In some embodiments, the microorganism or exudate is incorporated into the interior of the plant. In some embodiments, the microorganism or exudate is incorporated into the plant beneath the pericarp. In some embodiments, the microorganism or exudate is incorporated into the plant between the pericarp and the aleurone cell layer. In some embodiments, the microorganism or exudate contacts the embryo of the plant. In some embodiments, the microorganism or exudate does not contact the embryo of the plant. In some embodiments, the microorganism or exudate contacts the endosperm of the plant. In some embodiments, the microorganism or exudate does not contact the endosperm of the plant. In some embodiments, the microorganism or exudate is incorporated into the plant in an interspace between a plant coat and a plant embryo. In some embodiments, the microorganism or exudate is incorporated into an interspace between a plant pericarp and a plant aleurone cell layer.

The modified plant may be any type of plant. In some embodiments, the modified plant is a monocot plant. In some embodiments, the plant is a maize, a wheat, a rice, a barley, a rye, a sugar cane, a millet, an oat, or a sorghum plant. In some embodiments, the plant is a maize plant. In some embodiments, the plant is a Zea maize plant. In some embodiments, the modified plant is a dicot plant. In some embodiments, the plant is a soybean, cotton, alfalfa, bean, quinoa, lentil, peanut, sunflower, canola, cassava, oil palm, potato, sugar beet, cacao, coffea, lettuce, tomato, or cabbage plant. In some embodiments, the plant is a lettuce plant. In some embodiments, the plant is a Lactuca sativa plant. In some embodiments, the plant is a tomato plant. In some embodiments, the plant is a Solanum lycopersicum plant. In some embodiments, the plant is a genetically modified organism (GMO) plant. In some embodiments, the plant is a non-GMO plant.

An amount of microorganism or exudate incorporated into the plant must be of a sufficient level in order for effectively sequester CO₂. In some embodiments, the amount of microorganism incorporated into the plant is about 250 colony forming units (CFU) to about 5,000 CFU. In some embodiments, the amount of microorganism incorporated into the plant is about 250 CFU to about 500 CFU, about 250 CFU to about 750 CFU, about 250 CFU to about 1,000 CFU, about 250 CFU to about 2,000 CFU, about 250 CFU to about 3,000 CFU, about 250 CFU to about 4,000 CFU, about 250 CFU to about 5,000 CFU, about 500 CFU to about 750 CFU, about 500 CFU to about 1,000 CFU, about 500 CFU to about 2,000 CFU, about 500 CFU to about 3,000 CFU, about 500 CFU to about 4,000 CFU, about 500 CFU to about 5,000 CFU, about 750 CFU to about 1,000 CFU, about 750 CFU to about 2,000 CFU, about 750 CFU to about 3,000 CFU, about 750 CFU to about 4,000 CFU, about 750 CFU to about 5,000 CFU, about 1,000 CFU to about 2,000 CFU, about 1,000 CFU to about 3,000 CFU, about 1,000 CFU to about 4,000 CFU, about 1,000 CFU to about 5,000 CFU, about 2,000 CFU to about 3,000 CFU, about 2,000 CFU to about 4,000 CFU, about 2,000 CFU to about 5,000 CFU, about 3,000 CFU to about 4,000 CFU, about 3,000 CFU to about 5,000 CFU, or about 4,000 CFU to about 5,000 CFU. In some embodiments, the amount of microorganism incorporated into the plant is about 250 CFU, about 500 CFU, about 750 CFU, about 1,000 CFU, about 2,000 CFU, about 3,000 CFU, about 4,000 CFU, or about 5,000 CFU. In some embodiments, the amount of microorganism incorporated into the plant is at least about 250 CFU, about 500 CFU, about 750 CFU, about 1,000 CFU, about 2,000 CFU, about 3,000 CFU, or about 4,000 CFU. In some embodiments, the amount of microorganism incorporated into the plant is at most about 500 CFU, about 750 CFU, about 1,000 CFU, about 2,000 CFU, about 3,000 CFU, about 4,000 CFU, or about 5,000 CFU. In some embodiments, at least about 500 CFU are incorporated into the plant. In some embodiments, at least about 1000 CFU are incorporated into the plant.

In some embodiments, the microorganism or exudate incorporated into the plant is shelf stable for an extended period of time. In some embodiments, the modified plant is shelf stable for about 3 months to about 36 months. In some embodiments, the modified plant is shelf stable for about 3 months to about 6 months, about 3 months to about 9 months, about 3 months to about 12 months, about 3 months to about 15 months, about 3 months to about 18 months, about 3 months to about 21 months, about 3 months to about 24 months, about 3 months to about 30 months, about 3 months to about 36 months, about 6 months to about 9 months, about 6 months to about 12 months, about 6 months to about 15 months, about 6 months to about 18 months, about 6 months to about 21 months, about 6 months to about 24 months, about 6 months to about 30 months, about 6 months to about 36 months, about 9 months to about 12 months, about 9 months to about 15 months, about 9 months to about 18 months, about 9 months to about 21 months, about 9 months to about 24 months, about 9 months to about 30 months, about 9 months to about 36 months, about 12 months to about 15 months, about 12 months to about 18 months, about 12 months to about 21 months, about 12 months to about 24 months, about 12 months to about 30 months, about 12 months to about 36 months, about 15 months to about 18 months, about 15 months to about 21 months, about 15 months to about 24 months, about 15 months to about 30 months, about 15 months to about 36 months, about 18 months to about 21 months, about 18 months to about 24 months, about 18 months to about 30 months, about 18 months to about 36 months, about 21 months to about 24 months, about 21 months to about 30 months, about 21 months to about 36 months, about 24 months to about 30 months, about 24 months to about 36 months, or about 30 months to about 36 months. In some embodiments, the modified plant is shelf stable for about 3 months, about 6 months, about 9 months, about 12 months, about 15 months, about 18 months, about 21 months, about 24 months, about 30 months, or about 36 months. In some embodiments, the modified plant is shelf stable for at least about 3 months, about 6 months, about 9 months, about 12 months, about 15 months, about 18 months, about 21 months, about 24 months, or about 30 months. In some embodiments, the modified plant is shelf stable for at most about 6 months, about 9 months, about 12 months, about 15 months, about 18 months, about 21 months, about 24 months, about 30 months, or about 36 months.

In some embodiments, a microorganism incorporated into a plant is stable after incorporation. In some embodiments, the microorganism is stable for greater than 30 days, for greater than six months, greater than one year, or greater than two years. In some embodiments, the microorganism is stable for greater than 30 days. In some embodiments, the microorganism is stable for greater than six months. In some embodiments, the microorganism is stable for greater than one year. In some embodiments, the microorganism is stable for greater than two years

The microorganism or exudate thereof incorporated into plants may be any of the microorganisms provided herein, or any other microorganism. In some embodiments, the microorganism is a microbe. In some embodiments, the microorganism is an endospore forming microbe. In some embodiments, the microorganism is an endospore forming microbe or an endospore thereof. In some embodiments, the microorganism is an endospore of a microorganism provided herein. In some embodiments, the microorganism is an endospore forming bacteria or an endospore thereof.

### Methods of Incorporating Bacteria

In one aspect, provided herein, is a method of incorporating one or more microorganisms or exudates thereof into one or more plants. In some embodiments, the method comprises disinfecting the plants. In some embodiments, the method comprises contacting the plants with a solution comprising the one or more microorganisms or the exudate thereof. In some embodiments, the solution further comprises a salt. In some embodiments, the method comprises incubating the plants with the solution for a period of time. In some embodiments, the period of time is sufficient to allow a desired amount of microorganisms or exudates thereof into the plants. In some embodiments, the method incorporates a desired amount of microorganisms or exudate thereof into the plants.

In some embodiments, the method comprises contacting the plants with a solution comprising a salt as described herein

In some embodiments, the solution comprises an additional additive as described herein.

In some embodiments, the solution comprises an additional metal ion as described herein.

In some embodiments, the solution comprises one or more nutrients for the microorganisms as described herein. In some embodiments, the solution comprises a bacterial growth media. In some embodiments, the solution comprises lysogeny broth (LB), nutrient broth, or a combination thereof. In some embodiments, the solution comprises lysogeny broth. In some embodiments, the solution comprises nutrient broth.

In some embodiments, the solution comprises a microorganism as described herein.

In some embodiments, the solution comprises a desired amount of microorganism per plant mass as described herein.

In some embodiments, the plants comprise a desired amount of microorganism per plant as described herein. In some embodiments, the microorganism is a bacterium. In some embodiments, the bacterium is an endospore forming bacteria. In some embodiments, the method comprises inducing endosporulation of the endospore forming bacteria. In some embodiments, the bacteria incorporated into the plant is an endospore. In some embodiments, the solution comprises one or more ingredients to induce endosporulation. In some embodiments, the solution comprises potassium, ferrous sulfate, calcium, magnesium, manganese, or a combination thereof.

In some embodiments, the method comprises sterilizing the plants. In some embodiments, the method comprises sterilizing the surface of the plants. Any method of producing a plant with a sterilized surface may be employed. In some embodiments, the plant is sterilized with a bleach solution. In some embodiments, the plants are sterilized prior to immersing the plants in the solution containing the one or more microorganisms. In some embodiments, the plant is a sterilized plant. In some embodiments, the plant has a sterilized surface. As used herein, “sterilizing,” “sterilized” and related terms (e.g. “disinfecting” and the like) indicates that there are substantially no microorganisms alive on the sterilized item. In some embodiments, the plant is sterilized prior to incubating the plant in the solution comprising the microorganism. In some embodiments, the plant is sterilized after incubating the plant in the solution comprising the microorganism. In some embodiments, a fungicide is added to the surface of the plant.

In some embodiments, the sterilized or disinfected plants comprise substantially no living microorganisms on the plant (e.g. the surface of the plant). In some embodiments, the sterile or sterilized plant comprises less than 1 CFU, less than 5 CFU, less than 10 CFU, less than 20 CFU, less than 30 CFU, less than 40 CFU, or less than 50 CFU of microorganisms on the plant.

In some embodiments, the plants are incubated with the solution containing the microorganism for a time sufficient to incorporate the microorganism into the plant.

### Microorganisms and Exudates

The microorganisms or exudates thereof provided herein produce or promote the formation of bicarbonate and one or more minerals. In some embodiments, the formation of bicarbonate sequesters CO₂. In some embodiments, the formation of bicarbonate leads to minerals formation. In some embodiments, the formed minerals stably sequester carbon in the soil. In some embodiments, the microorganism is a bacterium as described herein. In some embodiments, the microorganism is an endospore forming bacteria. In some embodiments, the microorganism is an endospore of a bacteria. Whenever a microorganism (e.g. a bacterium) referenced herein is capable of forming an endospore, it is intended that any endospore of the microorganism is also encompassed. For example, if a plant treatment formulation comprises a Bacillus sp., the formulation may comprise endospores of the Bacillus sp.

In some embodiments, the microorganism is a microbe from the phyla of Firmicutes, Proteobacteria, and Actinobacteria. In some embodiments, the microorganism is a microbe from the phylum Firmicutes. In some embodiments, the microorganism is a microbe from the phylum Proteobacteria. In some embodiments, the microorganism is a microbe from the phylum Actinobacteria. In some embodiments, the microorganism is an endospore of any of the microorganisms.

Rhizobacteria that fix atmospheric nitrogen are found on the roots of plants. These microorganisms are able to survive in soil and have tolerance to a great amount of CO₂ that is either being released by the roots of plants during respiration or CO₂ evolution by nearby microbial and soil fauna community through respiration.

In some embodiments, the bacterium is not genetically modified. In some embodiments, the bacterium is selected for its ability to convert CO₂ to bicarbonate and ultimately minerals. In some embodiments, the bacterium is selected for its use of carbonic anhydrase. In some embodiments, the bacterium is selected for its use of carbonic anhydrase. In some embodiments, a variety of rhizobacteria effectively loaded into the seeds. In some embodiments, the rhizobacteria includes an endospore-forming bacteria that enhances the biological nitrogen fixation. In some embodiments, said rhizobacteria comprise Bacillus sp, Paenibacillus sp, or both. In some embodiments, said one or more microorganisms comprise B. amyloliquefaciens, B. laterosporus, B. licheniformis, B. macerans, B. cereus, B. circulans, B. firmus, B. subtilis, B. sphaericus, B. megaterium, B. coagulans, B. brevis, B. thuringiensis, B. mycoides, B. cucumis, B. endophyticus, B. pumilus, B. velezensis, B. mucilaginosus, B. tequilensis, B. methylotrophicus, or any combination thereof. In some embodiments, said one or more microorganisms comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof. In some embodiments, said one or more microorganisms comprise Bacillus subtilis S3C23. In some embodiments, said one or more microorganisms comprise Bacillus subtilis MP2.

In some embodiments, said one or more microorganisms comprise a genetic modification which causes said one or more microorganisms to produce or promote the formation of more carbonic anhydrase relative to corresponding wild type microorganisms. In some embodiments, genetic modification comprises a nucleic acid construct, wherein said nucleic acid construct comprises one or more promoters configured to drive expression of a carbonic anhydrase (CA) coding sequence. In some embodiments, said genetic modification comprises a nucleic acid construct, wherein said nucleic acid construct comprises a carbonic anhydrase (CA) coding sequence. In some embodiments, said CA coding sequence is heterologous to said one or more microorganisms. In some embodiments, said CA coding sequence is endogenous to said one or more microorganisms. In some embodiments, the nucleic acid construct is codon optimized. In some embodiments, said nucleic acid construct further comprises one or more promoters configured to drive expression of said CA coding sequence. In some embodiments, said one or more promoters drive constitutive expression of said CA coding sequence. In some embodiments, said one or more promoters drive inducible expression of said CA coding sequence. In some embodiments, said genetic modification comprises a carbonic anhydrase gene which has been modified by direct microbial evolution. In some embodiments, said genetic modification comprises a signal sequence. In some embodiments, said signal sequence comprises a periplasmic signal sequence or an extracellular secretion signal. In some embodiments, said periplasmic signal sequence or said extracellular secretion signal is disposed to a 5′ end of a carbonic anhydrase coding sequence. In some embodiments, said periplasmic signal sequence or said extracellular secretion signal is fused to a 5′ end of a carbonic anhydrase coding sequence. In some embodiments, said genetic modification comprises one or more components of the general secretion pathway, and wherein said genetic modification results in secretion or subcellular targeting of carbonic anhydrase by said one or more microorganisms.

In some embodiments, said one or more promoters are or are derived from one or more promoters comprised in Bacillus sp. or Paenibacillus sp. In some embodiments, said one or more promoters is selected from P_{groES}, P43, P_{sigX}, P_{trnQ}, and P_{xylA}. In some embodiments, said one or more promoters are or are derived from one or more housekeeping gene promoters or strongly expressed constitutive promoters. In some embodiments, said one or more housekeeping gene promoters or strongly expressed constitutive promoters is selected from P_{liaG}, P_{lepA}, P_{veg}, P_{gstB}, P43, P_{trnQ}, Pₗᵢₐₗ (bacitracin inducible), and P_{xylA} (xylose inducible).

In some embodiments, said genetic modification comprises an introduction of an expression vector to the one or microorganisms. In some embodiments, said genetic modification comprises a modification to a chromosome of the one or microorganisms.

In some embodiments, the microorganisms may fix both nitrogen and carbon dioxide. In some embodiments, the nitrogen fixing microorganisms will continue to provide fixed nitrogen (ammonia) via biological nitrogen fixation to plants and this would reduce the use of chemical fertilizers that are polluting the environment. The end product (ammonia) of atmospheric nitrogen fixation may enhance the process of CO₂ to minerals because ammonia has been reported to increase the pH that accelerated mineralization. Because the ammonia production from the microorganisms disclosed herein is significantly higher than other soil inhabiting microorganisms even in the presence of external nitrogen source, the mineralization process may be quicker by the strains disclosed herein than the other microorganisms inhabiting in soil.

In some embodiments, the microorganism is a microbe selected from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Pelospora sp., Pelotomaculum sp., Piscibacillus sp., Planfilum sp., Pontibacillus sp., Propionispora sp., Salinibacillus sp., Salsuginibacillus sp., Seinonella sp., Shimazuella sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp. and Vulcanobacillus sp. In some embodiments, the microorganism is a microbe selected from Acetobacter sp., Actinomyces sp., Bacillus sp., Chryseobacterium sp., Coxiella sp., Ensifer sp., Glutamicibacter sp., Microbacterium sp., or Serratia sp. In some embodiments, the microorganism is an Acetobacter sp. In some embodiments, the microorganism is an Actinomyces sp. In some embodiments, the microorganism is a Bacillus sp. In some embodiments, the microorganism is a Chryseobacterium sp. In some embodiments, the microorganism is a Coxiella sp. In some embodiments, the microorganism is an Ensifer sp. In some embodiments, the microorganism is a Glutamicibacter sp. In some embodiments, the microorganism is a Microbacterium sp. In some embodiments, the microorganism is a Pantoea sp. In some embodiments, the microorganism is a Serratia sp. In some embodiments, the microorganism is an endospore of any of the microorganisms.

In some embodiments, a microorganism is selected for one or more properties associated with the microorganism's ability to interact with the plant. In some embodiments, the microorganism is selected for compatibility. In some embodiments, the microorganism is selected to ensure no predatory or antagonistic effects will develop. In some embodiments, the microorganism is selected for stability during storage. In some embodiments, the microorganism is selected for rapid plant colonization and survival within associated tissues. In some embodiments, the microorganism is selected for optimal incorporation into the one or more plants. In some embodiments, the microorganism remains present throughout the plant life cycle.

In some embodiments, a microorganism incorporated into a plant is stable after incorporation. In some embodiments, the microorganism is stable for greater than 30 days, for greater than six months, greater than one year, or greater than two years. In some embodiments, the microorganism is stable for greater than 30 days. In some embodiments, the microorganism is stable for greater than six months. In some embodiments, the microorganism is stable for greater than one year. In some embodiments, the microorganism is stable for greater than two years.

### Compositions Comprising Bacteria

In certain aspects, disclosed herein is a composition comprising one or more microorganisms, wherein said one or microorganisms are, or are derived from, microorganisms selected to produce or promote the formation of bicarbonate and one or more minerals.

The microorganisms or exudates thereof provided herein produce or promote the formation of bicarbonate and one or more minerals. In some embodiments, the formation of bicarbonate sequesters CO₂. In some embodiments, the formation of bicarbonate leads to minerals formation. In some embodiments, the formed minerals stably sequester carbon in the soil. In some embodiments, the microorganism is a bacterium as described herein. In some embodiments, the microorganism is an endospore forming bacteria. In some embodiments, the microorganism is an endospore of a bacteria. Whenever a microorganism (e.g. a bacterium) referenced herein is capable of forming an endospore, it is intended that any endospore of the microorganism is also encompassed. For example, if a plant treatment formulation comprises a Bacillus sp., the formulation may comprise endospores of the Bacillus sp.

In some embodiments, the microorganism is a microbe from the phyla of Firmicutes, Proteobacteria, and Actinobacteria. In some embodiments, the microorganism is a microbe from the phylum Firmicutes. In some embodiments, the microorganism is a microbe from the phylum Proteobacteria. In some embodiments, the microorganism is a microbe from the phylum Actinobacteria. In some embodiments, the microorganism is an endospore of any of the microorganisms.

Rhizobacteria that fix atmospheric nitrogen are found on the roots of plants. These organisms are able to survive in soil and have tolerance to a great amount of CO₂ that is either being released by the roots of plants during respiration or CO₂ evolution by nearby microbial and soil fauna community through respiration.

In some embodiments, the bacterium is not genetically modified. In some embodiments, the bacterium is selected for its ability to convert CO₂ to bicarbonate and ultimately minerals. In some embodiments, the bacterium is selected for its use of carbonic anhydrase. In some embodiments, the bacterium is not genetically modified. In some embodiments, the bacterium is selected for its ability to convert CO₂ to bicarbonate and minerals. In some embodiments, the bacterium is selected for its use of carbonic anhydrase. In some embodiments, the bacterium is selected for its use of carbonic anhydrase. In some embodiments, a variety of rhizobacteria effectively loaded into the seeds. In some embodiments, the rhizobacteria includes an endospore-forming bacteria. In some embodiments, said rhizobacteria comprise Bacillus sp, Paenibacillus sp, or both. In some embodiments, said one or more microorganisms comprise B. amyloliquefaciens, B. laterosporus, B. licheniformis, B. macerans, B. cereus, B. circulans, B. firmus, B. subtilis, B. sphaericus, B. megaterium, B. coagulans, B. brevis, B. thuringiensis, B. mycoides, B. cucumis, B. endophyticus, B. pumilus, B. velezensis, B. mucilaginosus, B. tequilensis, B. methylotrophicus, or any combination thereof. In some embodiments, said one or more microorganisms comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof. In some embodiments, said one or more microorganisms comprise Bacillus subtilis S3C23. In some embodiments, said one or more microorganisms comprise Bacillus subtilis MP2.

In some embodiments, the microorganisms may fix both nitrogen and carbon dioxide. In some embodiments, the nitrogen fixing microorganisms will continue to provide fixed nitrogen (ammonia) via biological nitrogen fixation to plants and this would reduce the use of chemical fertilizers that are polluting the environment. The end product (ammonia) of atmospheric nitrogen fixation may enhance the process of CO₂ to bicarbonate and minerals because ammonia has been reported to increase the pH that accelerated mineralization. Because the ammonia production from the microorganisms disclosed herein is significantly higher than other soil inhabiting microorganisms even in the presence of external nitrogen source, the mineralization process may be quicker by the strains disclosed herein than the other microorganisms inhabiting in soil.

In some embodiments, the microorganism is a microbe selected from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Pelospora sp., Pelotomaculum sp., Piscibacillus sp., Planfilum sp., Pontibacillus sp., Propionispora sp., Salinibacillus sp., Salsuginibacillus sp., Seinonella sp., Shimazuella sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp. and Vulcanobacillus sp. In some embodiments, the microorganism is a microbe selected from Acetobacter sp., Actinomyces sp., Bacillus sp., Chryseobacterium sp., Coxiella sp., Ensifer sp., Glutamicibacter sp., Microbacterium sp., or Serratia sp. In some embodiments, the microorganism is an Acetobacter sp. In some embodiments, the microorganism is an Actinomyces sp. In some embodiments, the microorganism is a Bacillus sp. In some embodiments, the microorganism is a Chryseobacterium sp. In some embodiments, the microorganism is a Coxiella sp. In some embodiments, the microorganism is an Ensifer sp. In some embodiments, the microorganism is a Glutamicibacter sp. In some embodiments, the microorganism is a Microbacterium sp. In some embodiments, the microorganism is a Pantoea sp. In some embodiments, the microorganism is a Serratia sp. In some embodiments, the microorganism is an endospore of any of the microorganisms.

In some embodiments, a microorganism is selected for one or more properties associated with the microorganism's ability to interact with the plant. In some embodiments, the microorganism is selected for compatibility. In some embodiments, the microorganism is selected to ensure no predatory or antagonistic effects will develop. In some embodiments, the microorganism is selected for stability during storage. In some embodiments, the microorganism is selected for rapid plant colonization and survival within associated tissues. In some embodiments, the microorganism is selected for optimal incorporation into the one or more plants. In some embodiments, the microorganism remains present throughout the plant life cycle.

In some embodiments, a microorganism incorporated into a plant is stable after incorporation. In some embodiments, the microorganism is stable for greater than 30 days, for greater than six months, greater than one year, or greater than two years. In some embodiments, the microorganism is stable for greater than 30 days. In some embodiments, the microorganism is stable for greater than six months. In some embodiments, the microorganism is stable for greater than one year. In some embodiments, the microorganism is stable for greater than two years.

### Definitions

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Use of absolute or sequential terms, for example, “will,” “will not,” “shall,” “shall not,” “must,” “must not,” “first,” “initially,” “next,” “subsequently,” “before,” “after,” “lastly,” and “finally,” are not meant to limit scope of the present embodiments disclosed herein but as exemplary.

As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “irrigation system,” as described herein, may be the artificial process of applying controlled amounts of water to assist in the production of crops, but also to grow plants, where it may be known as “watering.” In some embodiments the term “irrigation system” may include spraying foliage, in-furrow fertilizer treatment, sprinkler system, humidifier, or a misting system.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, “or” may refer to “and”, “or,” or “and/or” and may be used both exclusively and inclusively. For example, the term “A or B” may refer to “A or B”, “A but not B”, “B but not A”, and “A and B”. In some cases, context may dictate a particular meaning.

Any systems, methods, software, and platforms described herein are modular. Accordingly, terms such as “first” and “second” do not necessarily imply priority, order of importance, or order of acts.

The term “about” when referring to a number or a numerical range means that the number or numerical range referred to is an approximation within experimental variability (or within statistical experimental error), and the number or numerical range may vary from, for example, from 1% to 15% of the stated number or numerical range. In examples, the term “about” refers to +10% of a stated number or value.

The terms “increased”, “increasing”, or “increase” are used herein to generally mean an increase by a statically significant amount. In some aspects, the terms “increased,” or “increase,” mean an increase of at least 10% as compared to a reference level, for example an increase of at least about 10%, at least about 20%, or at least about 30%, or at least about 40%, or at least about 50%, or at least about 60%, or at least about 70%, or at least about 80%, or at least about 90% or up to and including a 100% increase or any increase between 10-100% as compared to a reference level, standard, or control. Other examples of “increase” include an increase of at least 2-fold, at least 5-fold, at least 10-fold, at least 20-fold, at least 50-fold, at least 100-fold, at least 1000-fold or more as compared to a reference level.

The terms, “decreased”, “decreasing”, or “decrease” are used herein generally to mean a decrease by a statistically significant amount. In some aspects, “decreased” or “decrease” means a reduction by at least 10% as compared to a reference level, for example a decrease by at least about 20%, or at least about 30%, or at least about 40%, or at least about 50%, or at least about 60%, or at least about 70%, or at least about 80%, or at least about 90% or up to and including a 100% decrease (e.g., absent level or non-detectable level as compared to a reference level), or any decrease between 10-100% as compared to a reference level. In the context of a marker or symptom, by these terms is meant a statistically significant decrease in such level. The decrease can be, for example, at least 10%, at least 20%, at least 30%, at least 40% or more, and is preferably down to a level accepted as within the range of normal for an individual without a given disease.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

### NUMBERED EMBODIMENTS

1. A composition comprising one or more microorganisms, wherein said one or more microorganisms are located at an interspace between a coating and a cell layer of a plant or a part thereof, and are, or are derived from, one or more microorganisms selected to produce or promote the formation of bicarbonate, carbonate or one or more minerals.
2. The composition of any one of the preceding embodiments, wherein said plant or said part thereof is a plant root, a plant stem, a plant leaf, a plant seed, a plant fruit, a plant tuber, or a plant root nodule.
3. The composition of any one of the preceding embodiments, wherein said plant or said part thereof comprise a commercial plant or part thereof.
4. The composition of any one of the preceding embodiments, wherein said commercial plant or part thereof is maize, wheat, rice, sorghum, barley, rye, sugar cane, millet, oat, soybean, cotton, alfalfa, bean, quinoa, lentil, peanut, sunflower, canola, cassava, oil palm, potato, sugar beet, cacao, coffea, lettuce, tomato, pea, cabbage, fruit tree, nut tree, forestry tree, grassland, or turfgrass.
5. The composition of any one of the preceding embodiments, wherein said part thereof is a plant seed and wherein said one or more microorganisms associated with said plant seed are disposed in an interspace between a seed coat and a seed embryo of said plant seed.
6. The composition of any one of the preceding embodiments, wherein said one or more microorganisms associated with said plant or said part thereof are disposed as a coating of said plant or said part thereof.
7. The composition of any one of the preceding embodiments, wherein said one or more microorganisms associated with said plant or said part thereof are applied through an irrigation-system to said plant seed.
8. The composition of any one of the preceding embodiments, wherein said irrigation system comprises an in-furrow treatment technique.
9. The composition of any one of the preceding embodiments, wherein said irrigation system comprises a spray technique.
10. The composition of any one of the preceding embodiments, wherein said bicarbonate sequesters carbon.
11. The composition of any one of the preceding embodiments, wherein the carbon is a gaseous carbon.
12. The composition of any one of the preceding embodiments, wherein said gaseous carbon is carbon dioxide.
13. The composition of any one of the preceding embodiments, wherein said carbonate sequesters carbon.
14. The composition of any one of the preceding embodiments, wherein the carbon is a gaseous carbon.
15. The composition of any one of the preceding embodiments, wherein said gaseous carbon is carbon dioxide.
16. The composition of any one of the preceding embodiments, wherein said one or more minerals sequester carbon.
17. The composition of any one of the preceding embodiments, wherein the carbon is a gaseous carbon.
18. The composition of any one of the preceding embodiments, wherein the gaseous carbon is carbon dioxide.
19. The composition of any one of the preceding embodiments, wherein said part thereof is a plant seed and wherein said one or more microorganisms associated with said plant seed are disposed in an interspace between a seed pericarp and a seed aleurone cell layer of said plant seed.
20. The composition of any one of the preceding embodiments, wherein said one or more microorganisms comprises one or more carbonic anhydrase enzymes.
21. The composition of any one of the preceding embodiments, wherein said one or more carbonic anhydrase enzymes comprise a carbonic anhydrase enzyme alpha class.
22. The composition of any one of the preceding embodiments, wherein said one or more carbonic anhydrase enzymes comprise a carbonic anhydrase enzyme beta class.
23. The composition of any one of the preceding embodiments, wherein said one or more carbonic anhydrase enzymes comprise a carbonic anhydrase enzyme gamma class.
24. The composition of any one of the preceding embodiments, wherein said one or more carbonic anhydrase enzymes comprise a carbonic anhydrase enzyme delta class.
25. The composition of any one of the preceding embodiments, wherein said one or more carbonic anhydrase enzymes comprise a carbonic anhydrase enzyme zeta class.
26. The composition of any one of the preceding embodiments, wherein said one or more carbonic anhydrase enzymes comprise a carbonic anhydrase enzyme eta class.
27. The composition of any one of the preceding embodiments, wherein said one or more carbonic anhydrase enzymes comprise a carbonic anhydrase enzyme iota class.
28. The composition of any one of the preceding embodiments, wherein said one or more microorganisms comprise a bacteria, archaea, fungi, or virus.
29. The composition of any one of the preceding embodiments, wherein said one or more microorganisms comprise said bacteria.
30. The composition of any one of the preceding embodiments, wherein said bacteria comprise endospore forming bacteria.
31. The composition of any one of the preceding embodiments, wherein said bacteria comprise bacteria from Acetonema sp., Actinomyces sp., Alkalibacillus sp., Ammoniphilus sp., Amphibacillus sp., Anaerobacter sp., Anaerospora sp., Aneurinibacillus sp., Anoxybacillus sp., Bacillus sp., Brevibacillus sp., Caldanaerobacter sp., Caloramator sp., Caminicella sp., Cerasibacillus sp., Clostridium sp., Clostridiisalibacter sp., Cohnella sp., Coxiella sp. Dendrosporobacter sp., Desulfotomaculum sp., Desulfosporomusa sp., Desulfosporosinus sp., Desulfovirgula sp., Desulfunispora sp., Desulfurispora sp., Filifactor sp., Filobacillus sp., Gelria sp., Geobacillus sp., Geosporobacter sp., Gracilibacillus sp., Halobacillus sp., Halonatronum sp., Heliobacterium sp., Heliophilum sp., Laceyella sp., Lentibacillus sp., Lysinibacillus sp., Mahela sp., Metabacterium sp., Moorella sp., Natroniella sp., Oceanobacillus sp., Orenia sp., Ornithinibacillus sp., Oxalophagus sp., Oxobacter sp., Paenibacillus sp., Paraliobacillus sp., Pelospora sp., Pelotomaculum sp., Piscibacillus sp., Planifilum sp., Pontibacillus sp., Propionispora sp., Salinibacillus sp., Salsuginibacillus sp., Seinonella sp., Shimazuella sp., Sporacetigenium sp., Sporoanaerobacter sp., Sporobacter sp., Sporobacterium sp., Sporohalobacter sp., Sporolactobacillus sp., Sporomusa sp., Sporosarcina sp., Sporotalea sp., Sporotomaculum sp., Syntrophomonas sp., Syntrophospora sp., Tenuibacillus sp., Tepidibacter sp., Terribacillus sp., Thalassobacillus sp., Thermoacetogenium sp., Thermoactinomyces sp., Thermoalkalibacillus sp., Thermoanaerobacter sp., Thermoanaeromonas sp., Thermobacillus sp., Thermoflavimicrobium sp., Thermovenabulum sp., Tuberibacillus sp., Virgibacillus sp., Vulcanobacillus sp., or a combination thereof.
32. The composition of any one of the preceding embodiments, wherein said bacteria comprise bacteria belonging to the Firmicutes phylum.
33. The composition of any one of the preceding embodiments, wherein said bacteria comprise rhizobacteria.
34. The composition of any one of the preceding embodiments, wherein said rhizobacteria comprise Bacillus sp, Paenibacillus sp, or both.
35. The composition of any one of the preceding embodiments, wherein said bacteria comprise B. amyloliquefaciens, B. laterosporus, B. licheniformis, B. macerans, B. cereus, B. circulans, B. firmus, B. subtilis, B. megaterium, B. coagulans, B. brevis, B. sphaericus, B. thuringiensis, B. mycoides, B. cucumis, B. endophyticus, B. pumilus, B. velezensis, B. mucilaginosus, B. tequilensis, B. methylotrophicus, or any combination thereof.
36. The composition of any one of the preceding embodiments, wherein said bacteria comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof.
37. The composition of any one of the preceding embodiments, wherein said bacteria comprise Bacillus subtilis S3C23.
38. The composition of any one of the preceding embodiments, wherein said bacteria comprise Bacillus subtilis MP2.
39. The composition of any one of the preceding embodiments, wherein said bacteria comprise Ensifer adhaerens S3C10.
40. The composition of any one of the preceding embodiments, wherein said bacteria comprise Paenibacillus polymyxa, Paenibacillus taohuashanense, Paenibacillus pocheonensis, Paenibacillus aceris, Paenibacillus catalpa, Paenibacillus rigui, Paenibacillus pabuli, Paenibacillus brasiliensis, or any combination thereof.
41. The composition of any one of the preceding embodiments, wherein said bacteria comprise Paenibacillus polymyxa RO3C16, Paenibacillus taohuashanense TY4D5, Paenibacillus pocheonensis S2C3, Paenibacillus aceris VF2D2, Paenibacillus catalpa TY2B5, Paenibacillus rigui TY2D5, Paenibacillus pabuli PG2A8, or any combination thereof.
42. The composition of any one of the preceding embodiments, wherein said bacteria comprise non-endospore forming bacteria.
43. The composition of any one of the preceding embodiments, wherein said bacteria comprise bacteria belonging to the Proteobacteria phylum.
44. The composition of any one of the preceding embodiments, wherein said bacteria comprise Klebsiella sp., Rhizobium sp., Bradyrhizobium sp., Ochrobactrum sp., Sinorhizobium sp., Xanthobacter sp., Methylobacterium sp., Actinomyces sp., Kosakonia sp., Azotobacter sp., Acetobacter sp., Herbaspirillum sp., Pseudomonas sp., Paraburkholderia sp., Ralstonia sp., Geobacter sp., Serratia sp., Pantoea sp., Ensifer sp., Enterobacter sp., or any combination thereof.
45. The composition of any one of the preceding embodiments, wherein said bacteria comprise bacteria belonging to the Actinobacteria phylum.
46. The composition of any one of the preceding embodiments, wherein said bacteria comprise Streptomyces sp., Coxiella sp., Frankia sp.
47. The composition of any one of the preceding embodiments, wherein said bacteria comprise bacteria belonging to the Cyanobacteria phylum.
48. The composition of any one of the preceding embodiments, wherein said bacteria comprise Cyanobacteria sp.
49. The composition of any one of the preceding embodiments, wherein said bacteria comprise bacteria belonging to the Cloroflexi phylum.
50. The composition of any one of the preceding embodiments, wherein said one or more microorganisms comprise one or more fungi associated with said plant or said part thereof.
51. The composition of any one of the preceding embodiments, wherein said one or more fungi associated with said plant or said part thereof are disposed in an interspace between a seed coat and a seed embryo of said plant or said part thereof.
52. The composition of any one of the preceding embodiments, wherein said one or more fungi associated with said plant or said part thereof are disposed as a coating of said plant or said part thereof.
53. The composition of any one of the preceding embodiments, wherein said one or more fungi associated with plant or part thereof are applied with in-furrow techniques to said plant or said part thereof.
54. The composition of any one of the preceding embodiments, wherein said one or more fungi associated with said plant or said part thereof are applied with spray techniques to said plant or said part thereof.
55. The composition of any one of the preceding embodiments, wherein said one or more fungi associated with said plant or said part thereof are applied through said irrigation system to said plant or said part thereof.
56. The composition of any one of the preceding embodiments, wherein said one or more fungi associated with said plant or said part thereof are disposed in an interspace between a seed pericarp and a seed aleurone cell layer of said plant or said part thereof.
57. The composition of any one of the preceding embodiments, wherein said one or more fungi comprise Arbuscular Mycorrhizal fungi.
58. The composition of any one of the preceding embodiments, wherein said one or more fungi comprise Ectomycorrhizal fungi.
59. The composition of any one of the preceding embodiments, wherein said one or more fungi comprise fungi from the genus Trichoderma.
60. The composition of any one of the preceding embodiments, wherein said one or more fungi comprise fungi from the genus Penicillium.
61. The composition of any one of the preceding embodiments, wherein said one or more minerals comprise calcite, aragonite, dolomite, limestone, or any combination thereof.
62. The composition of any one of the preceding embodiments, wherein said one or more minerals comprise CaCO₃, MgCO₃, CaMg(CO₃)₂, or any combination thereof.
63. The composition of any one of the preceding embodiments, wherein said promotion of production of said one or more minerals comprises production of ammonia and a resulting increase in pH in a medium in which a plant derived from said plant or said part thereof is grown.
64. The composition of any one of the preceding embodiments, wherein said part thereof is a plant seed and wherein said one or more microorganisms are not naturally present in said interspace between said seed pericarp and said seed aleurone cell layer of said plant or said part thereof.
65. The composition of any one of the preceding embodiments, wherein said plant or said part thereof is monocot plant or dicot plant.
66. A method of promoting mineralization, the method comprising:
   a. cultivating a plant or a part thereof and one or more microorganisms associated with said plant or said part thereof,
wherein said one or more microorganisms are, or are derived from, microorganisms selected to produce or promote the formation of bicarbonate, carbonate, or one or more minerals.
67. The method of any one of the preceding embodiments, wherein said plant or said part thereof is a commercial plant, a plant root, a plant stem, a plant leaf, a plant seed, a plant fruit, a plant tuber, or a plant root nodule.
68. The method of any one of the preceding embodiments, wherein said one or more microorganisms associated with said plant or part thereof are disposed on said plant root or a rhizosphere of said plant or part thereof.
69. The method of any one of the preceding embodiments, wherein said one or more microorganisms associated with said plant or said part thereof are disposed on said plant root or said rhizosphere of said plant or said part thereof by an irrigation system.
70. The method of any one of the preceding embodiments, wherein said irrigation system comprises an in-furrow treatment technique.
71. The method of any one of the preceding embodiments, wherein said irrigation system comprises a spray technique.
72. The method of any one of the preceding embodiments, wherein said plant or part thereof is derived from a seedling, which is integrated through said irrigation system with said microorganisms to stimulate production of said one or more minerals by said plant or part thereof.
73. The method of any one of the preceding embodiments, wherein said bicarbonate sequesters carbon.
74. The method of any one of the preceding embodiments, wherein the carbon is a gaseous carbon.
75. The method of any one of the preceding embodiments, wherein said gaseous carbon is carbon dioxide.
76. The method of any one of the preceding embodiments, wherein said carbonate sequesters carbon.
77. The method of any one of the preceding embodiments, wherein the carbon is a gaseous carbon.
78. The method of any one of the preceding embodiments, wherein said gaseous carbon is carbon dioxide.
79. The method of any one of the preceding embodiments, wherein said one or more minerals sequester carbon.
80. The method of any one of the preceding embodiments, wherein the carbon is a gaseous carbon.
81. The method of any one of the preceding embodiments, wherein the gaseous carbon is carbon dioxide.
82. The method of any one of the preceding embodiments, wherein said one or more microorganisms comprise bacteria, archaea, a fungi, or a virus.
83. The method of any one of the preceding embodiments, wherein said one or more microorganisms comprise said bacteria.
84. The method of any one of the preceding embodiments, wherein said bacteria comprise endospore forming bacteria.
85. The method of any one of the preceding embodiments, wherein bacteria comprise rhizobacteria.
86. The method of any one of the preceding embodiments, wherein said rhizobacteria comprise Bacillus sp, Paenibacillus sp, or both.
87. The method of any one of the preceding embodiments, wherein said bacteria comprise B. amyloliquefaciens, B. laterosporus, B. licheniformis, B. macerans, B. cereus, B. circulans, B. firmus, B. subtilis, B. sphaericus, B. megaterium, B. coagulans, B. brevis, B. thuringiensis, B. mycoides, B. cucumis, B. endophyticus, B. pumilus, B. velezensis, B. mucilaginosus, B. tequilensis, B. methylotrophicus, or any combination thereof.
88. The method of any one of the preceding embodiments, wherein said bacteria comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof.
89. The method of any one of the preceding embodiments, wherein said bacteria comprise Bacillus subtilis S3C23.
90. The method of any one of the preceding embodiments, wherein said bacteria comprise Bacillus subtilis MP2.
91. The method of any one of the preceding embodiments, wherein said bacteria comprise Ensifer adhaerens S3C10.
92. The method of any one of the preceding embodiments, wherein said one or more microorganisms comprise one or more fungi associated with said plant or said part thereof.
93. The method of any one of the preceding embodiments, wherein said one or more fungi associated with said plant or said part thereof are disposed on said plant root or said rhizosphere of said plant or said part thereof by said irrigation system.
94. The method of any one of the preceding embodiments, wherein said one or more fungi comprise Arbuscular Mycorrhizal fungi.
95. The method of any one of the preceding embodiments, wherein said one or more fungi comprise Ectomycorrhizal fungi.
96. The method of any one of the preceding embodiments, wherein said one or more fungi comprise fungi from the genus Trichoderma.
97. The method of any one of the preceding embodiments, wherein said one or more fungi comprise fungi from the genus Penicillium.
98. The method of any one of the preceding embodiments, wherein said one or more microorganisms produces the formation of one or more carbonic anhydrase enzymes.
99. The method of any one of the preceding embodiments, wherein said one or more microorganisms produces the formation of one or more carbonic anhydrase enzymes belonging to the alpha class.
100. The method of any one of the preceding embodiments, wherein said one or more microorganisms produces the formation of one or more carbonic anhydrase enzymes belonging to the beta class.
101. The method of any one of the preceding embodiments, wherein said one or more microorganisms produces the formation of one or more carbonic anhydrase enzymes belonging to the gamma class.
102. The method of any one of the preceding embodiments, wherein said one or more microorganisms produces the formation of one or more carbonic anhydrase enzymes belonging to the delta class.
103. The method of any one of the preceding embodiments, wherein said one or more microorganisms produces the formation of one or more carbonic anhydrase enzymes belonging to the zeta class.
104. The method of any one of the preceding embodiments, wherein said one or more microorganisms produces the formation of one or more carbonic anhydrase enzymes belonging to the eta class.
105. The method of any one of the preceding embodiments, wherein said one or more microorganisms produces the formation of one or more carbonic anhydrase enzymes belonging to the iota class.
106. The method of any one of the preceding embodiments, wherein said one or more minerals comprise calcite, aragonite, dolomite, limestone, or any combination thereof.
107. The method of any one of the preceding embodiments, wherein said promotion of production of said one or more minerals comprises production of ammonia and a resulting increase in pH in a medium in which said plant or said part thereof is grown.
108. The method of any one of the preceding embodiments, wherein said one or more microorganisms are not naturally present on said one or more roots.
109. The method of any one of the preceding embodiments, wherein said plant or said part thereof is monocot plant or dicot plant
110. The method of any one of the preceding embodiments, wherein said plant or said part thereof comprise a commercial plant or part thereof.
111. The method of any one of the preceding embodiments, wherein said commercial plant or part thereof is comprised of a group consisting essentially of plant is maize, wheat, rice, sorghum, barley, rye, sugar cane, millet, oat, soybean, cotton, alfalfa, bean, quinoa, lentil, peanut, sunflower, canola, cassava, oil palm, potato, sugar beet, cacao, coffea, lettuce, tomato, pea, cabbage, fruit tree, nut tree, forestry tree, grassland, or turfgrass.
112. A composition comprising one or more microorganisms, wherein said one or more microorganisms are, or are derived from, microorganisms selected to produce or promote the formation of bicarbonate, carbonate, or one or more minerals.
113. The composition of any one of the preceding embodiments, wherein said plant or said part thereof is a plant root, a plant stem, a plant leaf, a plant seed, a plant fruit, a plant tuber, or a plant root nodule.
114. The composition of any one of the preceding embodiments, wherein said plant or said part thereof comprise a commercial plant or part thereof.
115. The composition of any one of the preceding embodiments, wherein said commercial plant or part thereof is maize, wheat, rice, sorghum, barley, rye, sugar cane, millet, oat, soybean, cotton, alfalfa, bean, quinoa, lentil, peanut, sunflower, canola, cassava, oil palm, potato, sugar beet, cacao, coffea, lettuce, tomato, pea, cabbage, fruit tree, nut tree, forestry tree, grassland, or turfgrass.
116. The composition of any one of the preceding embodiments, wherein said bicarbonate sequesters carbon.
117. The composition of any one of the preceding embodiments, wherein the carbon is a gaseous carbon.
118. The composition of any one of the preceding embodiments, wherein said gaseous carbon is carbon dioxide.
119. The composition of any one of the preceding embodiments, wherein said carbonate sequesters carbon.
120. The composition of any one of the preceding embodiments, wherein the carbon is a gaseous carbon.
121. The composition of any one of the preceding embodiments, wherein said gaseous carbon is carbon dioxide.
122. The composition of any one of the preceding embodiments, wherein said one or more minerals sequester carbon.
123. The composition of any one of the preceding embodiments, wherein the carbon is a gaseous carbon.
124. The composition of any one of the preceding embodiments, wherein the gaseous carbon is carbon dioxide.
125. The composition of any one of the preceding embodiments, wherein said one or more microorganisms comprise bacteria, archaea, a fungi, or a virus.
126. The composition of any one of the preceding embodiments, wherein said one or more microorganisms comprise said bacteria.
127. The composition of any one of the preceding embodiments, wherein said bacteria comprise endospore forming bacteria.
128. The composition of any one of the preceding embodiments, wherein said bacteria comprise rhizobacteria.
129. The composition of any one of the preceding embodiments, wherein said rhizobacteria comprise Bacillus sp, Paenibacillus sp, or both.
130. The composition of any one of the preceding embodiments, wherein said bacteria comprise B. amyloliquefaciens, B. laterosporus, B. licheniformis, B. macerans, B. cereus, B. circulans, B. firmus, B. subtilis, B. sphaericus, B. megaterium, B. coagulans, B. brevis, B. thuringiensis, B. mycoides, B. cucumis, B. endophyticus, B. pumilus, B. velezensis, B. mucilaginosus, B. tequilensis, B. methylotrophicus, or any combination thereof.
131. The composition of any one of the preceding embodiments, wherein said bacteria comprise Bacillus subtilis S3C23, Bacillus subtilis MP2, Bacillus subtilis RO2C15, Bacillus subtilis RO2C22, Bacillus megaterium 6, Bacillus megaterium S3C21, Bacillus megaterium RO2C12, Bacillus cucumis S3C14, Bacillus endophyticus 5, or any combination thereof.
132. The composition of any one of the preceding embodiments, wherein said bacteria comprise Bacillus subtilis S3C23.
133. The composition of any one of the preceding embodiments, wherein said bacteria comprise Bacillus subtilis MP2.
134. The composition of any one of the preceding embodiments, wherein said bacteria comprise Ensifer adhaerens S3C10.
135. The composition of any one of the preceding embodiments, wherein said one or more microorganisms comprise one or more fungi associated with said plant or said part thereof.
136. The composition of any one of the preceding embodiments, wherein said one or more fungi associated with said plant or said part thereof are disposed on said plant root or said rhizosphere of said plant or said part thereof by said irrigation system.
137. The composition of any one of the preceding embodiments, wherein said one or more fungi comprise Arbuscular Mycorrhizal fungi.
138. The composition of any one of the preceding embodiments, wherein said one or more fungi comprise Ectomycorrhizal fungi.
139. The composition of any one of the preceding embodiments, wherein said one or more fungi comprise fungi from the genus Trichoderma.
140. The composition of any one of the preceding embodiments, wherein said one or more fungi comprise fungi from the genus Penicillium.
141. The composition of any one of the preceding embodiments, wherein said one or more minerals comprise calcite, aragonite, dolomite, limestone, or any combination thereof.
142. The composition of any one of the preceding embodiments, wherein said promotion of production of said one or more minerals comprises production of ammonia and a resulting increase in pH in a medium in which said plant or said part thereof is grown.
143. The composition of any one of the preceding embodiments, wherein said one or more microorganisms comprises one or more carbonic anhydrase enzymes.
144. The composition of any one of the preceding embodiments, wherein said one or more carbonic anhydrase enzymes comprise a carbonic anhydrase enzyme alpha class.
145. The composition of any one of the preceding embodiments, wherein said one or more carbonic anhydrase enzymes comprise a carbonic anhydrase enzyme beta class.
146. The composition of any one of the preceding embodiments, wherein said one or more carbonic anhydrase enzymes comprise a carbonic anhydrase enzyme gamma class.
147. The composition of any one of the preceding embodiments, wherein said one or more carbonic anhydrase enzymes comprise a carbonic anhydrase enzyme delta class.
148. The composition of any one of the preceding embodiments, wherein said one or more carbonic anhydrase enzymes comprise a carbonic anhydrase enzyme zeta class.
149. The composition of any one of the preceding embodiments, wherein said one or more carbonic anhydrase enzymes comprise a carbonic anhydrase enzyme eta class.
150. The composition of any one of the preceding embodiments, wherein said one or more carbonic anhydrase enzymes comprise a carbonic anhydrase enzyme iota class.

### EXAMPLES

The methods and compositions of the disclosure are designed to microbially sequester carbon by the formation of bicarbonate and one or more minerals in association with a plant or a plant seed.

Definition of the microbial formulation: In order to achieve early conditioning, the disclosure employs seed treatment compositions comprising a synthetic consortium or single isolated bacterial strains or endospores in a suspension medium. Typically, the plant cultivation compositions and methods comprise diverse and environmentally adaptable plant-associated bacteria belonging to a wide variety of bacterial genera, distributed among different taxa within the Proteobacteria phylum (α-, β-, γ and δ-Proteobacteria classes), as well as the Phylum Firmicutes, Bacteroidetes, and Actinobacteria. The inventors have isolated and characterized rhizobacteria belonging to various genera, usually comprising plant associated microorganisms, within these large taxonomical groups can be applied to seeds, using the method of the present disclosure, in order to effectively colonize the roots and ultimately sequester CO₂. Compositions include one, two, three, or several different bacterial strains cultivated separately, and mixed for Microprime™ seed treatment.

### Example 1. Seed Treatment to Increase Loading of Non-Endospore-Forming Bacteria, Endospore-Forming Bacteria and/or Bacteria Endospores: The Microprime™ Technology

While CO₂ fixing microorganisms reside in the soil, CO₂ sequestration is not effective because of the following reasons. Many of the microorganisms are unable to utilize CO₂ as their energy source. Many organisms are not close enough to the roots where CO₂ emission is taking place and their number remain lower probably because other microorganisms kill them off. The Microprime™ seed treatment directly delivers microorganisms at the site of CO₂ evolution and to promote 100% effective colonization on roots.

The Microprime™ seed treatment is a stable microbial seed treatment process by which a plant-beneficial bacteria as endospore or vegetative cell and/or a synthetic consortium of microorganisms and/or its exudates and/or its individualized biomolecules will be packed inside the seed through an industrially scalable process. This process takes into account the process cost, time, stability over time (for both the plant embryo and the inoculant), the multi-soil compatibility, the stability under different environmental conditions and compatibility with the traditional distribution chain for agricultural inputs. The method involved a controlled, economical and fast imbibition of seeds in an aqueous solution of an osmotically active liquid media supplemented with an specified amount of the beneficial microorganisms or a synthetic consortia of microorganisms and/or its exudates and/or its individualized biomolecules, in addition to a surfactant to enhance intra-seed permeability and/or a group of nutrients to enhance the microorganism colonization inside the seed and/or a supplemental reagent for enhancing bacterial endospore formation. The long-term biological agent survival, the genetic modulation of the embryo and the extended shelf-life of the treated seed are guaranteed by the Microprime™ seed technology. Finally, this methodology did not require a seed drying process making it an economically insurmountable process of only $0.20 per acre with the potential to be reduced even more.

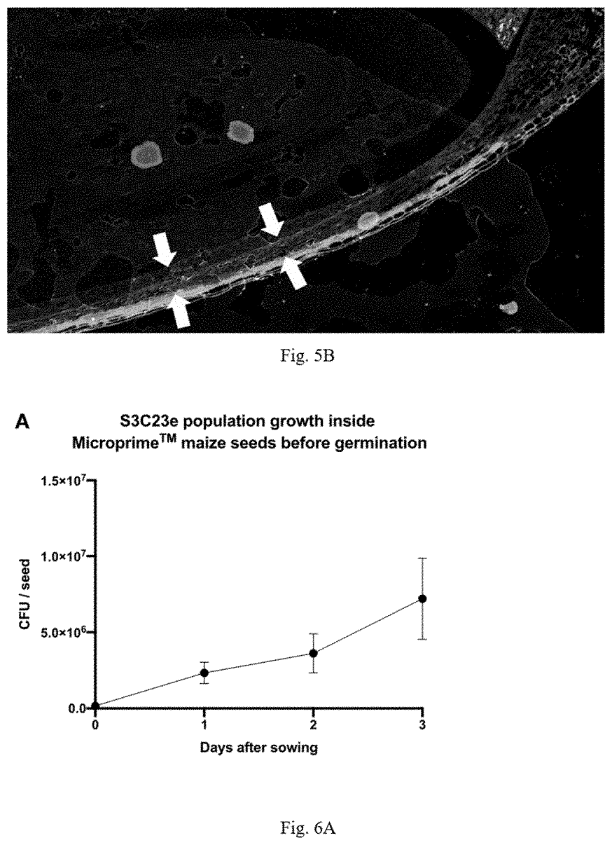

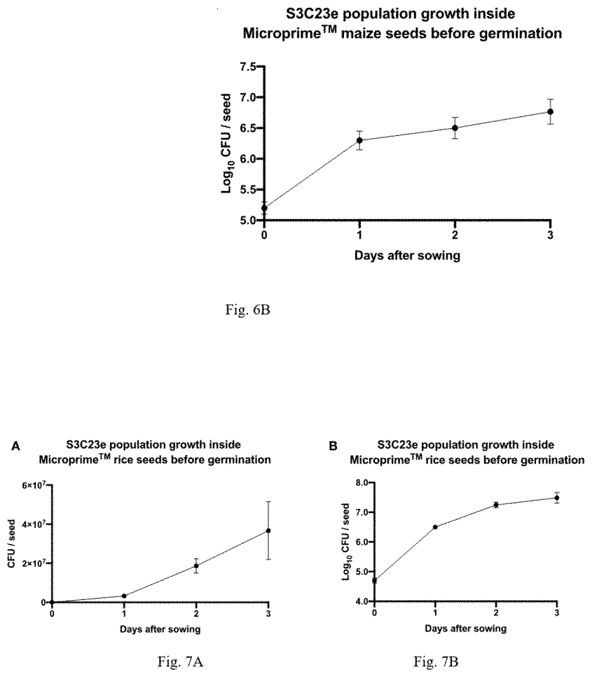

The Microprime™ seed treatment had an efficiency of 100% using endospores. This means that 100% of the treated seeds were effectively loaded with the desired endospores within 30 seconds and the average of loaded bacterial cells per seed is of the order of 10⁵ (Table 2). This high loading efficiency of microbial cells into the seed is a unique characteristic of the Microprime™ seed treatment. which guarantees the efficient delivery of a desired bacteria on to the field. The plant's root colonization by the loaded bacteria was 100% and this means that 100% of the treated seeds/plants were effectively colonized by the initially loaded bacteria. The plant's root colonization process immediately starts as the seed is sown, comes out of dormancy and germination begins (Table 2, FIGS. 5-7).

The Microprime™ seed treatment was used in both monocot and dicot seeds with the same efficiency and effectiveness (Table 2). Briefly the Microprime™ seed treatment was applied in monocot (maize and rice) and dicot (soybean) seeds, using endospores of Bacillus subtilis strain S3C23. Root colonization, percentage of colonized plants and percentage of seedling emergence were measured 14 days after sowing. For seed loading the data represent the mean of three pools of five seeds per pool. For root colonization the data represent the mean of 10 plants per treatment. For the percentage of seedling emergence, the data represent the mean of 36 plants per treatment for corn and 72 plants per treatment for soybean and rice.

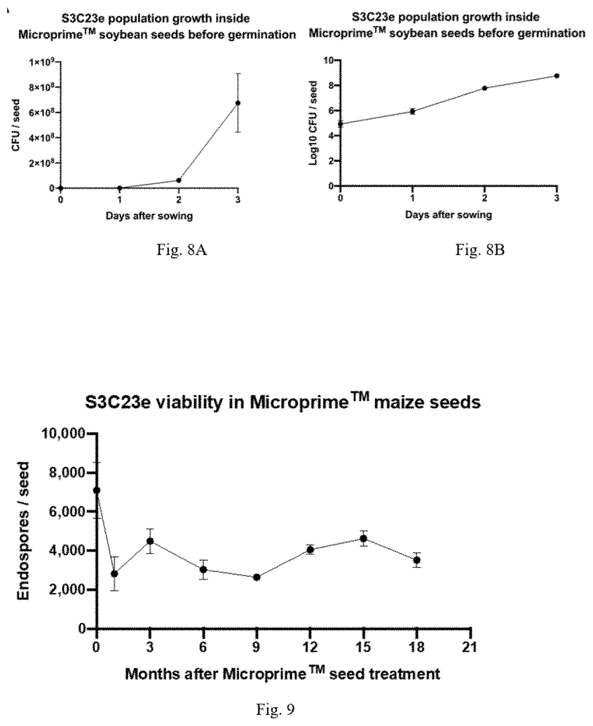

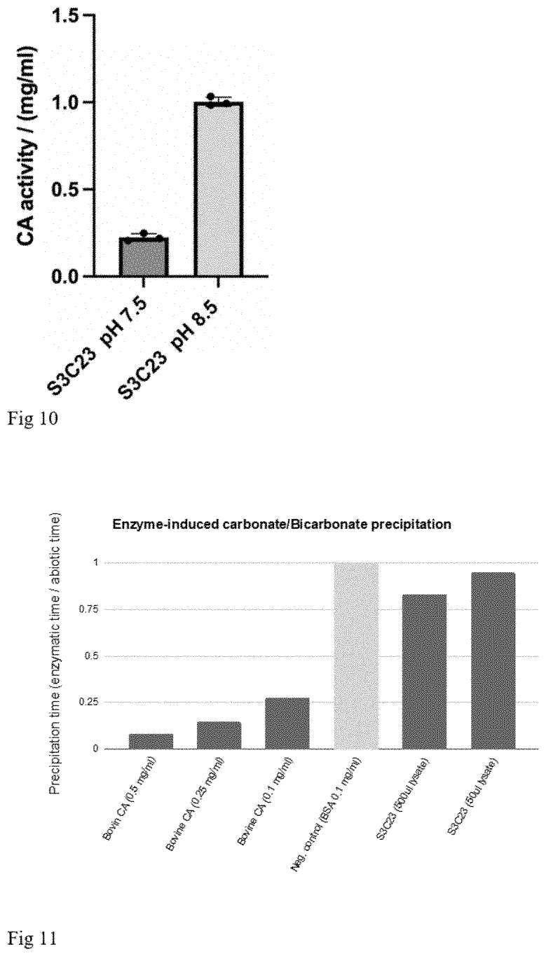

The Microprime™ seed treatment presents high compatibility with a commercial seed in terms of the requirements of traditional seed industry and agricultural practices since the embryo and the bacteria stability were guaranteed through time (FIG. 8). The Microprime™ seed treatment process is described with more particularity in WO2020214843, which is herein incorporated by reference in its entirety.

TABLE 2
Example of bacterial loading into a seed

| Time of Microprime ™ seed treatment (min) | Average of CFU/seed |
|---|---|
| 0.5 | 5.54E+05 |
| 1.0 | 3.53E+05 |
| 2.5 | 2.27E+05 |
| 5.0 | 7.73E+05 |

TABLE 3
Summary of the Microprime ™ seed treatment applied in monocot and dicot

| | | Root | | | |
|---|---|---|---|---|---|
| Type of | Seed loading | (CFU/g root FW) | % of colonized | % of seedling emergence | |
| seed | (CFU/seed) | colonization | plants | Microprime ™ | UTC |
| Maize | 133,333 | 814,354 | 100 | 100.0 | 100.0 |
| Rice | 46,667 | 1,384,447 | 100 | 94.4 | 93.1 |
| Soybean | 61,333 | 140,037 | 100 | 95.8 | 93.1 |

### Example 2: The Effect of the Biosystem Plant-Microorganisms on Carbon Dioxide Removal

Carbon free world is a global initiative and many internationally renowned companies such as Microsoft, Amazon and Google have committed to be carbon neutral or carbon free by 2040. These companies generate a high carbon footprint and in order to become carbon neutral, in the near future, these companies buy carbon credit from companies/organizations that can effectively capture CO₂. The technology is focused on not only reducing the carbon emissions but also converting it into either agricultural useful products or bio-persisting products. Using the compositions and methods disclosed herein that would ensure efficient CO₂ sequestration would generate carbon credits for farmers and at the same time it will be slowing down climate change. Because the overall cost of the compositions and methods disclosed herein is significantly lower than any existing technology in the market, its adoption should be fast, which will allow to generate a large inventory of carbon credits to offer them to the growing number of companies that need to mitigate their carbon footprint.

Carbon dioxide removal (CDR) is a type of climate engineering in which CO₂ is removed from the atmosphere and sequestered for long periods of time. CDR methods include afforestation, agricultural practices that sequester carbon in soils, bio-energy with carbon capture and storage, enhanced weathering, ocean fertilization and direct air capture when combined with storage.

A 2019 consensus report by the National Academies of Sciences, Engineering, and Medicine concluded that using existing CDR methods at scales that can be safely and economically deployed, there is potential to remove and sequester up to 10 Gt of carbon dioxide per year. This would offset greenhouse gas emissions at about a fifth of the rate at which they are being produced.

For the carbon sequestration three conditions are needed: storage, space and low-cost power. Current technologies to capture carbon from the air, such as direct air capture (DAC) needs a vast space for its operations and also a lot of energy, being the theoretical minimum energy required to extract CO₂ from ambient air about 250 kWh per ton of CO₂.

On the other hand, by using crop plantations, fruit trees and forest trees which already exist to support the food production for the global population and also wood as a commodity for several industries, the advantages in terms of installed capacity and low-cost power are unmatched.

More detailed, regarding space to capture CO₂, the FAO predicts that global arable land use will continue to grow from a 1.58 billion hectares (3.9×10⁹ acres) in 2014 to 1.66 billion hectares (4.1×10⁹ acres) in 2050 and the total forest area is 4.06 billion hectares, so the installed capacity already exists and must be used.

Regarding low-energy power, the use of microorganisms, such as bacteria, who interact tightly with plant roots is the most cost-effective scenario for a factory of CO₂ sequestration. This, because plants provide through their root exudates an abundant cocktail of carbon and energy sources from which the soil bacteria can use for their proliferation, and on the other hand, the plant benefits in many ways by the colonization of these bacteria. No additional power input is needed to thrive this biosystem plant-bacteria.

Finally, by using microorganisms expressing the carbonic anhydrase enzyme in association with plants, the CO₂ can be effectively sequestered by the production of bicarbonate and ultimately carbonate minerals in the soil.

### Example 3: Methods to Measure the CA Activity and/or Bicarbonate and Mineral Formation

At a laboratory scale, the selected microorganisms will be grown in the CA producing media as described previously by (Zhuang et al., 2018). CA activity units will be measured at different time points using the CA activity measurement method described by Zhuang et al., 2018. Alternatively, the relative transcript abundance could be measured to know which CA has the highest activity as many microorganisms encode more than one CA in their genome. In addition, bicarbonate and carbonate ions production, the concentration of ammonium (NH₄⁺), growth curve and pH change will be measured.

Formation of biotic and abiotic carbonate minerals (MgCO₃ and CaCO₃) is tested using the method described by Han et al., 2020. Precipitates in the form of carbonate minerals are characterized by using Scanning Electron Microscopy (SEM). Different cations are tested for the mineralization purposes and their effectiveness, and stability is analyzed. X-Ray diffractometer (XRD) analysis would be pursued to characterize the morphology of minerals Zhuang et al., 2018 To further prove the biogenesis of these minerals the stable carbon isotope values could be considered. While mineralization takes place on the surface of bacteria, mineralization to some extent is possible inside the bacterial cells. Detection of intracellular mineral formation is carried out by the method described by Han et al., 2020.

Selected microorganisms with enhanced ability to mineralize CO₂ will be tested in the greenhouse where these microorganisms will be loaded into the seed of major crops such as soybean, corn, etc. using the Microprime™ seed technology that ensures effective and guaranteed colonization of microorganisms on the roots as the roots emerge. These plants will be allowed to grow under standard conditions and after a specified time, these plants will be uprooted and our bacteria will be extracted followed by their counting and mineralized CO₂ on their surfaces. In addition, the soil sample in the closer proximity to roots will be analyzed to quantify total carbon, bicarbonate, carbonate and mineral while comparing the data with the soil of the control group (seeds/plants without Microprime™). The stable C isotope [¹³C] could be used to comprehend CO₂ fixation, respiration by the soil microbial community and soil respiration as described previously. Ultimately, selected strains will be tested in the large soybean and corn field to measure CO₂ fixation, amount of mineral production and its impact on productivity.

### Example 4: Strain Engineering to Enhance the CA Activity and/or Formation

To utilize the full potential of the microorganisms disclosed herein to fix CO₂ via CA, genetic engineering would be employed to increase its expression, stability, activity and secretion. According to Han et al., 2019 the concentration of Bacillus subtilis CA increases up to ˜30 h from 0 h to 17.14 U/L followed by a slight decrease from 31 h to 350 h. In B. subtilis a continuous production of mRNA has been documented even when bacterial growth is not taking place. This suggests the enhanced stability of the mRNA therefore, it would be strategic to increase its production. While the production of CA could be tightly regulated, genetic strategies will be applied to decouple this regulation including but not limited to making expression constitutive. For this approach, promoters of several highly expressed house-keeping genes or strongly expressed constitutive promoter genes such as P_{liaG}, P_{lepA}, P_{veg}, P_{gstB}, P43, P_{rnQ}, Pₗᵢₐₗ (bacitracin inducible), and P_{xylA} (xylose inducible), will be tested by replacing the native promoter of CA. The increased CA transcript abundance is likely to maintain the highest level of CA. Relative transcript abundance studies via qRT-PCR will be used to test the strength of the promoters and CA protein will be tagged to assess corresponding increases transcript and protein levels.

Many microorganisms can secrete CA extracellularly, which catalyzes the hydration of CO₂ to form HCO₃₋ under alkaline conditions. Extracellular secretion or targeting CA to periplasmic space has been beneficial to effectively sequester CO₂ by mineral carbonation. The whole cell as a CA catalyst has been shown to be important for mineralization even at slightly acidic or near neutral pH conditions. This is particular crucial for mineralization in soil as the pH of the soil could be slightly acidic or neutral and may not reach pH 9.0 (an ideal pH for mineralization). Jo et al., 2013 targeted the CA of Neisseria gonorrhoeae (ngCA) to the cytoplasm and periplasmic space of E. coli and concluded that the expression of ngCA in the periplasm of E. coli greatly accelerated the rate of CaCO₃ formation. The ability of the microorganisms to transport CA to periplasmic space or its extracellular secretion will be tested. A variety of approaches could be utilized to change the targeting of the CA in the strains. These strategies would involve an addition of either periplasmic signal sequence or extracellular secretion signal to the 5′ end of CA. The twin-arginine translocation (Tat) pathway that transports a fully folded protein extracellularly could be used. For extracellular secretion of CA an authentic Tat signal (TorA leader sequence) would be fused to the 5′ end of CA. Alternately, the general secretion pathway (Sec) that starts translocating protein as it is being synthesized could be used and an authentic Sec signal such as PelB could be used. These new strains will be tested for their ability to target CA in a particular compartment of the bacterial cell followed by testing these microorganisms via Microprime™ as described above.

The soil environment is dynamic and may contain CA inhibitors and to test this, the activity of CA will be tested in the presence of sample soil. To improve its fitness and evolve CA enzyme, direct evolution approach could be used. This approach has been used to improve the thermostability, and alkali tolerance of CA of Desulfovibrio vulgaris. Alvizo et al., 2014 using direct evolution, improved the temperature tolerance up to 107° C. in the presence of 4.2 M alkaline amine solvent at pH>10.0 and this increase is 4,000,000-fold improvement over the natural enzyme.

### Example 5: Concentrations of Bicarbonate and Calcium Carbonate in Soil—Season 2020

Corn was grown in the field in the US Midwest from seeds treated with Microprime B. subtilis S3C23 and untreated seeds (control). Midway through the growing season, 9 samples per treatment were taken from three different fields (Paxton, IL, Milford, IL and Wolcott, IN). The soil samples were analyzed for calcium carbonate and bicarbonate content. The results are shown in Table 4. An average of 3.19 tons of CO₂ per acre was sequestered in soils containing B. subtilis strain S3C23 in comparison with soils of untreated plants (control plants). This value reflects the concentration of bicarbonate and calcium carbonate detected up to V11 corn stage (45 days after sowing, of a total of 110 days).

TABLE 4
Results of soil analysis Corn Season 2020.

| | | | | | | Total |
|---|---|---|---|---|---|---|
| | | | | | | per |
| | | | | | | site |
| Corn | Treatments | | | | Captured | Captured |
| field | Untreated | | | | CO₂ | CO₂ |
| trials | control | Microprime | % over | | (tons/ | (tons/ |
| 2020 | (UTC) | S3C23 | UTC | Delta | acre) | acre) |

Paxton, IL

| | | | | | | |
|---|---|---|---|---|---|---|
| Bicarbonate | 0.21 | 0.22 | 4.8% | 0.01 | 0.00 | 4.60 |
| (meq/L) | | | | | | |
| CaCO₃ (%) | 0.60 | 0.73 | 22.2% | 0.13 | 4.60 | |

Milford, IL

| | | | | | | |
|---|---|---|---|---|---|---|
| Bicarbonate | 0.28 | 0.35 | 25.0% | 0.07 | 0.02 | 1.43 |
| (meq/L) | | | | | | |
| CaCO₃ (%) | 0.66 | 0.70 | 6.1% | 0.04 | 1.41 | |

Wolcott, IN

| | | | | | | |
|---|---|---|---|---|---|---|
| Bicarbonate | 0.20 | 0.10 | −50.0% | −0.10 | 0.00 | 3.54 |
| (meq/L) | | | | | | |
| CaCO₃ (%) | 0.62 | 0.72 | 16.1% | 0.10 | 3.54 | |

Average CO₂ tons per acre captured with Corn
Microprime S3C23 (V11 stage): 3.19

### Example 6: Concentrations of Bicarbonate and Calcium Carbonate in Soil—Season 2021

Corn was grown in the field in the US Midwest from seeds treated with Microprime B. subtilis S3C23 and untreated seeds (control). Midway through the growing season, 9 samples per treatment were taken from four different fields (Milford, IL, Rensselear, IN, Beaver Damn, WI, and Monticello, IL). The soil samples were analyzed for calcium carbonate and bicarbonate content. The results are shown in Table 5. An average of 8.18 tons of CO₂ per acre was sequestered in soils containing B. subtilis strain S3C23 in comparison with soils of untreated plants (control plants). This value reflects the concentration of bicarbonate and calcium carbonate detected up to V11 corn stage (45 days after sowing, of a total of 110 days).

TABLE 5
Results of soil analysis Corn Season 2021.

| | | | | | | Captured |
|---|---|---|---|---|---|---|
| | | | | | | CO₂ |
| Corn | | | | | Captured | per |
| field | Untreated | | | | CO₂ | site |
| trials | control | Microprime | % over | | (tons/ | (tons/ |
| 2021 | (UTC) | S3C23 | UTC | Delta | acre) | acre) |

Milford, IL

| | | | | | | |
|---|---|---|---|---|---|---|
| Bicarbonate | 0.30 | 0.40 | 33.3% | 0.10 | 0.04 | 4.99 |
| (meq/L) | | | | | | |
| CaCO₃ (%) | 0.69 | 0.82 | 19.8% | 0.14 | 4.95 | |

Rensselear, IN

| | | | | | | |
|---|---|---|---|---|---|---|
| Bicarbonate | 0.30 | 0.48 | 60.0% | 0.18 | 0.06 | 15.98 |
| (meq/L) | | | | | | |
| CaCO₃ (%) | 1.23 | 1.68 | 36.6% | 0.45 | 15.92 | |

Beaver Damn, WI

| | | | | | | |
|---|---|---|---|---|---|---|
| Bicarbonate | 0.18 | 0.28 | 55.6% | 0.10 | 0.04 | 6.76 |
| (meq/L) | | | | | | |
| CaCO₃ (%) | 1.07 | 1.26 | 17.8% | 0.19 | 6.72 | |

Monticello, IN

| | | | | | | |
|---|---|---|---|---|---|---|
| Bicarbonate | 0.21 | 0.35 | 66.7% | 0.14 | 0.05 | 5.00 |
| (meq/L) | | | | | | |
| CaCO₃ (%) | 1.01 | 1.15 | 13.9% | 0.14 | 4.95 | |

Average CO₂ tons per acre captured with Corn
Microprime S3C23 (V11 stage): 8.18

Soybeans grown in the field in the US Midwest from seeds treated with Microprime B. subtilis MP1, B. subtilis MP2, and E. adhaerens S3C10 and untreated seeds (control). Midway through the growing season, 9 samples per treatment were taken from one field (Flanagan, IL). The soil samples were analyzed for calcium carbonate and bicarbonate content. The results are shown in Table 6. An average of 8.63 tons of CO₂ per acre was sequestered in soils containing Andes Microprime Microbial Treatment in comparison with soils of untreated plants (control plants). This value reflects the concentration of bicarbonate and calcium carbonate detected up to 45 days after sowing.

Data presented in both Table 5 and Table 6 show that 2020 data as shown in Table 4 was not a mere coincidence and that the Andes Microprime™ Treatment and Andes proprietary microorganisms are substantially effective as sequestering an important amount of CO₂ into the soil.

TABLE 6
Results of soil analysis Soybean Season 2021.

| | | | | | | Total per |
|---|---|---|---|---|---|---|
| | | | | | | microbial |
| | | | | | | treatment |
| Soybean | | Microbial | | | Captured | Captured |
| field | Untreated | treatment | | | CO₂ | CO₂ |
| trial | control | Microprime | % over | Delta | (tons/ | (tons/ |
| 2021 | (UTC) | MP1 | UTC | MP1 | acre) | acre) |

Flanagan, IL

| Bicarbonate | 0.41 | 0.55 | 34.1% | 0.14 | 0.05 | 14.90 |
|---|---|---|---|---|---|---|
| (meq/L) | | | | | | |
| CaCO₃ (%) | 0.49 | 0.91 | 85.7% | 0.42 | 14.85 | |
| Soybean | | | | | Captured | Captured |
| field | Untreated | | | | CO₂ | CO₂ |
| trial | control | Microprime | % over | Delta | (tons/ | (tons/ |
| 2021 | (UTC) | MP2 | UTC | MP2 | acre) | acre) |

Flanagan, IL

| Bicarbonate | 0.41 | 0.42 | 2.4% | 0.01 | 0.00 | 3.54 |
|---|---|---|---|---|---|---|
| (meq/L) | | | | | | |
| CaCO₃ (%) | 0.49 | 0.59 | 20.4% | 0.10 | 3.54 | |
| Soybean | | | | | Captured | Captured |
| field | Untreated | | | | CO₂ | CO₂ |
| trial | control | Microprime | % over | Delta | (tons/ | (tons/ |
| 2021 | (UTC) | S3C10 | UTC | S3C10 | acre) | acre) |

Flanagan, IL

| | | | | | | |
|---|---|---|---|---|---|---|
| Bicarbonate | 0.41 | 0.50 | 22.0% | 0.09 | 0.03 | 7.46 |
| (meq/L) | | | | | | |
| CaCO₃ (%) | 0.49 | 0.70 | 42.9% | 0.21 | 7.43 | |

Average CO₂ tons per acre captured with Andes
Microprime microbial treatment: 8.63

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A composition comprising a plant seed and one or more microorganisms associated with said plant seed, wherein said one or more microorganisms are, or are derived from, one or more microorganisms selected to produce or promote the formation of bicarbonate, or carbonate.

2. The composition of claim 1, wherein said plant seed is a commercial plant seed, a fruit tree plant seed, a nut tree plant seed, a bush plant seed, a bulb plant seed, a grassland plant seed, a turfgrass plant seed, or any combination thereof.

3. The composition of claim 1, wherein said one or more microorganisms associated with said plant seed are disposed in an interspace between a seed coat and a seed embryo of said plant seed.

4. The composition of claim 1, wherein said one or more microorganisms associated with said plant seed are disposed as a coating of said plant seed.

6-16. (canceled)

17. The composition of claim 1, wherein said one or more microorganisms associated with said plant seed are disposed in an interspace between a seed pericarp and a seed aleurone cell layer of said plant seed.

18. The composition of claim 1, wherein said one or more microorganisms comprises one or more carbonic anhydrase enzymes.

19-27. (canceled)

28. The composition of claim 1, wherein said one or more microorganisms comprise endospore forming bacteria.

29-167. (canceled)

168. The composition of claim 3, wherein said plant seed comprises at least about 250 CFU of said one or more microorganisms disposed between said seed coat and said seed embryo of said plant seed.

169. The composition of claim 28, wherein said endospore forming bacteria comprise Bacillus sp.

170. The composition of claim 1, wherein said plant seed is at least 3 months old.

171. The composition of claim 170, wherein said plant seed comprises at least 4,000 CFU of said one or more microorganisms.

172. The composition of claim 1, wherein said plant seed is at least 6 months old.

173. The composition of claim 172, wherein said plant seed comprises at least 2,000 CFU of said one or more microorganisms.

174. The composition of claim 1, wherein said plant seed is selected from a maize seed, a rice seed, and a soybean seed.

175. The composition of claim 1, wherein said one or more microorganisms produce the formation of one or more carbonic anhydrase enzymes.

176. The composition of claim 175, wherein said one or more carbonic anhydrase enzymes

177. The composition of claim 1, wherein said one or more microorganisms produce bicarbonate or carbonate and one or more other minerals.

178. The composition of claim 1, wherein said one or more microorganisms are further selected to fix nitrogen.

179. The composition of claim 177, wherein said one or more minerals comprise CaCO₃, MgCO₃, CaMg(CO₃)₂, or any combination thereof.

180. The composition of claim 17, wherein said one or more microorganisms are present in an amount of at least 2,000 CFU.
